(19) United States
(12) Patent Application Publication
(10) Pub. No.: US 2016/0132940 A1
(43) Pub. Date: May 12, 2016

(54) MEDIA PLANNING SYSTEM

(71) Applicant: Analytics Media Group, LLC, Chicago, IL (US)

(72) Inventors: Christopher Walther Frommann, New York, NY (US); Alan Sean Papir, Brooklyn, NY (US); Karl S. Jin, North Berge, NJ (US)

(21) Appl. No.: 14/539,807

(22) Filed: Nov. 12, 2014

(51) Int. Cl. G06Q 30/02

(52) U.S. Cl. CPC G06Q 30/0276; G06Q 30/0249

(57) ABSTRACT

A media planning system is provided to generate a media plan. The system can employ a combination of a pre-optimization algorithm and an optimization algorithm to optimize a media plan with recommended placement block. The optimized media plan is generated based upon a fitness value using various media data and plan parameters.

### BACKGROUND

Advertising is typically performed in various types of media, such as print advertising, television, radio, telephone, and electronic media distributed via electronic communications. A primary goal of the advertising is to not only make effective advertising content but also the most effective return on investment by allocating advertisements to influence as many viewers in a target population as possible in a cost effective manner.

### SUMMARY

In general terms, this disclosure is directed to a media planning system for generating a media plan. In one possible configuration and by non-limiting example, the system employs a combination of a pre-optimization algorithm and an optimization algorithm to optimize a media plan based upon various media data and plan parameters. Various aspects are described in this disclosure, which include, but are not limited to, the following aspects.

One aspect is a method of generating a campaign media plan. The method includes receiving media data; receiving plan parameters; generating at least one advertising options data file based upon the media data and the plan parameters; and generating, using one or more computing devices, a media plan with recommended placement blocks, the recommended placement blocks generated from the at least one advertising options data file and selected based upon a fitness value.

Another aspect is a system of generating a campaign media plan. The system includes at least one processing devices; a computer readable storage device storing software instructions that, when executed by the one or more computing devices, cause the one or more processing devices to: receive media data; receive plan parameters; generate at least one advertising options data file based upon the media data and the plan parameters; and generate a media plan with recommended placement blocks, the recommended placement blocks generated from the at least one advertising options data file and selected based upon a fitness value.

Yet another aspect is a computer storage medium encoding computer executable instructions that, when executed by at least one processor, perform a method of generating a campaign media plan, the method comprising: receiving media data; converting the media data into a predetermined format readable by a database; receiving plan parameters; generating at least one advertising options data file based upon the media data and the plan parameters; generating all possible placement blocks from the at least one advertising options data file; eliminating at least one of the all possible placement blocks based upon one or more predetermined criteria to select some of the all possible placement blocks to be used as a basis list of placement blocks; creating a group of chromosomes from the basis list of placement blocks, each of the chromosomes representing a placement block selected from the basis list of placement blocks; repeatedly mutating the group of chromosomes using a fitness value either until the fitness value converges or until a predetermined number of mutations have been reached; and generating a media plan with placement blocks represented by the group of chromosomes that offer a highest fitness value.

### BRIEF DESCRIPTION OF THE DRAWINGS

FIG. 1 is a schematic diagram of an example media planning system for generating a media plan.

FIG. 2 is a block diagram of an example media plan generation system in relation to an advertiser and a media data provider.

FIG. 3 illustrates an example structure of a media plan.

FIG. 4 is a flowchart of an example method of operating the media plan generation system.

FIG. 5 is an example functional block diagram of the media plan generation system.

FIG. 6 is example architecture of the media plan generation system.

FIG. 7 illustrates an exemplary architecture of a computing device that can be used to implement aspects of the present disclosure.

FIG. 8 is a block diagram of an example data transformation subsystem.

FIG. 9 illustrates an example operation of a media data collection engine.

FIG. 10 illustrates an example of media data.

FIG. 11 illustrates a portion of example audience measurement data by a media data provider.

FIG. 12 illustrates a portion of example measurement data provided by a media data provider.

FIG. 13 illustrates a portion of example program data provided by a media data provider.

FIG. 14 illustrates a portion of example cost data provided by a media data provider.

FIG. 15 illustrates an example rate card.

FIG. 16 illustrates an example rate card.

FIG. 17 illustrates an example rate card.

FIG. 18 illustrates an example rate card.

FIG. 19 illustrates an example rate card.

FIG. 20 is a block diagram of an example data conversion engine.

FIG. 21 is an example schema of a database.

FIG. 21A is a portion of the schema of FIG. 21.

FIG. 21B is the other portion of the schema of FIG. 21.

FIG. 22 is a block diagram of an example data management subsystem.

FIG. 23 is a flowchart of an example method of operating an advertising options data file generation engine.

FIG. 24 is a block diagram of an example advertising options data file generation engine.

FIG. 25 is a block diagram of an example plan generation subsystem management engine.

FIG. 26 illustrates an example format of a command from the plan generation subsystem management engine.

FIG. 27 illustrates an example list of data included in an output received by the plan generation subsystem management engine from the plan generation subsystem.

FIG. 28 illustrates an example layout of an interface provided by a user interface engine.

FIG. 29 is a block diagram of an example plan generation subsystem.

FIG. 30 is a flowchart of an example method of operating a pre-optimization engine.

FIG. 31 is a flowchart of an example method of operating an optimization engine.

FIG. 32 is a block diagram of an example potential media plan containing one or more chromosomes.

FIG. 33 is a flowchart of an example method for performing an operation of FIG. 31.

FIG. 34 illustrates a mutation of chromosomes in a potential media plan.

FIG. 35 illustrates an example calculation of a fitness value.

FIG. 36 is an example schema utilized by the plan generation subsystem.

FIG. 37 is an example output of a media plan generated by the plan generation subsystem.

FIG. 38 is a block diagram of an example user interaction subsystem.

FIG. 39 is a flowchart of an example method of operating a run management engine.

FIG. 40 is an example interface of the run management engine that displays a client list page.

FIG. 41 is an example interface of the run management engine that displays a client details page.

FIG. 42 is an example interface of the run management engine that displays a page for generating a new campaign.

FIG. 43 is an example interface of the run management engine that displays a campaign details page.

FIG. 44 is an example interface of the run management engine that displays a page for generating a new plan.

FIG. 45 is an example interface of the run management engine that displays a plan details page.

FIG. 46 is an example interface of the run management engine that displays an output result of the media plan.

FIG. 47 illustrates an example interface of a run management engine that displays statistics of the media plan in a form of charts.

FIG. 48 illustrates an example interface of a run management engine that displays statistics of the media plan in a form of costs.

FIG. 49 illustrates an example interface of a run management engine that displays statistics of the media plan in a form of target rating points.

FIG. 50 is an example interface of the run management engine that displays a page for a list of recommended placement blocks contained in the media plan.

FIG. 51 is a flowchart of an example method of operating a rate card import engine.

FIG. 52 is a flowchart of an example method of performing a parsing operation.

FIG. 53 is an example interface of the rate card import engine that displays a rate card load page.

FIG. 54 is an example interface of the rate card import engine that displays a rate card pattern selection page.

FIG. 55 is an example interface of the rate card import engine that displays the rate card pattern selection page.

FIG. 56 is an example interface of the rate card import engine that displays a page for enabling a user to validate uncertain avails and verify periods.

FIG. 57 is an example interface of the rate card import engine that displays a page for matching data.

FIG. 58 is an example interface of the rate card import engine that displays a page for enabling a user to select a rate class for an associated rate card.

FIG. 59 is an example interface of the rate card import engine that displays a page for enabling a user to select stations the rates apply.

FIG. 60 is an example interface of the rate card import engine that displays a rate card summary page.

FIG. 61 is an example interface of the rate card import engine that displays a rate card list page.

FIG. 62 is a flowchart of an example method of operating a data management engine.

FIG. 63 illustrates an example interface of the data management engine that displays a stations management page.

FIG. 64 illustrates an example interface of the data management engine that displays a media markets management page.

FIG. 65 illustrates an example interface of the data management engine that displays a sync history page.

FIG. 66 illustrates an example rate card.

FIG. 67 illustrates an example rate card.

FIG. 68 illustrates an example rate card.

FIG. 69 illustrates an example bitmask.

FIG. 70 illustrates an example hierarchy of data.

FIG. 71 is an example table containing every cell format to model/field (or hash) combination.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

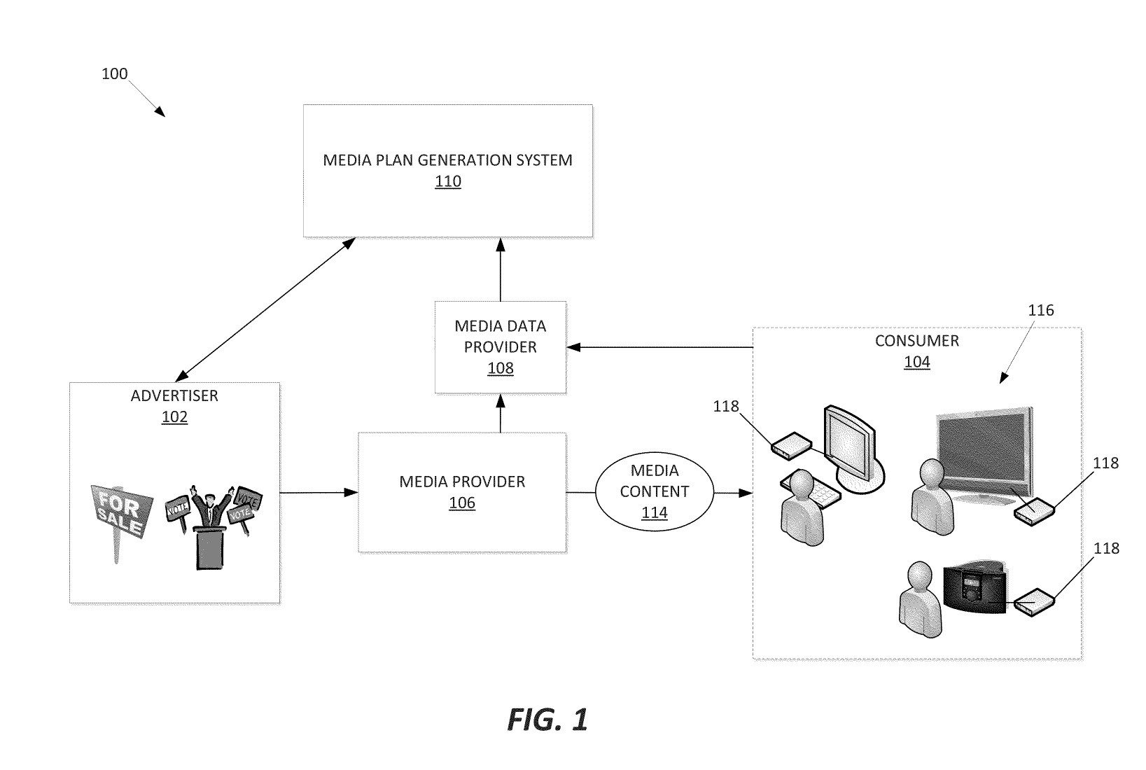

FIG. 1 is a schematic diagram of an example media planning system 100 for generating a media plan. In some embodiments, the system 100 includes an advertiser 102, a consumer 104, a media provider 106, a media data provider 108, and a media plan generation system 110. Also shown are media content 114, one or more media delivery devices 116, and one or more media data collection devices 118.

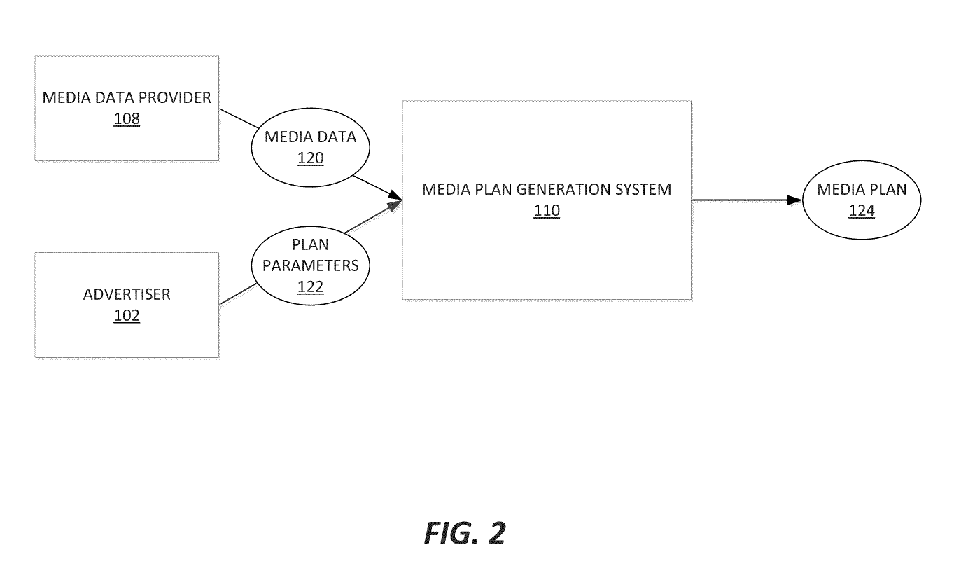

In various embodiments, the media planning system 100 operates to recommend a media advertisement plan 124 (FIG. 2) to the advertiser 102. As described herein, the media advertisement plan recommended by the media planning system 100 includes one or more advertisement placement blocks that are likely to provide the best advertising effects in a cost-efficient manner. For example, the media planning system 100 offers advertisers and other users access to an optimized media plan in reduce time and cost so as to facilitate allocation of limited advertising resources and increase the return on investment (ROI) of the advertising content.

In the present disclosure, embodiments of the media planning system 100 are primarily described and illustrated in the context of a political campaign. However, it is apparent that the media planning system 100 is applicable to other types of marketing campaign, such as an advertising campaign for a product (e.g., retail), service (e.g., hotel and travel), or entertainment media (e.g., HBO, NBC, AMC, and New Regency).

The advertiser 102 is a person, group, organization, or company that promotes a product, service, business, candidate, cause, and/or other objectives in various marketing campaigns. For example, the advertiser 102 is organized to perform an advertising campaign. In the advertising campaign, the advertiser 102 can perform a coordinated series of steps that include promotion of a product and/or service through different media using a variety of different types of advertisements. Examples of the advertiser 102 include advertising professionals, agencies, and media researchers.

In other embodiments, the advertiser 102 is organized to conduct a political campaign, which seeks to influence the decision making process within a certain group. For example, a political campaign is designed to promote a particular candidate for a member of a political body. In some embodiments, the advertiser 102 in a political campaign has a structure of personnel including a campaign manager who coordinates the campaign's operations, one or more political consultants who advise campaigns on all activities from research to field strategy, and activists who take part in various activities such as canvassing door-to-door and making phone calls on behalf of the campaign.

In a political campaign, the advertiser 102 performs a variety of activities to communicate a campaign message, which contains the ideas that a candidate wants to share with voters. The campaign activities are conducted to accord with a campaign plan set up by the advertiser 102. In general, a campaign plan takes account of a campaign's goal, message, target audience, and resources available. In many cases, the advertiser 102 implements campaign advertising through paid media, such as newspapers, radio, television, and other communication technologies. In some embodiments, the media also include web-based communication technologies, such as email, websites, podcasts, and social media.

The consumer 104 is a group of people who use a product or service that is advertised on the media. In a political campaign, the consumer 104 can be potential voters. The consumer 104 is the target of the campaign, which is designed to persuade them to agree with the candidate's ideas and support the candidate. The consumer 104 receives media content 114 via different media delivery devices 116. Examples of the media delivery devices include televisions, radios, computers, mobile devices, and other electronic devices.

The media provider 106 is one or more companies or organizations that deliver media content 114 to the consumer 104 via different media delivery devices 116. In some embodiments, the media provider 106 includes television broadcasting companies, cable television companies, radio broadcasting companies, telecommunications companies, Internet service providers, Internet content providers, and other program delivery sources. The media content 114 is intended to be delivered on the media delivery devices 116 and serves as attraction for viewership. In some embodiments, the media content 114 includes television programs, cable programs, radio programs, and streaming video or audio. As described herein, the media content 114 also includes advertising content (e.g., political messages in a political campaign). In some embodiments, the placement of advertising content is determined in accordance with the campaign plan (e.g., the media plan 124) generated by the media plan generation system 110.

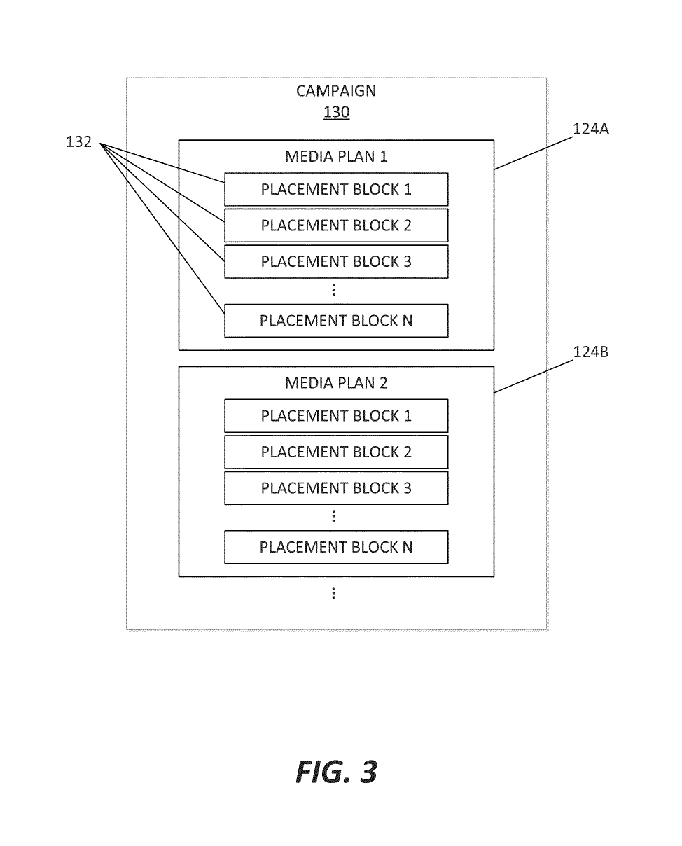

In some embodiments, the advertiser 102 can purchase one or more placement blocks of media content 114 from the media provider 106. The placement block is defined as a time slot for advertisement within or between different media programs delivered by a media provider 106. For example, the advertiser 102 can buy a certain number of placement blocks for advertisement between and/or in the middle of regularly scheduled television programs from a television broadcasting company. The advertiser 102 tries to design its campaign plans to choose placement blocks (e.g., time slots and media) for advertisement that can most appeal the candidate's demographic. An example of placement blocks is illustrated and described in more detail with reference to FIG. 3.

The media data provider 108 is one or more companies or organizations that generate and provide media data 120 (FIG. 2). As described herein, the media data 120 can include media measurement and other analytical services. In some embodiments, the media data provider 108 monitors and evaluates media content 114 provided by the media provider 106, and provides information about consumers as media data 120. For example, the media data provider 108 tracks viewing behavior from a number of televisions across a plurality of markets. The media measurement provided by the media data provider 108 is used by the media plan generation system 110 to help the advertiser 102 target customers with high prospects, thereby allowing the advertiser 102 make a cost effective decision on advertisement. Examples of the media data provider 108 include Rentrak Corporation (Portland, Oreg.), Kantar Group (Fairfield, Conn.), Fyi (Newark, N.J.), FourthWall Media (Dulles, Va.), Comcast (Philadelphia, Pa.), Time Warner (New York, N.Y.), Charter (St. Louis, Mo.), and other cable providers. In other embodiments, the media data provider 108 includes at least part of the media provider 106.

The media plan generation system 110 operates to recommend a cost effective media plan in a reduce period of time. The media plan generation system 110 offers the advertiser 102 access to an optimized media plan in reduce time and cost, thereby facilitating allocation of advertising resources and increasing the return on investment of the advertising content. The media plan generation system 110 allows the advertiser 102 to estimate the marketing effects of advertisement by matching the media data 120 from the media data provider 108 with various plan parameters provided by the advertiser 102. This helps the advertiser 102 reach its most intended consumer 104 and create a buying model built on more targeted impressions for a more effective and efficient advertising schedule. An example of the media plan generation system 110 is described and illustrated with reference to FIG. 2.

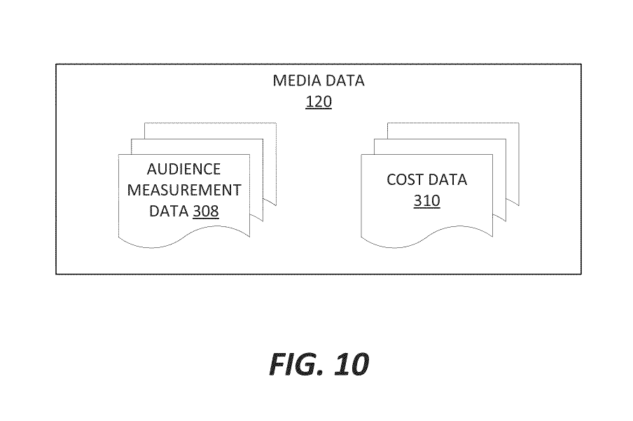

The media data collection device 118 is hardware and/or software (e.g., computer readable instructions) introduced into a household in addition to or to supplement the media delivery device 116 and externally operatively associated with the media delivery device 116. The primary purpose of a media data collection device 118 is to collect the media data 120 including viewership data, purchase data, and/or other media-related data. For example, in embodiments of television viewership, a set top box associated with a television in a household operates to obtain set top box data. The set top box data contain various media-related data, at least of which are used in the media data 120. An example content of the media data 120 is illustrated and described in more detail with reference to FIG. 10.

FIG. 2 is a block diagram of an example media plan generation system 110 in relation to the advertiser 102 and the media data provider 108. In addition to the advertiser 102, the media data provider 108, and the media plan generation system 110, media data 120, plan parameters 122, and a media plan 124 are also shown.

As illustrated, the media plan generation system 110 is configured to receive the media data 120 from the media data provider 108 and one or more plan parameters 122 from the advertiser 102. In some embodiments, the media plan generation system 110 uses one or more items from the media data 120 and one or more of the plan parameters 122 to generate a media plan 124. In general, the media plan generation system 110 is configured to cross-correlate the media data 120 collected via one or more media data collection devices (e.g., a television digital set-top box, as described herein) to generate an optimized media plan in reduced time and cost.

As described above, the media data 120 includes information about a variety of media measurement. An example of the media data 120 is illustrated and described in more detail with reference to FIG. 10.

The plan parameters 122 include one or more criteria for generating the media plan 124. The plan parameters 122 are determined and provided by the advertiser 102 to the media plan generation system 110 to develop the media plan 124. In some embodiments, the plan parameters 122 include at least one of a budget, a maximum allowable placement blocks (e.g., in total or in a predetermined period of time), a start date, a end data, a purchase target, geographic information (e.g., a media market, a congressional district, a state), a type of cost data to be used, a rate class, start and end dates for determining reach, a television type, a coverage type, demographic information, a reach weight, a budget multiplier, one or more advertising restrictions, and other relevant information. In other embodiments, the plan parameters 122 can include other types of inputs or limitations from the advertiser 102.

As described above, the media plan 124 generated by the media plan generation system 110 is designed to suggest an optimized advertising plan to the advertiser 102. An example of the media plan 124 is illustrated and described in more detail with reference to FIG. 3.

FIG. 3 illustrates an example structure of the media plan 124. In some embodiments, the media plan 124 belongs to a campaign 130. The campaign 130 includes one or more media plans 124 (including 124A and 124B). Each of the media plans 124 includes one or more placement blocks 132.

The campaign 130 is the highest level category of the output from the media plan generation system 110. In an example of a political campaign, the campaign 130 is designed to designate an overall campaign for a particular candidate in an election.

The media plans 124 are categorized under the campaign 130. Each media plan 124 is defined as a predetermined campaign activity. In some embodiments, the media plan 124 indicates one advertising plan with one or more criteria. For example, the media plan 124 can be a television advertisement plan with a predetermined budget during a predetermined period of time in a predetermined area.

The placement block 132 is designed to indicate a possible slot for advertising campaign content to the consumer 104 via the advertising delivery devices 116. In some embodiments, the advertising slot is defined by a particular period of time and date for a program (i.e., advertising content) on a station of a media provider 106. As described herein, the media plan generation system 110 is configured to generate a media plan 124 that contains one or more recommended placement blocks 132 so that the advertiser 102 finds the best available options for advertising campaign content.

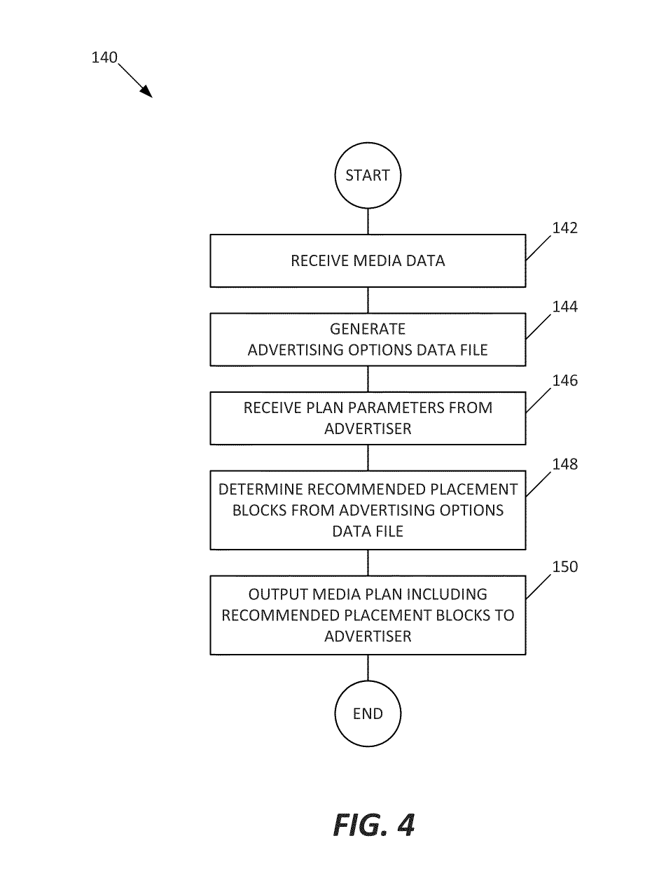

FIG. 4 is a flowchart of an example method 140 of operating the media plan generation system 110. In some embodiments, the method 140 includes operations 142, 144, 146, 148, and 150.

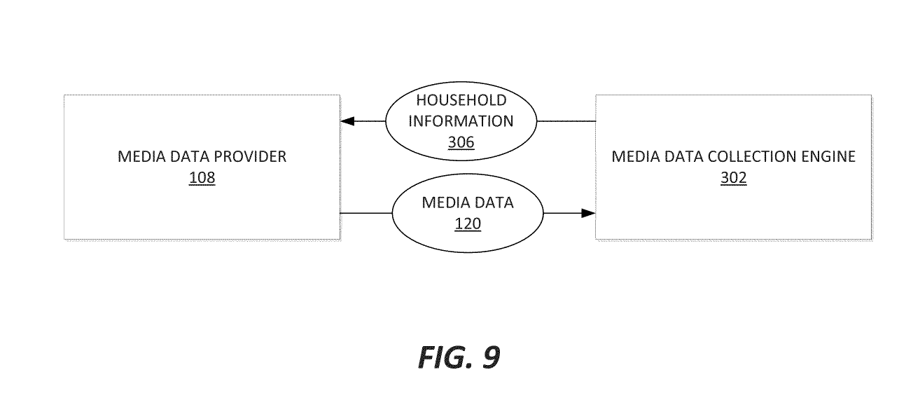

At the operation 142, the media plan generation system 110 receives the media data 120 from the media data provider 108. The media data 120 is designed to include various pieces of information about media content delivered to the consumer 104. An example of the media data 120 is described and illustrated with reference to FIG. 9.

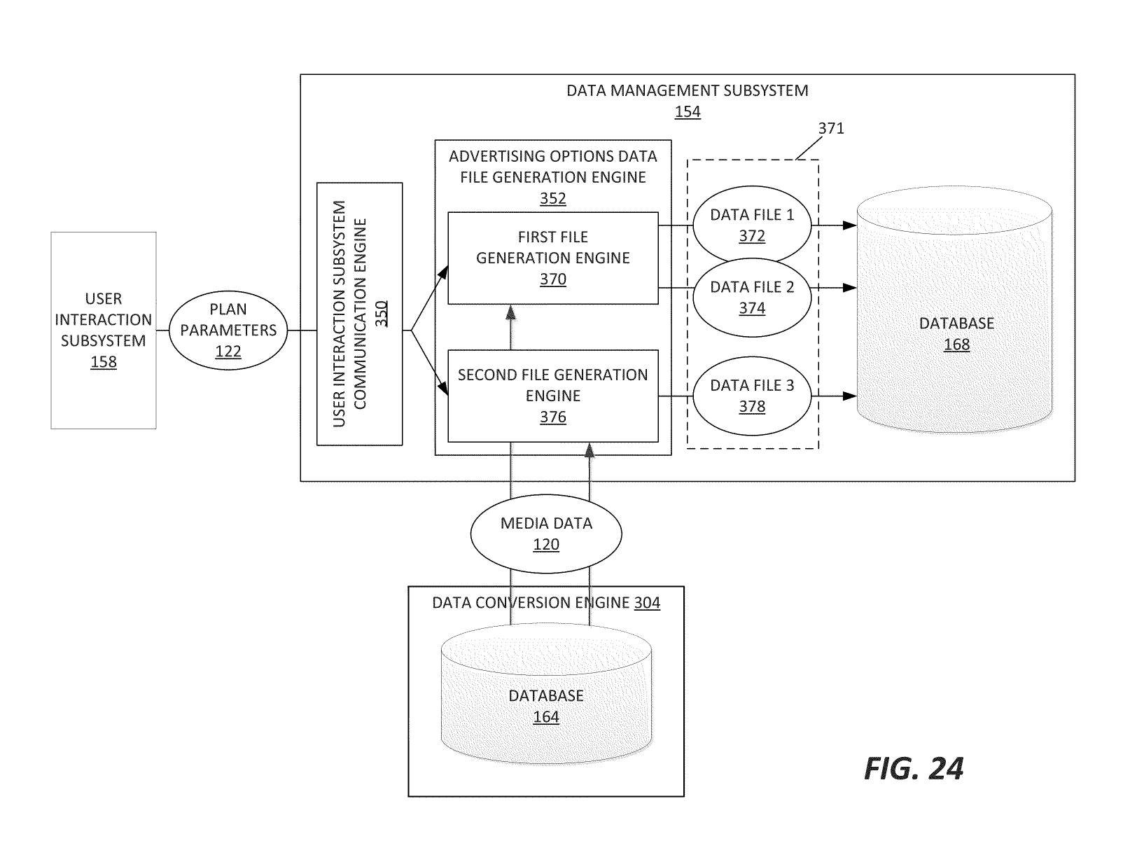

At the operation 144, the media plan generation system 110 generates one or more data files 371 (FIG. 24) containing a plurality of advertising options. The advertising options data files 371 is configured and used to identify all possible placement blocks 132 includable in the media plan 124. An example of the advertising options data files 371 is illustrated and described with reference to FIG. 24.

At the operation 146, the media plan generation system 110 receives one or more plan parameters 122 from the advertiser 102.

At the operation 148, the media plan generation system 110 determines recommended placement blocks 132 from the advertising options data file 317.

At the operation 150, the media plan generation system 110 outputs a media plan 124 including the recommended placement blocks 132 to the advertiser 102.

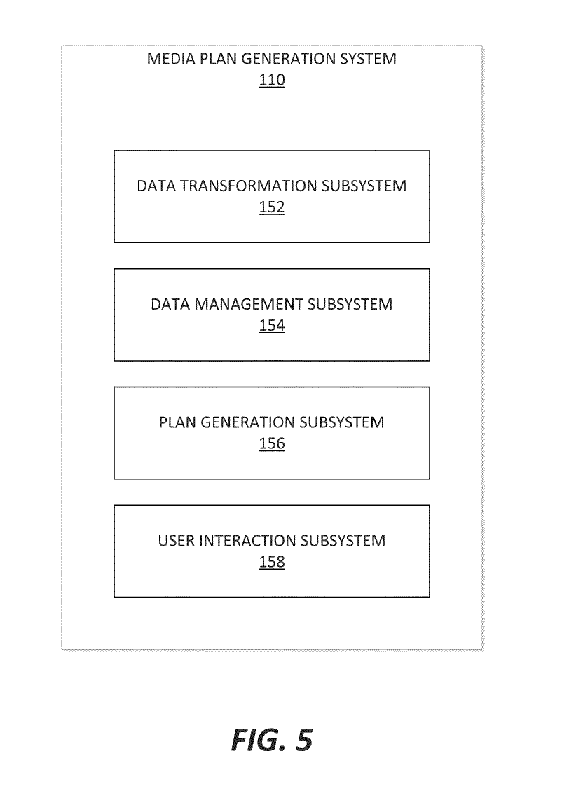

FIG. 5 is an example functional block diagram of the media plan generation system 110. In some embodiments, the media plan generation system 110 includes a data transformation subsystem 152, a data management subsystem 154, a plan generation subsystem 156, and a user interaction subsystem 158.

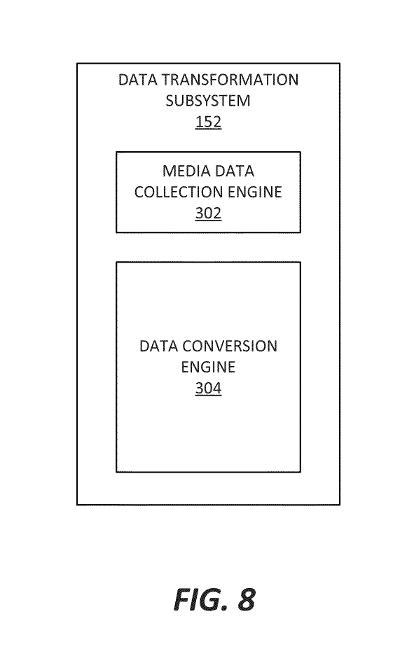

The data transformation subsystem 152 operates to receive the media data 120 from the media data provider 108 and transform the media data 120 in a predetermined format usable in other components of the media plan generation system 110. An example of the data transformation subsystem 152 is illustrated and described with reference to FIG. 8.

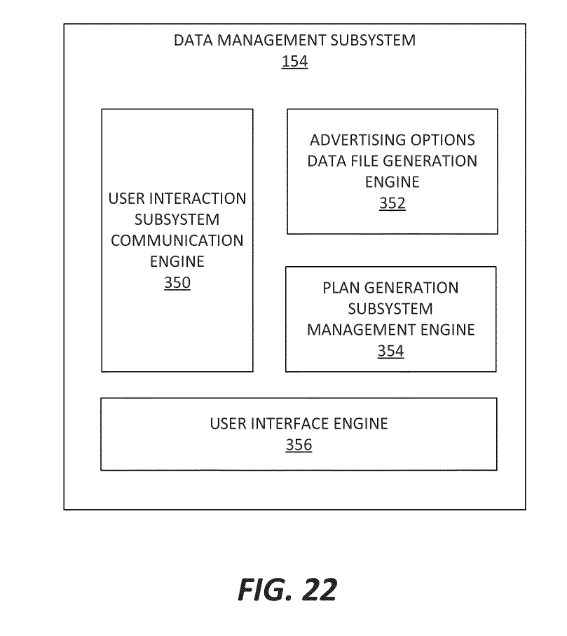

The data management subsystem 154 operates to generate one or more advertising options data file 371 from the transformed media data 120. An example of the data management subsystem 154 is illustrated and described with reference to FIG. 22.

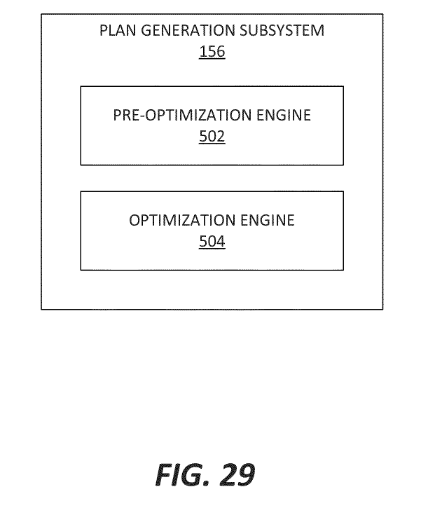

The plan generation subsystem 156 operates to generate recommended placement blocks 132 from the advertising options data file 371. In some embodiments, the placement blocks 132 are determined using a fitness value that is calculated based upon a plurality of advertising objectives. An example of the plan generation subsystem 156 is illustrated and described with reference to FIG. 29.

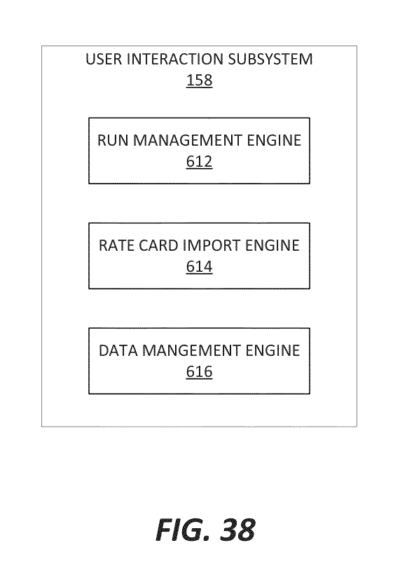

The user interaction subsystem 158 operates to provide an interface for the advertiser 102. The advertiser 102 can communicate with other components of the media plan generation system 110 via the interface provided by the user interaction subsystem 158. In some embodiments, the user interaction subsystem 158 is used to receive the plan parameters 122 from the advertiser 102 via the interface thereof, and the received plan parameters 122 are used for the plan generation subsystem 156 to generate the optimized media plan 124 with recommended placement blocks 132 to target with advertisements. In these manners, the advertiser 102 can select targeted criteria (e.g., the plan parameters) to increase the influence an impression will have on an ultimate decision of the consumer 104. The user interaction subsystem 158 can further enable the advertiser 102 to access data stored and managed in the media plan generation system 110 and manage the data in various manners (e.g., loading, creating, editing, and deleting). In some embodiments, the interface provided by the user interaction subsystem 158 is a web-based interface (e.g., a website). An example of the user interaction subsystem 158 is illustrated and described with reference to FIG. 38.

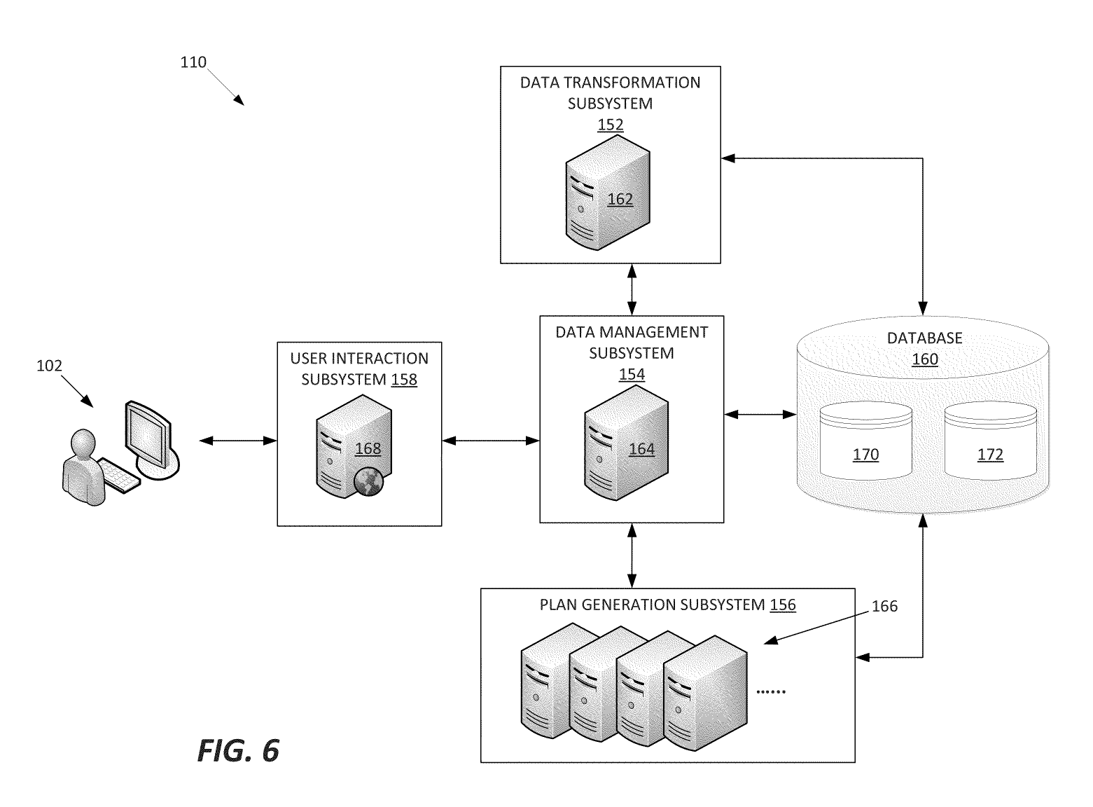

FIG. 6 is example architecture of the media plan generation system 110. Example structures of the data transformation subsystem 152, the data management subsystem 154, the plan generation subsystem 156, the user interaction subsystem 158, and a database 160 are illustrated in the Figure.

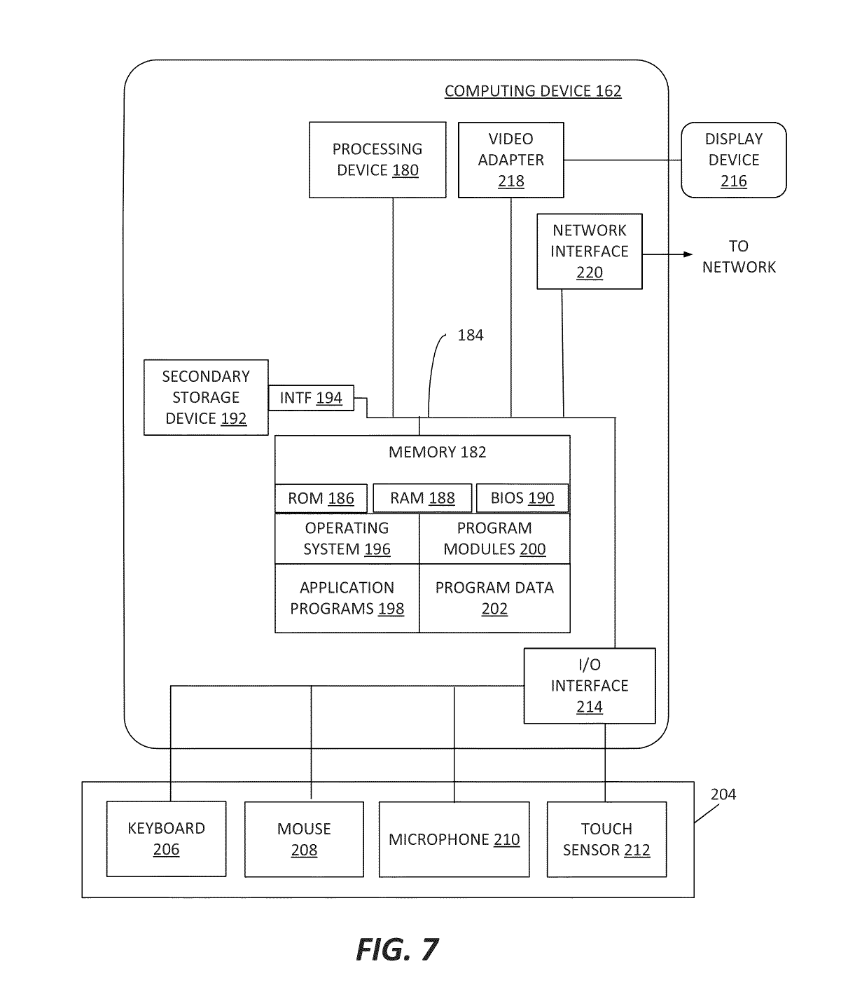

Some embodiments of the data transformation subsystem 152 include a computing device 162. The computing device 162 is used to execute the data transformation subsystem 152 and interact with the database 160. In some embodiments, the computing device 162 is configured as the type illustrated in FIG. 7.

Some embodiments of the data management subsystem 154 include a computing device 164. The computing device 164 is used to execute the data management subsystem 154 and interact with the database 160. In some embodiments, the computing device 164 is configured as the type illustrated in FIG. 7.

Some embodiments of the plan generation subsystem 156 are configured as a computer cluster 166 including a plurality of connected computing devices that work together as a single system. The computer cluster 166 is used to execute the plan generation subsystem 156. As described herein, the generation of the media plan 124 by the plan generation subsystem 156 involves a multi-objective knapsack problem to which an exact solution is typically infeasible. This problem is NP-complete (nondeterministic polynonmial time complete), and an exact solution to the problem requires a very large amount of time and computer resources because larger plans are effectively impossible to solve exactly. The absolute optimal solution is basically impossible to obtain and know in a reasonable amount of time and resources on a realistic plan. The computer cluster 166 speeds up the generation of a media plan 124 that closely approximates an optimal solution by the plan generation subsystem 156.

Some embodiments of the user interaction subsystem 158 include a computing device 168. In some embodiments, the computing device 168 is configured as the type illustrated in FIG. 7. In some embodiments, the computing device 168 of the user interaction subsystem 158 is a web server. The computing device 168 can be designed to store, process and deliver a web-based user interface to a computing device of the advertiser 102. Examples of the web-based user interface include HTTP-based webpages.

The database 160 is configured to store data used in the media plan generation system 110. For example, the database 160 is designed to store the media data 120 once the media data 120 has been transformed by the data transformation subsystem 152. The computing devices 162, 164, 166, and 168 can communicate with the database 160 via a communications network (either wired or wireless, or both).

In some embodiments, the database 160 is located adjacent a physical premise of the subsystems 152, 154, 156 and 158. The database 160 can be made with multiple physical (or production) disks that are linked together using a logical name that represents the database. Data added to the database is ultimately stored in physical disks. A physical disk is a type of physical storage capable of storing data in a volatile or nonvolatile manner. Example types of physical storage devices include magnetic storage (e.g., hard drives, magnetic tape), optical storage (e.g., CD, CD-ROM, DVD, BD-ROM), solid state drives, etc.

In other embodiments, the database 160 is a cloud database, which runs on a cloud computing platform. Examples of the cloud database include Amazon EC2, GoGrid, Salesforce, Rackspace, and Microsoft Azure.

In some embodiments, the database 160 is configured to include a data warehouse 170 and a file hosting service 172. Data handled in the media plan generation system 110 can be first managed in the file hosting database 172 before copied into the data warehouse 170. In some embodiments, at least one of the components (e.g., the subsystems 152, 154, 156 and 158) included in the media plan generation system 110 can access the file hosting database 172 to retrieve data stored therein. In other embodiments, at least one of the components included in the media plan generation system 110 can also access the data warehouse 170 to retrieve data stored therein. Examples of the data warehouse 170 include Amazon Redshift, Aster nCluster from Aster Data Systems, IBM InfoSphere DataStage, Vertica, ParAccel, HBase, and Cassandra. For example, Amazon Redshift is a hosted data warehouse product, which is part of the cloud computing platform. Examples of the file hosting service 172 include Amazon S3, MediaFire, RapidShare, ShareFile and YouSendlt.

Although it is illustrated in the Figures that the database 160 of the media plan generation system 110 is configured as a single system, it is apparent that the database 160 can be configured to have a plurality of databases and that at least one of the subsystems 152, 154, 156 and 158 accompanies its own database.

FIG. 7 illustrates an exemplary architecture of a computing device that can be used to implement aspects of the present disclosure, including any of the computing devices 162, 164, 166 and 168. The computing device illustrated in FIG. 7 can be used to execute the operating system, application programs, and software modules (including the software engines) described herein. By way of example, the computing device will be described below as the computing device 162 of the data transformation subsystem 152. To avoid undue repetition, this description of the computing device will not be separately repeated herein for each of the other computing devices, including the computing devices 164, 166 and 168, but such devices can also be configured as illustrated and described with reference to FIG. 7.

The computing device 162 includes, in some embodiments, at least one processing device 180, such as a central processing unit (CPU). A variety of processing devices are available from a variety of manufacturers, for example, Intel or Advanced Micro Devices. In this example, the computing device 162 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 162 include a desktop computer, a laptop computer, a tablet computer, a mobile computing device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 162, such as during start up, is typically stored in the read only memory 186.

The computing device 162 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 162.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 192 or memory 182, including an operating system 196, one or more application programs 198, other program modules 200 (such as the software engines described herein), and program data 202. The computing device 162 can utilize any suitable operating system, such as Microsoft Windows™, Google Chrome™, Apple OS, and any other operating system suitable for a computing device.

In some embodiments, a user provides inputs to the computing device 162 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch sensitive display device, is also connected to the system bus 184 via an interface, such as a video adapter 218. In addition to the display device 216, the computing device 162 can include various other peripheral devices (not shown), such as speakers or a printer.

When used in a local area networking environment or a wide area networking environment (such as the Internet), the computing device 162 is typically connected to a network through a network interface 220, such as an Ethernet interface. Other possible embodiments use other communication devices. For example, some embodiments of the computing device 162 include a modem for communicating across the network.

The computing device 162 typically includes at least some form of computer readable media. Computer readable media includes any available media that can be accessed by the computing device 162. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 162. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

FIG. 8 is a block diagram of an example data transformation subsystem 152. In some embodiments, the data transformation subsystem 152 includes the media data collection engine 302 and a data conversion engine 304.

The media data collection engine 302 operates to receive the media data 120 from the media data provider 108. An example of the media data collection engine 302 is illustrated and described with reference to FIG. 9.

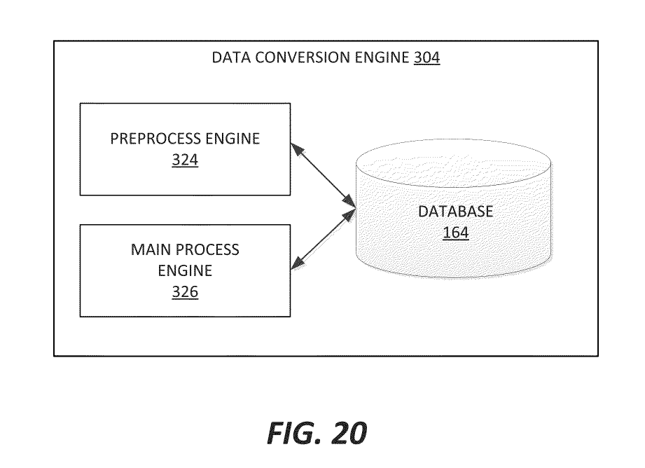

The data conversion engine 304 operates to convert the received media data 120 into a format usable by other components of the media plan generation system 110. An example of the data conversion engine 304 is illustrated and described with reference to FIG. 20.

FIG. 9 illustrates an example operation of the media data collection engine 302 of FIG. 8. In addition to the media data provider 108, the media data 120, and the media data collection engine 302, a household information 306 is shown in the Figure.

The media data collection engine 302 requests the media data 120 from the media data provider 108 by sending household information 306 to the media data provider 108. In return, the media data provider 108 provides the media data 120 to the media data collection engine 302. The media data 120 is collected by the media data provider 108 based upon the household information 306 provided by the media data collection engine 302.

In some embodiments, the media data collection engine 302 can interact with the media data provider 108 via a communications network. Some embodiments of the media data provider 108 include a database server (e.g., a FTP server) that is configured to store the media data 120. The media data collection engine 302 operates to retrieve the media data 120 from the database server of the media data provider 108. In some embodiments, the media data collection engine 302 is configured to interact with the media data provider 108 periodically or during a predetermined period of time a day. For example, the media data collection engine 302 operates to access the media data 120 night time.

In other embodiment, the communication between the media data collection engine 302 and the media data provider 108 involves an administrator of the media plan generation system 110. For example, the administrator of the media plan generation system 110 can place an order for the media data 120 to the media data provider 108 by sending the household information 306 via a communications network, over the phone, and by other either online or offline communications methods. In yet other embodiments, the advertiser 102 can provide the household information 306 to the media data provider 108 either directly or indirectly via the media plan generation system 110 (e.g., the media data collection engine 302). Once the media data provider 108 receives the order or request, the media data provider 108 collects the media data 120 based upon the received household information 306.

Some embodiments of the media data collection engine 302 are developed in Python, a general-purpose, high-level programming language. In other embodiments, the media data collection engine 302 can be made in other programming languages.

The household information 306 is provided to the media data provider 108 and operates as a search query for collecting the media data 120. The household information 306 defines demographic information in which the advertiser 102 is interested for a particular campaign plan. As applied herein, the term “household” may include a single residential address or other like locations to which programming and/or advertising content is communicated for viewing by consumers. Thus, the household information 306 is used to define the scope of the media data 120 that is necessary for generating the media plan 124. In some embodiments, the advertiser 102 may want to target a portion of the consumer 104 having one or more of demographic characteristics, such as ethnographic information, income, level of education, within a particular geographical region (e.g., a geographical bounds of an electoral district), and, therefore, use the household information 306 to sort out the media data 120 and focus only on the media data 120 that are associated with the selected demographic characteristics. The advertiser 102 can determine different target consumers 104 in different campaign plans, depending on campaign strategies, and create the household information 306 reflecting the different target consumers 104.

In some embodiments, the household information 306 includes the names and/or addresses of households. When the media data provider 108 receives the household information 306, the media data provider 108 generates the media data 120 that only contain media measurement data associated with the household information 306. As described below, in the media data 120, each household is identified with a unique household key, instead of actual names, addresses, or other personal or sensitive information. Such a unique key remains consistent for an associated household throughout a predetermined period of time (e.g., a month), and therefore other items in the media data 120 can be identified and arranged by the unique household key.

FIG. 10 illustrates an example of the media data 120. In some embodiments, the media data 120 include a set of audience measurement data 308 and a set of cost data 310.

The audience measurement data 308 include audience measurement and program information. Audience measurement provides how many people and/or who are in an audience. Examples of audience measurement include television viewership, radio listenership, readership of newspaper or magazine, and web traffic on websites.

In some embodiments, audience measurement also includes geographic and demographic information of the viewers including location information with a household. In some embodiments, geographic data include market, country, state, county, street, house number, congressional district, state legislative district, municipal district, zip code, census data, census block, latitude and longitude, GPS coordinates, cable television zone, current location, work location, home location, and the like. Demographic data may be linked or otherwise associated with the geographic data to allow micro-targeting of segments of voters sharing one or more demographics. In some embodiments, demographic data include gender, age, income level, race, ethnicity, knowledge of languages, disabilities, mobility, home ownership, employment status, and the like. In other embodiments, demographic data also include demographic information and behavioral information, including issues a consumer (or a voter in a political campaign) is interested in, party registration (in case of a political campaign), voting frequency or last time the person voted, websites the consumer has visited, browsing history, email lists or social networks the person has joined.

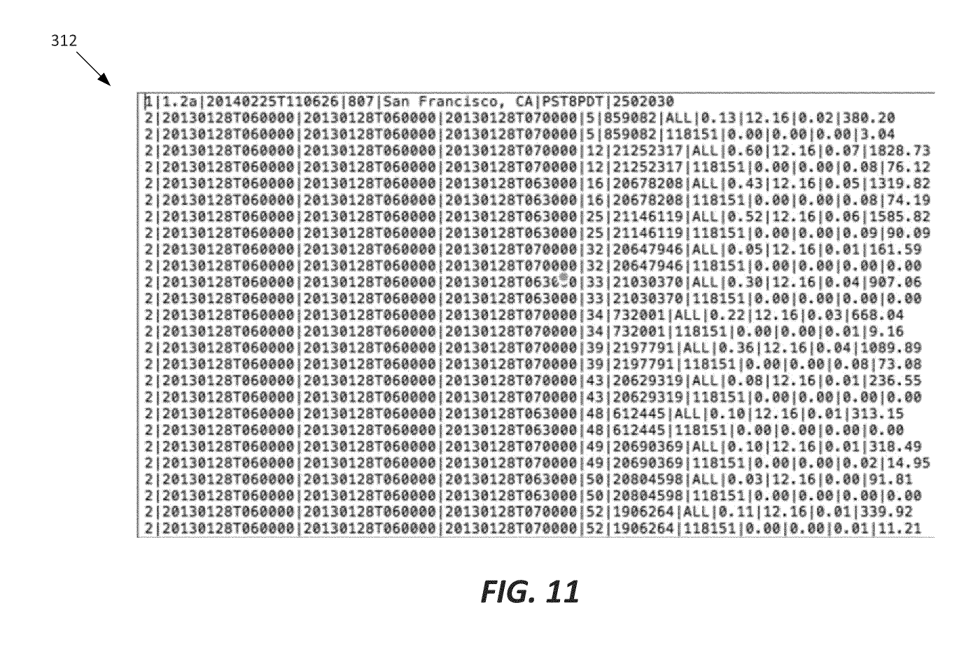

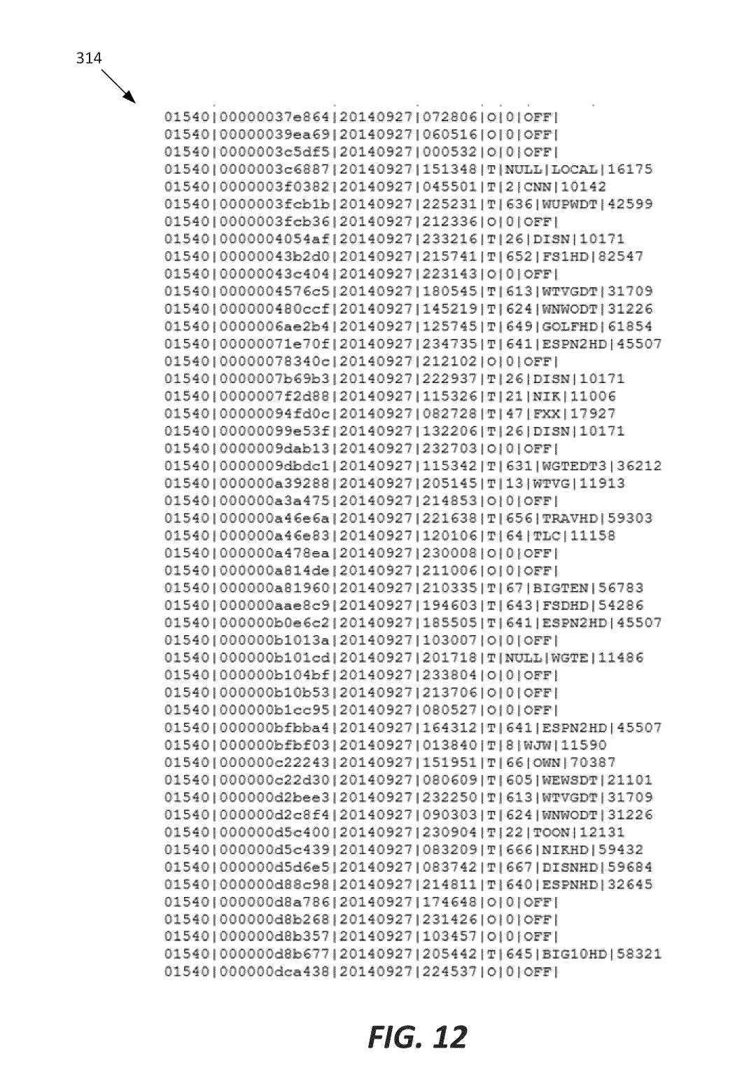

In some embodiments, the audience measurement data 308 are obtained by one or more media data collection devices 118 (FIG. 1). Examples of audience measurement include rating data generated by Rentrak and FourthWall. Rating data are measurement of viewership of a particular program. An example of Rentrak data is described and illustrated with reference to FIG. 11. An example of FourthWall data is described and illustrated with reference to FIG. 12.

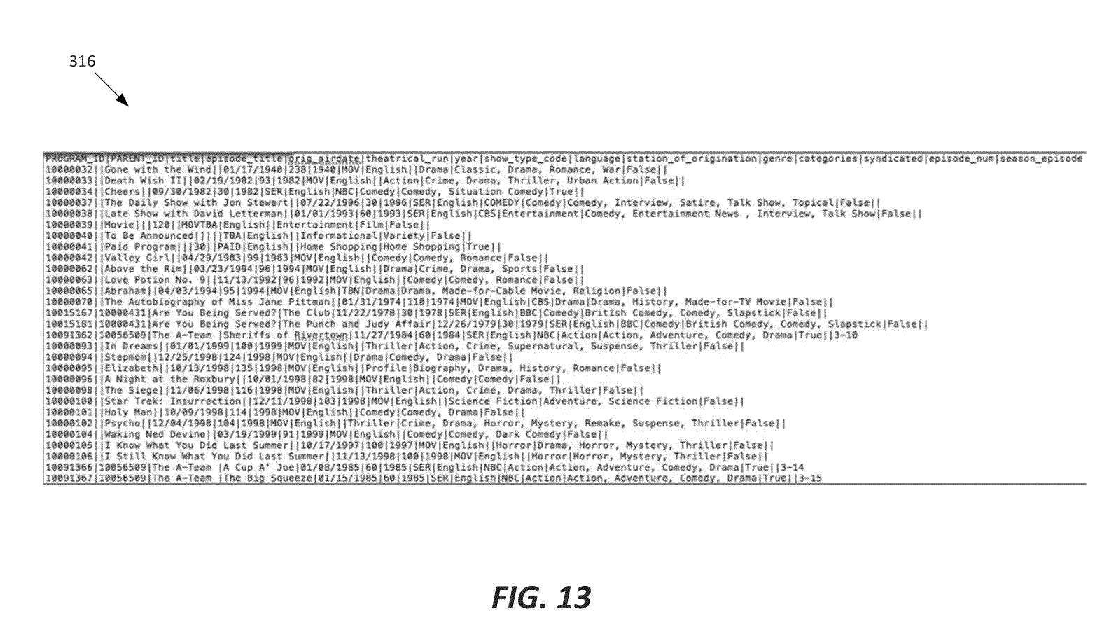

Program information provides a program aired during a certain period of time. Examples of program information include program data generated by Fyi. An example of Fyi data is described and illustrated with reference to FIG. 13.

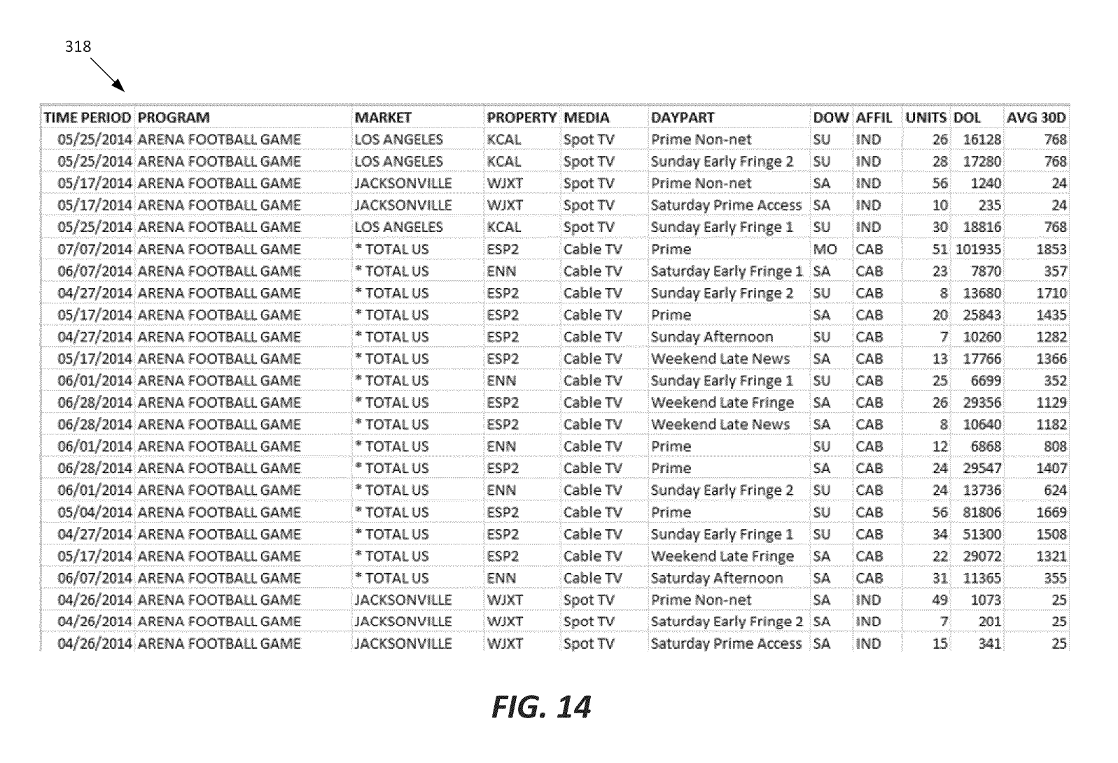

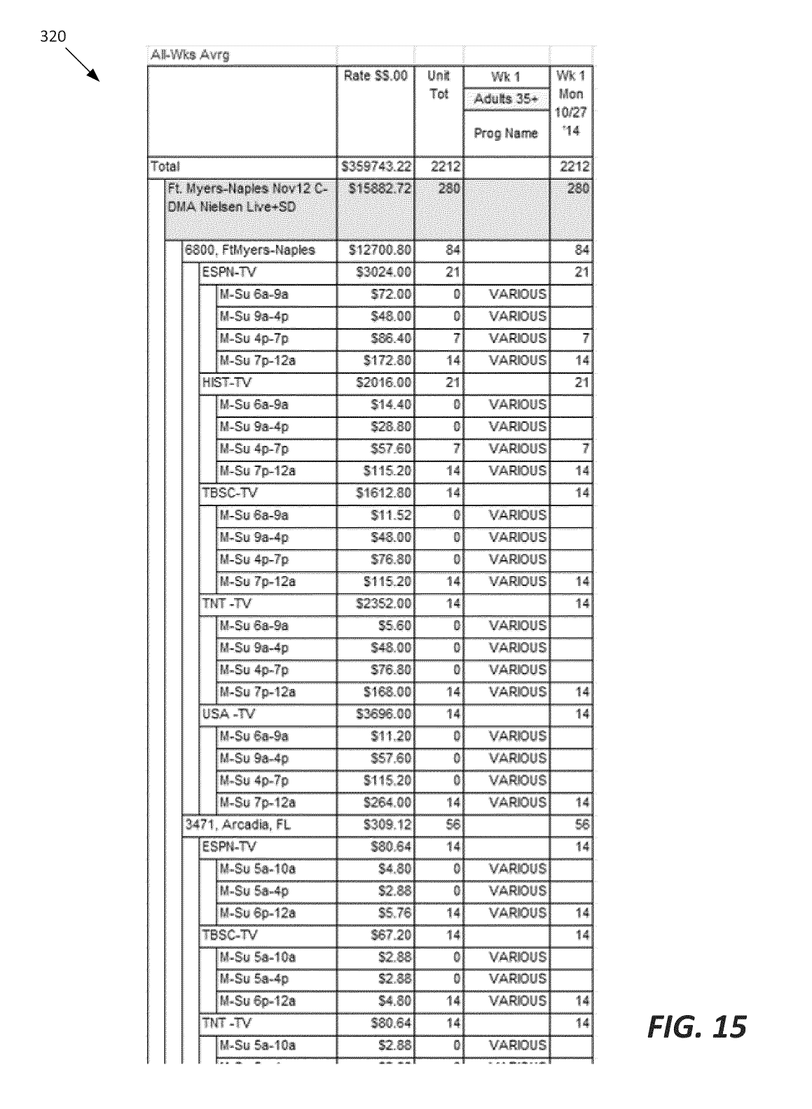

The cost data 310 include pricing information about each placement block for advertising media content 114 (e.g., advertising content). Examples of the cost data include data from Kantar and rate cards of various types. An example of Kantar data is described and illustrated with reference to FIG. 14. Examples of various rate cards are described and illustrated with reference to FIGS. 15-19.

FIG. 11 illustrates a portion of example audience measurement data 312 provided by a media data provider 108. In some embodiments, the media data provider 108 includes Rentrak Corporation. In some embodiments, the measurement data 312 is obtained using one or more media data collection devices 118, such as set top boxes, installed in each household so as to provide aggregated set top box data. The measurement data 312 become part of the media data 120. The measurement data 312 provide aggregated viewership information, such as how many viewers were exposed to commercials or advertisements in a campaign. In some embodiments, the measurement data 312 include a total number of viewers at a predetermined time. For example, the measurement data 312 update the report of the number of viewers in increments of 15 minutes.

FIG. 12 illustrates a portion of example measurement data 314 provided by a media data provider 108. In some embodiments, the media data provider 108 includes FourthWall Media, Comcast, Time Warner, Charter, and other cable providers. In some embodiments, the measurement data 314 is obtained using one or more media data collection devices 118, such as set top boxes, installed in each household so as to provide individual set top box events. The measurement data 314 is part of the media data 120. The measurement data 314 provide viewership information including individual viewing events. For example, the measurement data 314 record a tuning event every time a viewer changes the channel.

FIG. 13 illustrates a portion of example program data 316 provided by a media data provider 108. In some embodiments, the media data provider 108 includes Fyi, Rovi Corporation (Santa Clara, Calif.), Tribune Media (Chicago, Ill.), and other vendors. The program data 316 is part of the media data 120. The program data 316 provide program information. For example, the program data 316 include a list of programs aired during a certain period of time.

As described herein, the measurement data 312, the measurement data 314, and the program data 316 are cross-referenced and at least partially combined by the data transformation subsystem 152 to produce as much detailed viewership information as necessary to generate the media plan 124. In some embodiments, the combined data can include information about what program individual viewers were watching at a certain time and how many viewers were watching the program at the time. Further, in some embodiments, the data transformation subsystem 152 can operate to eliminate overlap of viewership in calculating advertising reach data.

FIG. 14 illustrates a portion of example cost data 318 provided by a media data provider 108. In some embodiments, the media data provider 108 includes Kantar Stradegy™ and SQAD®. The cost data 318 can include historical pricing data and is part of the media data 120. The cost data 318 include aggregated pricing information by network. For example, the cost data 318 provide an aggregate cost of a placement block (i.e., a slot for advertising media content) during a certain program on a certain data. The cost data 318 can include historical costs for advertising media content.

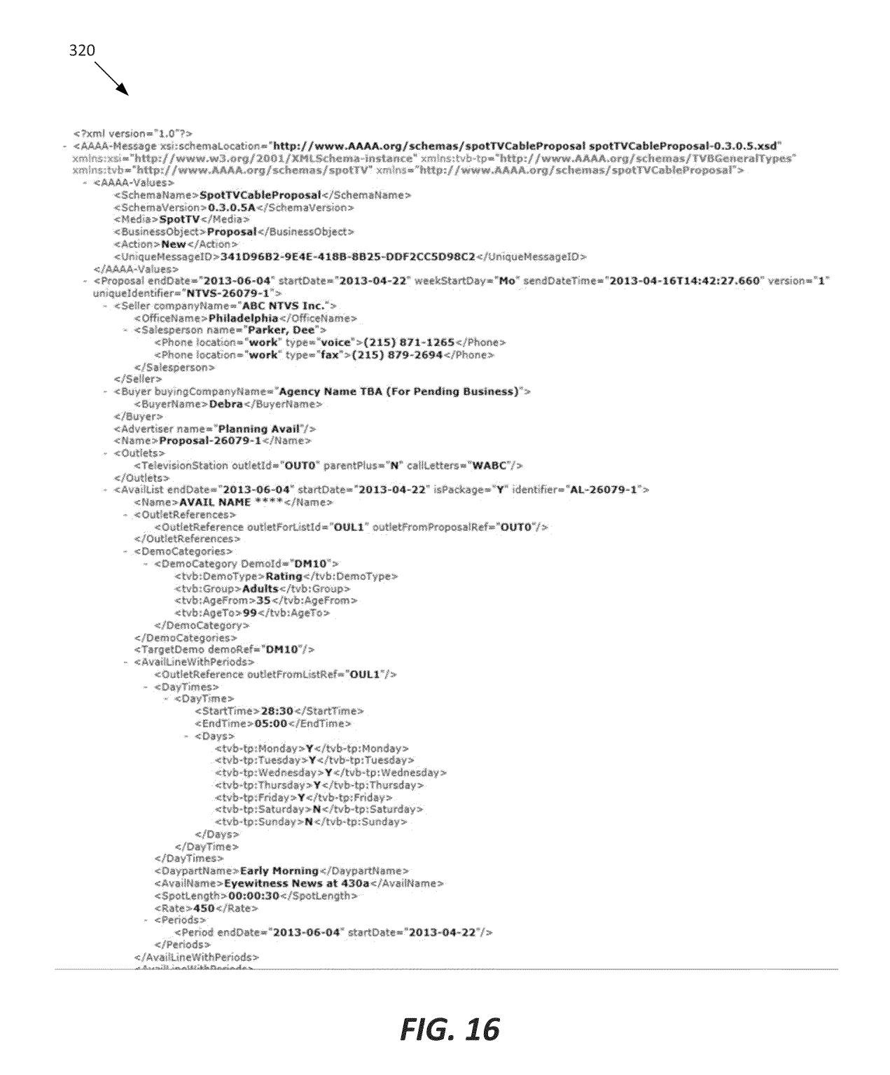

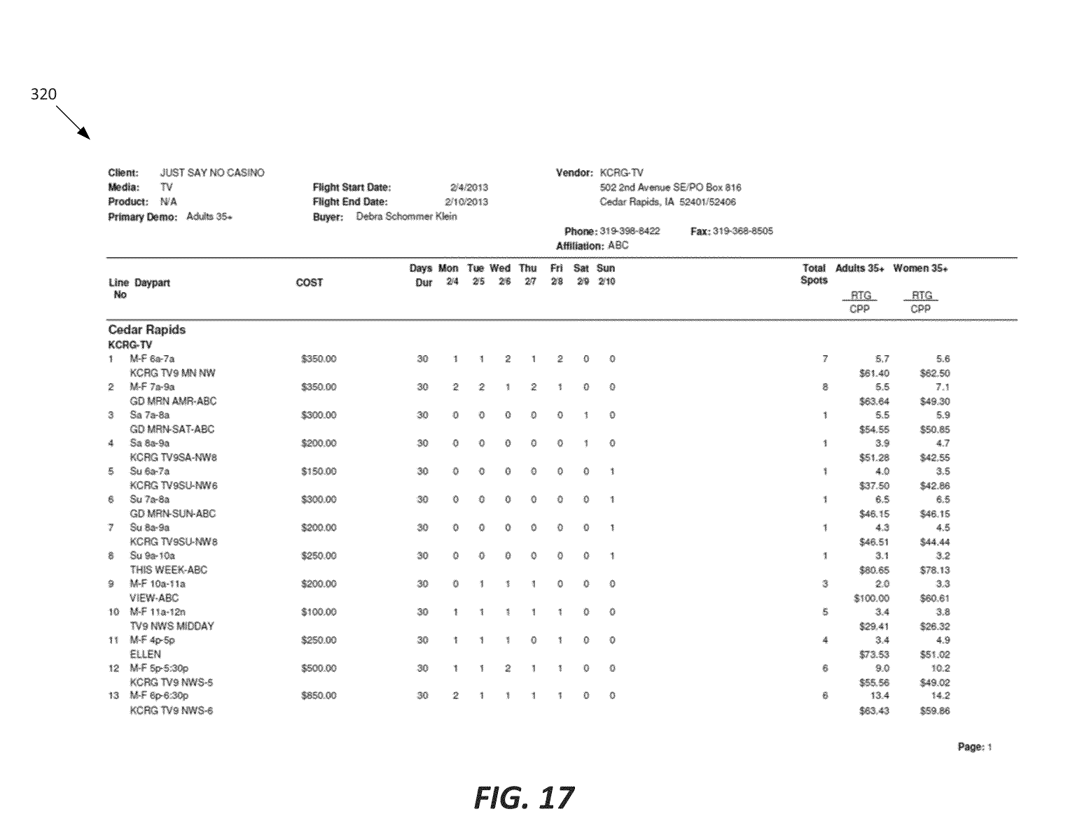

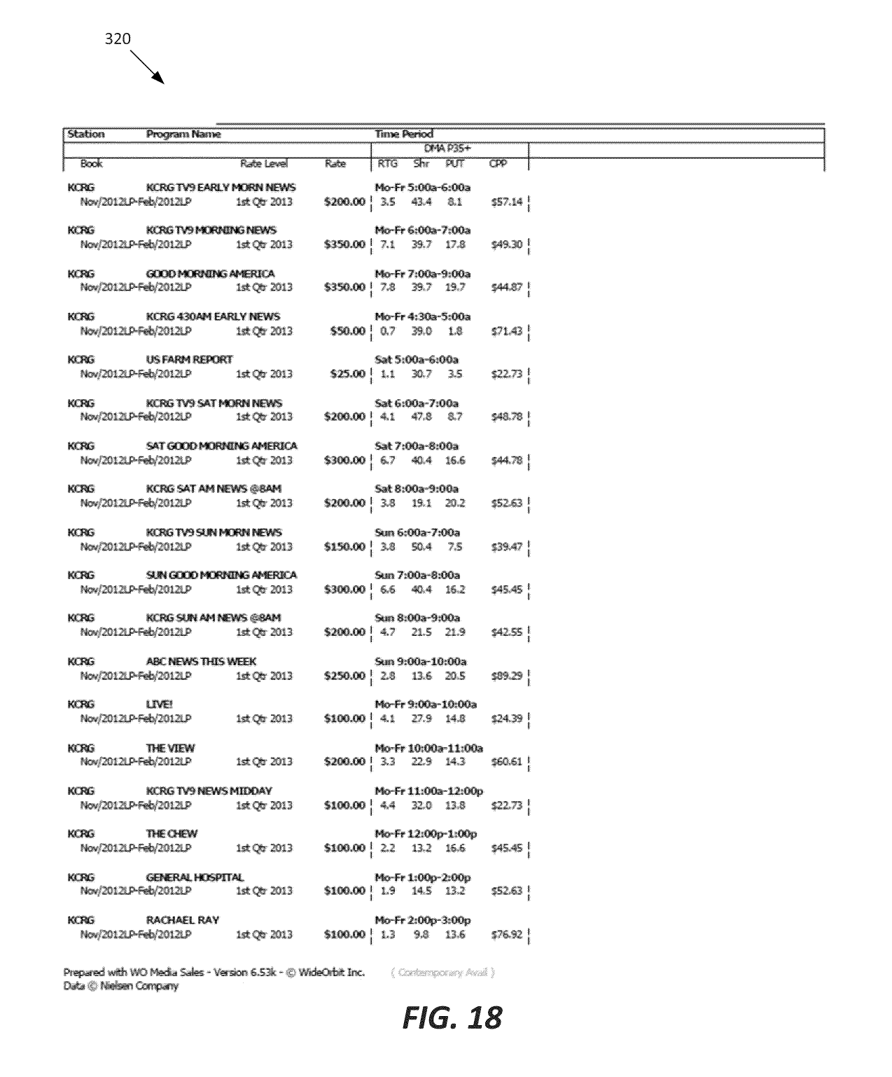

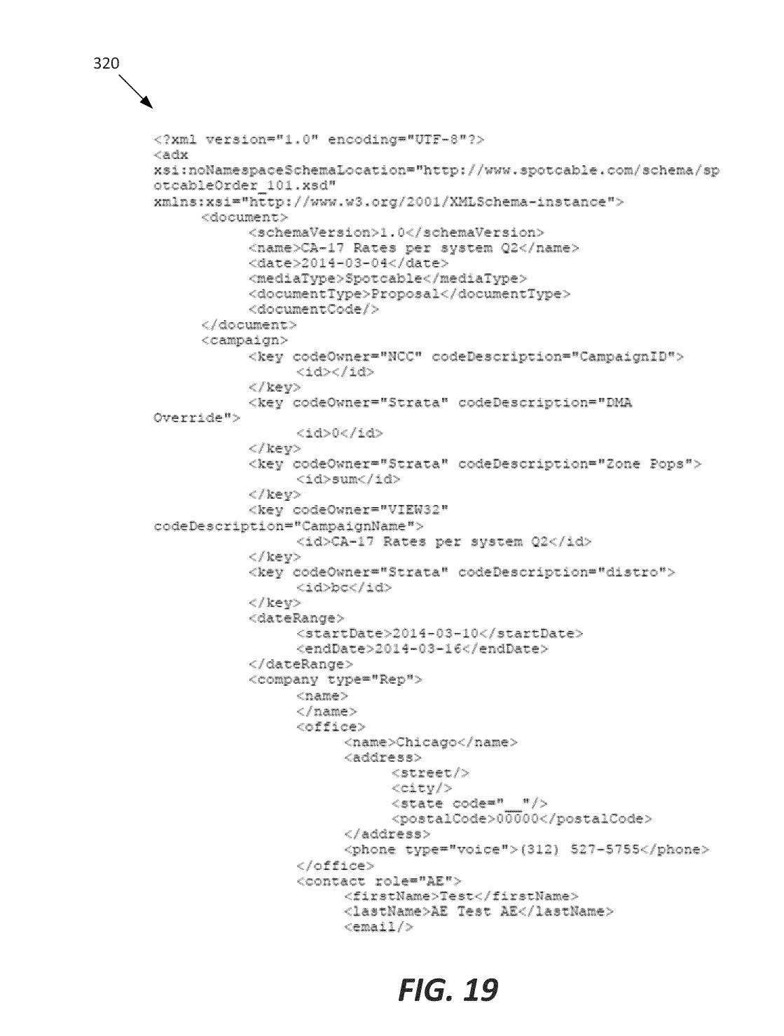

FIGS. 15-19 illustrate examples of various rate cards 320. The rate cards 320 are designed to provide costs or rates of possible placement blocks. For example, the rate cards 320 suggest a list of rates for placement blocks on different television programs at different dates and times. As illustrated in FIGS. 15-19, some embodiments of the rate cards 320 are provided by different media data providers 108 in different formats. Example formats available for the rate cards 320 include XML, SCX, PDF, XLSX, and other formats suitable to provide cost data. FIG. 15 is an example rate card 320 in XLSX format. Rate information is arranged in cells along one of columns in a XLSX sheet. FIG. 16 is an example rate card 320 in XML format. FIG. 17 is an example rate card 320 in PDF format. FIG. 18 is another example rate card 320 in PDF format. FIG. 19 is an example rate card 320 in SCX format.

FIG. 20 is a block diagram of an example data conversion engine 304. In some embodiments, the data conversion engine 304 includes a preprocess engine 324 and a main process engine 326.

In general, the data conversion engine 304 operates to transform the media data 120 into a format usable in other components of the media plan generation system 110.

The preprocess engine 324 operates to process the media data 120 to be properly stored in the database 160. In some embodiments, the preprocess engine 324 manipulates different documents or files in the media data 120 to be in a format storable in the database 160 (e.g., the data warehouse 170). For example, the preprocess engine 324 is configured to delimit the media data 120, add extra fields in the media data 120, and/or compress the media data 120 in a predetermined format (e.g., gzip).

The media data 120 treated by the preprocess engine 324 is stored in the database 160. In some embodiments, where the database 160 includes a file hosting service 172 and a data warehouse 170, the media data 120 are first stored in the file hosting database 172 (e.g., Amazon S3), which are then copied from the file hosting database to the data warehouse 170 (e.g., Amazon Redshift).

Some embodiments of the preprocess engine 324 are developed in Python, a general-purpose, high-level programming language. In other embodiments, the preprocess engine 324 can be made in other programming languages.

The main process engine 326 operates to manage the media data 120 that have been processed by the preprocess engine 324, such that the media data 120 is appropriately transformed to be usable by other components of the media plan generation system 110, such as the data management subsystem 154 thereof. In some embodiments, the main process engine 326 operates to indicate the status of the media data 120. For example, the main process engine 326 mark documents or files of the media data 120 as be started, imported, or failed. In other embodiments, the main process engine 326 operates to manage the media data 120 to clean, normalize, join, and enrich the media data 120 into a format usable by the data management subsystem 154 in subsequent processes.

The media data 120 managed by the main process engine 326 are stored in the database 160 (e.g., a data warehouse 170). In some embodiments, the main process engine 326 is configured to interact with the database 160 periodically or during a predetermined period of time a day. For example, the media data 120 can be transferred to the database 160 night time.

Some embodiments of the main process engine 326 run Structured Query Language (SQL) to manage the media data 120 stored in the database 160.

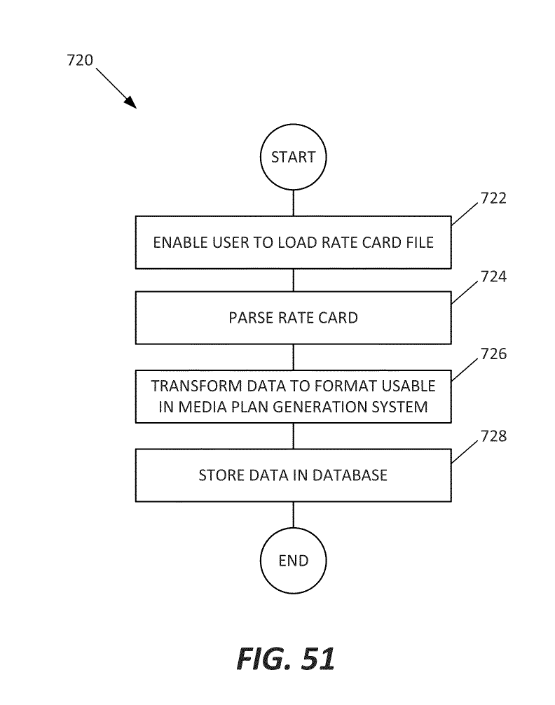

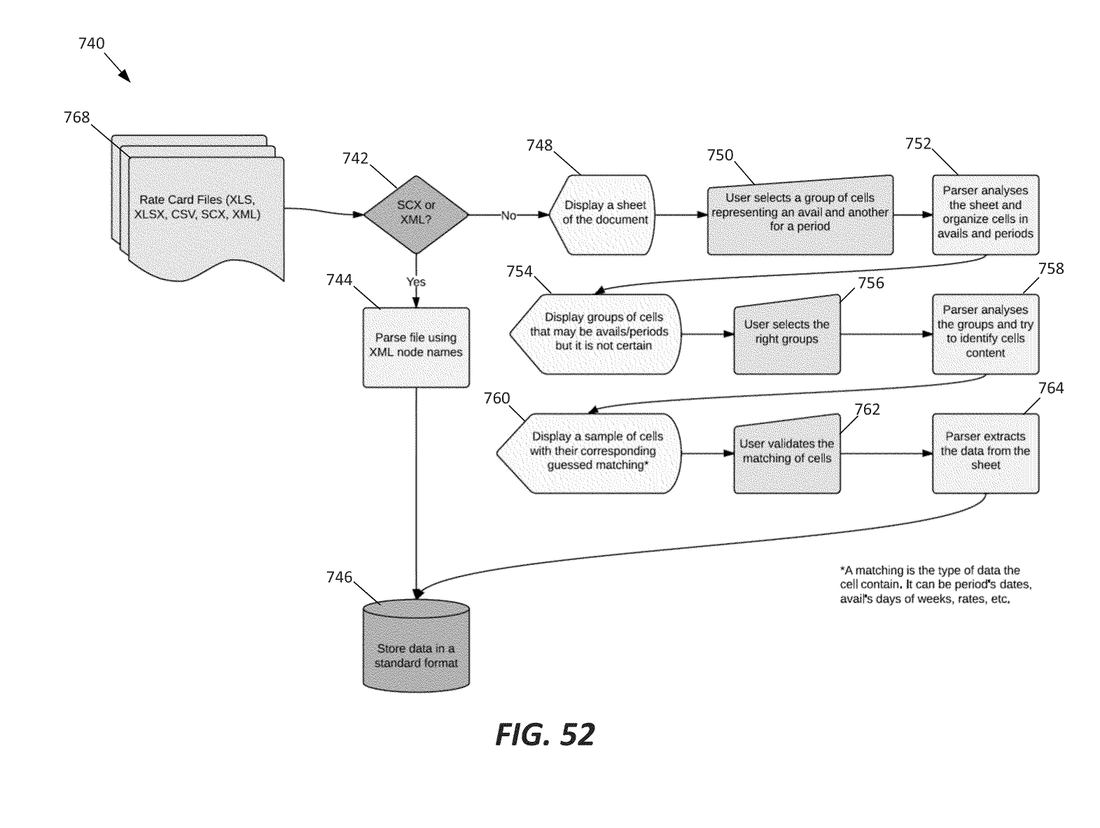

As described above, the media data 120 are automatically transformed by the data transformation subsystem 152 (e.g., the preprocess engine 324 and the main process engine 326) into a format usable in other components of the media plan generation system 110 (e.g., the database 160 and the data management subsystem 154). In other embodiments, at least some of the media data 120 require a manual manipulation to transform the media data 120 into the appropriate format. For example, at least some of the rate cards generated in different formats cannot be automatically managed by data transformation subsystem 152 and require a human involvement in identifying relevant portions of the rate cards. An example of the manual transformation of the media data 120 is illustrated and described in more detail, along with the user interaction subsystem 158, with reference to FIGS. 51 and 52.

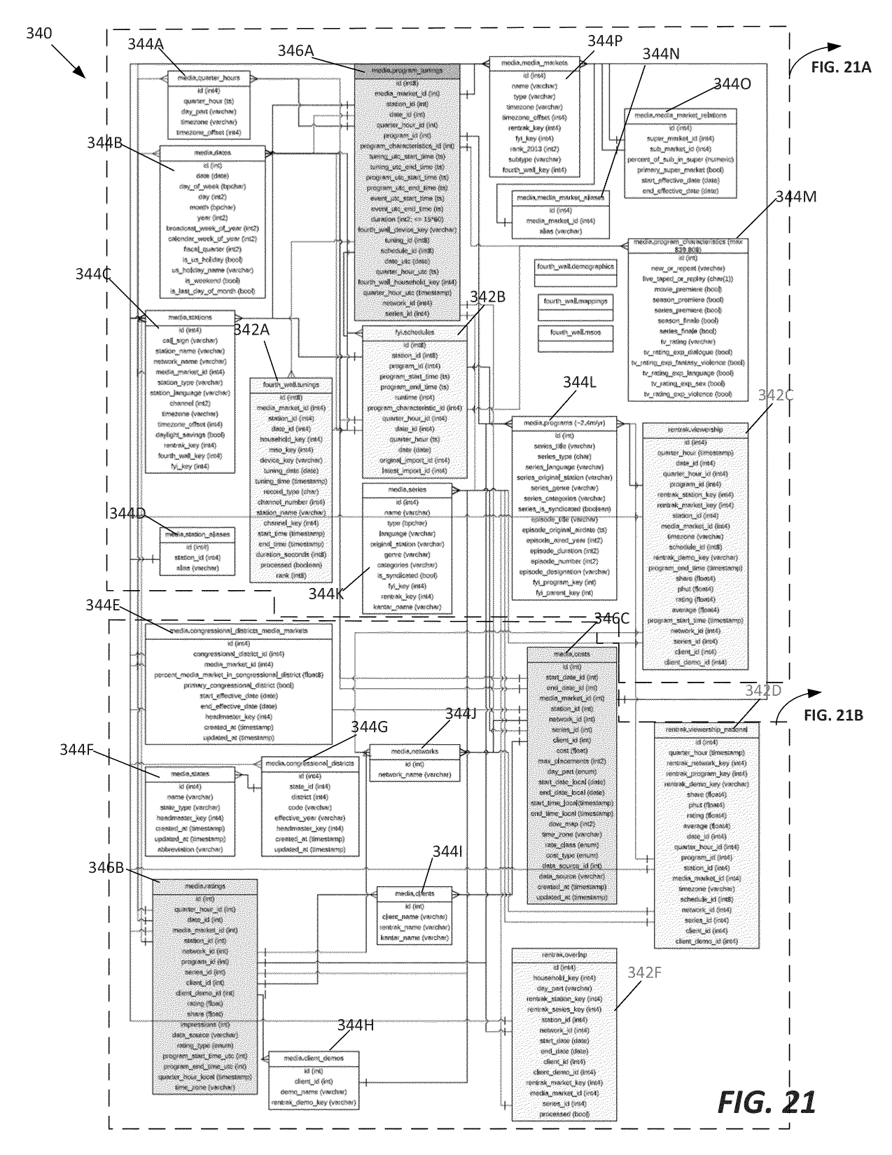

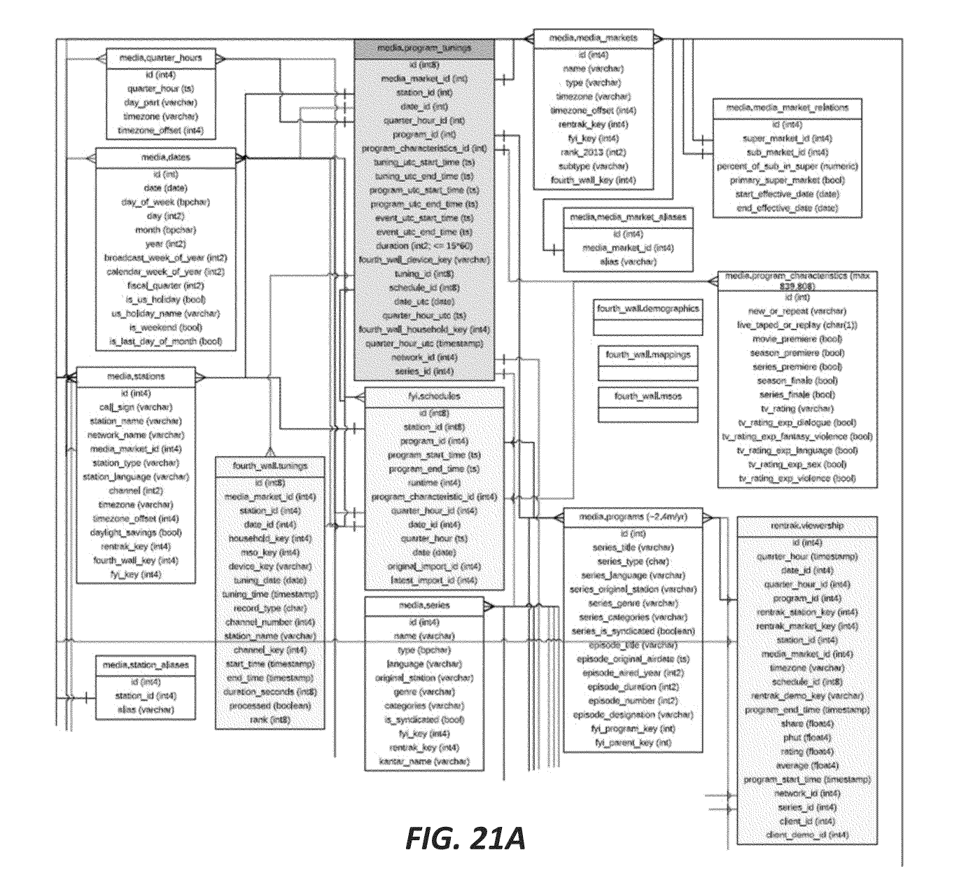

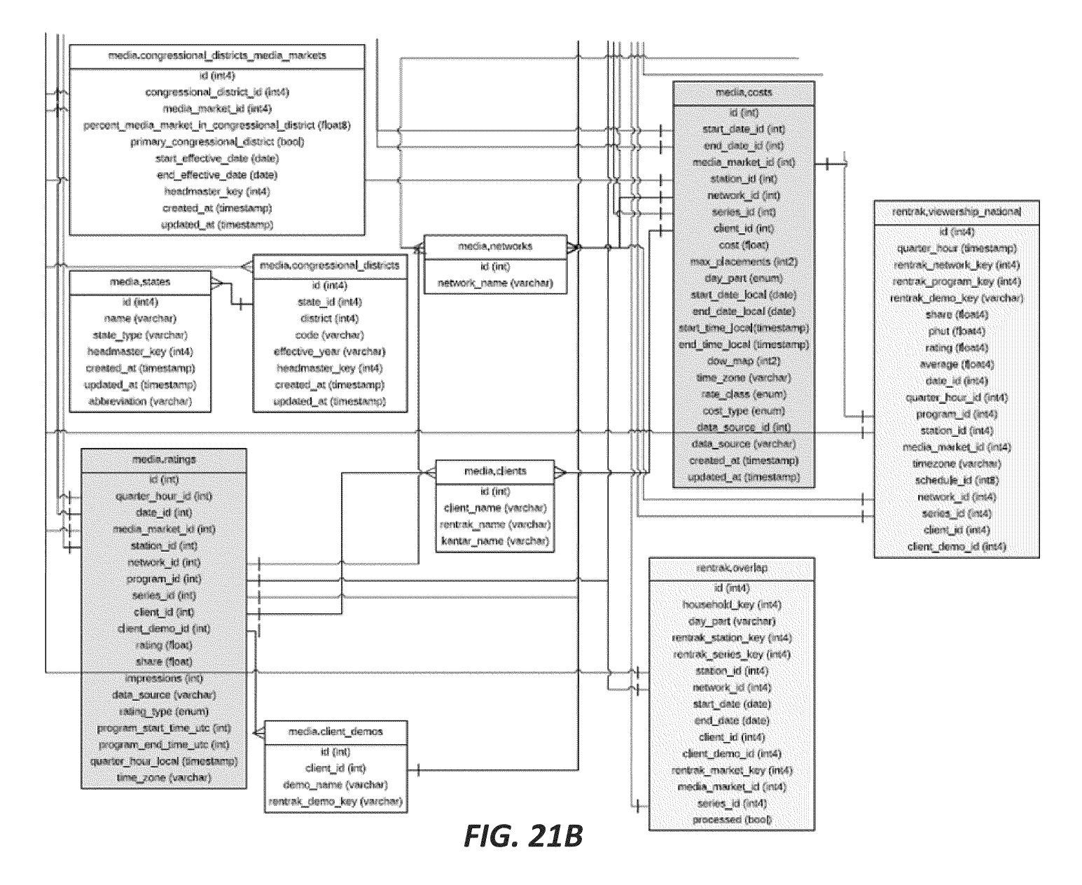

FIG. 21 is an example schema 340 of the database 160. FIG. 21A is a portion of the schema 340 of FIG. 21, and FIG. 21B is the other portion of the schema 340 of FIG. 21. The database schema 340 defines the structure of the media data 120 managed by the data transformation subsystem 152. In some embodiments, the database schema 340 includes raw media data tables 342 (including 342A-342F), bridge tables 344 (including 344A-344P), and fact tables 346 (including 346A, 346B and 346C).

The raw media data tables 342 present structures of the raw media data 120 provided by the media data provider 108. As illustrated, the raw media data tables 342 include a plurality of raw media data tables 342A-342F. In some embodiments, the plurality of raw media data tables 342A-342F can be associated with the raw media data 120 including tunings information (e.g., “fourth_wall.tunings” 342A), schedules information (e.g., “fyi.schedules” 342B), viewership information (e.g., “rentrak.viewership” 342C), national viewership information (e.g., “rentrak.viewership_national” 342D), and overlap information (e.g., “rentrak.overlap” 342F).

The bridge tables 344 present structures of the media data 120 that have been managed by the preprocess engine 324 of the data conversion engine 304. The bridge tables 344 are created based upon the raw media data 120 provided by the media data provider 108. As illustrated, the bridge tables 344 includes a number of tables 344A-344S that are categorized by different items, such as the states, congressional districts, clients, media markets, media market relations, media market aliases, networks, stations, station aliases, programs, series, and program characteristics.

The fact tables 346 are structures of the media data 120 that have been transformed by the main process engine 326 of the data conversion engine 304. The fact tables 346 are generated based upon the bridge tables 344 and/or the raw media data tables 342. In some embodiments, the media data 120 represented by the fact tables 346 are used as input to the data management subsystem 154. Examples of the fact tables 346 include a first fact table 346A, a second fact table 346B, and a third fact table 346C. The first fact table 346A is designed to include information about program tuning events, which is also referred to herein as program data. The second fact table 346B is used to provide information about costs, which is also referred to herein as cost data. The third fact table 346C is designed to include information about ratings, which is also referred to herein as ratings data.

The schema 340 is not limited to the tables illustrated in FIG. 21. In other embodiments, the database schema 340 includes additional tables associated with the tables listed therein. In yet other embodiments, some of the tables in the schema 340 are replaced by other tables as necessary.

FIG. 22 is a block diagram of an example data management subsystem 154. In some embodiments, the data management subsystem 154 includes a user interaction subsystem communication engine 350, an advertising options data file generation engine 352, a plan generation subsystem management engine 354, and a user interface engine 356.

The user interaction subsystem communication engine 350 is configured to interact with the user interaction subsystem 158 to receive input from the advertiser 102 and send various outputs to the user interaction subsystem 158 so that the user interaction subsystem 158 presents the outputs to the advertiser 102. In some embodiments, the user interaction subsystem communication engine 350 operates to receive various inputs from the advertiser 102 via the user interaction subsystem 158. For example, the communication engine 350 receives various requests from the advertiser 102. Examples of the requests include a request for checking an operational status of the plan generation subsystem 156 and a request for editing the operational parameters of the plan generation subsystem 156. Further, the communication engine 350 is configured to receive the plan parameters 122 from the advertiser 102 via the user interaction subsystem 158.

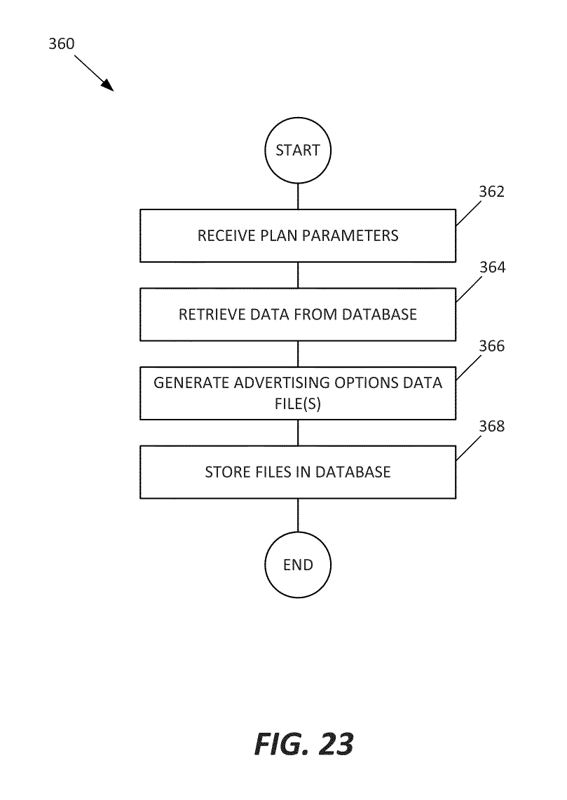

The advertising options data file generation engine 352 operates to generate an advertising options data file 371 from the transformed media data 120 such that the plan generation subsystem 156 utilizes the advertising options data file 371 to generate the media plan 124. An example of the advertising options data file generation engine 352 is illustrated and described in more detail with reference to FIGS. 23 and 24.

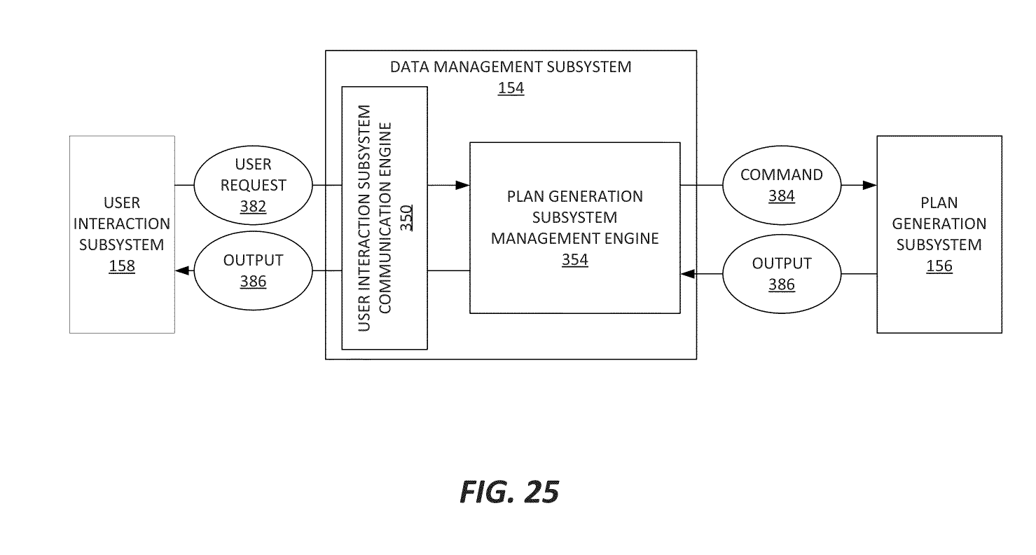

The plan generation subsystem management engine 354 operates to manage the plan generation subsystem 156 and monitor the operational status of the plan generation subsystem 156. An example of the plan generation subsystem management engine 354 is illustrated and described in more detail with reference to FIG. 25.

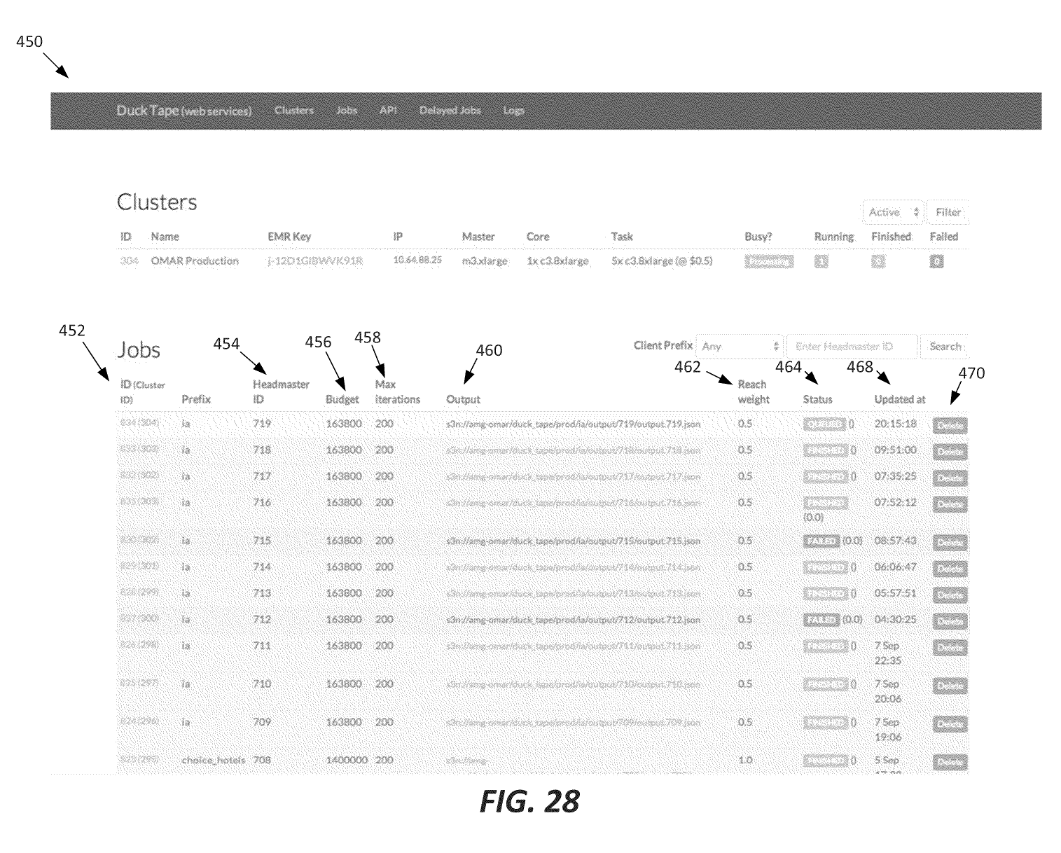

The user interface engine 356 provides an interface 450 (FIG. 28) for a user of the data management subsystem 154 to manage the subsystem 154 and output various pieces of information about the operation of the data management subsystem 154. In some embodiments, the user interface engine 356 provides a web-based interface to a user of the media plan generation system 110. For example the user interface engine 356 operates as a web domain to serve a website to a user of the media plan generation system 110. An example of the interface 450 is illustrated and described in more detail with reference to FIG. 28.

FIG. 23 is a flowchart of an example method 360 of operating the advertising options data file generation engine 352. In some embodiments, the method 360 includes operations 362, 364, 366, and 368.

At the operation 362, the advertising options data file generation engine 352 operates to receive the plan parameters 122 via the user interaction subsystem communication engine 350.

At the operation 364, the engine 352 operates to retrieve the media data 120 from the database 160. As described above, the media data 120 have been transformed by the data transformation subsystem 152 to be usable by the data management subsystem 154.

At the operation 366, the engine 352 operates to generate one or more adverting options data files 371 based upon the media data 120. As described below, the advertising options data files 371 is configured and used to define all possible placement blocks 132 includable in the media plan 124.

At the operation 368, the engine 352 operates to store the advertising options data files 371 in the database 160 for subsequent uses by other components of the media plan generation system 110, such as the plan generation subsystem 156.

FIG. 24 is a block diagram of an example advertising options data file generation engine 352. In some embodiments, the advertising options data file generation engine 352 includes a first file generation engine 370 for generating first and second advertising options data files 372 and 374 and a second file generation engine 376 for generating a third advertising options data file 378. The first, second, and third advertising options data files 372, 374 and 378 can be collectively referred to herein as an advertising options data file 371.

The first file generation engine 370 operates to generate the first and second advertising options data files 372 and 374. In some embodiments, the first file generation engine 370 receives the plan parameters 122 from the user interaction subsystem 158 via the user interaction subsystem communication engine 350. As described herein, examples of the plan parameters 122 include information about the client (e.g., the advertiser 102), selection of rate cards, a purchase period, information about demographics, and information about advertising restrictions. The first file generation engine 370 further retrieves the transformed media data 120 from the database 160 of the data transformation subsystem 152. As described above, the transformed media data 120 include the cost data, the ratings data, and the program data. Then, the first file generation engine 370 uses the plan parameters 122 and the media data 120 to create the first and second advertising options data files 372 and 374. The first and second advertising options data files 372 and 374 are saved in the database 160 for subsequent access by the plan generation subsystem 156.

The first advertising options data file 372, in some embodiments, relates to information about restrictions in advertising. Examples of the advertising restrictions include the type of restrictions, the capped number of advertising, limitations on dates and times at which the advertisement is aired, limitations on networks, limitations on program series, and other possible restrictions in determining the placement blocks 132. In some embodiments, the first advertising options data file 372 is generated as a comma-separated values (CSV) file.

The second advertising options data file 374, in some embodiments, includes information about costs of placement blocks 132. In some embodiments, the second advertising options data file 374 is generated as a comma-separated values (CSV) file.

In some embodiments, the first and second advertising options data files 372 and 374 are generated as a single file.

The second file generation engine 376 operates to generate the third advertising options data file 378. Similarly to the first file generation engine 370, the second file generation engine 376 receives the plan parameters 122 from the user interaction subsystem 158 via the user interaction subsystem communication engine 350, and retrieves the transformed media data 120 from the database 160. Then, the second file generation engine 376 uses the plan parameters 122 and the media data 120 to create the third advertising options data file 378. The third advertising options data file 378 is saved in the database 160 for subsequent access by the plan generation subsystem 156.

The third advertising options data file 378, in some embodiments, relates to reach data. For example, the third advertising options data file 378 includes a sample of households that watched a program series during a predetermined period of time. Examples of the third advertising options data file 378 include program series, networks, dayparts (e.g., late fringe, post late fringe, early morning, daytime, early fringe, prime access, prime time, and late news), media markets, number of quarter hours, ratings, and a list of households watching. In some embodiments, the second advertising options data file 374 is generated as a comma-separated values (CSV) file.

In some embodiments, the first, second, and third advertising options data files 372, 374 and 378 are generated as a single file, such as the advertising options data file 371.

As described above, in other embodiments, the database 160 can be configured to include the file hosting database 172 (e.g., Amazon S3) and the data warehouse 170 (e.g., Amazon Redshift). In some embodiments, the media data 120 are stored in the data warehouse 170, and thus the first and second file generation engines 370 and 376 accesses the data warehouse to retrieve the media data 120. In this configuration, the first and second file generation engines 370 and 376 can save the first, second and third advertising options data files 372, 374 and 378 in the file hosting database 172, and the plan generation subsystem 156 access the file hosting database 172 to retrieve the files 372, 374, and 378 for subsequent processes, such as the generation of the media plan 124.

FIG. 25 is a block diagram of an example plan generation subsystem management engine 354. Introduced are a user request 382, a command 384, and an output 386.

As described above, the plan generation subsystem management engine 354 operates to control the plan generation subsystem 156 and interact with other components (e.g., the data transformation subsystem 152, the plan generation subsystem 156, and the user interaction subsystem 158) of the media plan generation system 110. In some embodiments, the plan generation subsystem management engine 354 receives a user request 382 via the user interaction subsystem communication engine 350. The user request 382 is input by the advertiser 102 through the user interaction subsystem 158 and then delivered to the plan generation subsystem management engine 354 via the user interaction subsystem communication engine 350. Once receiving the user request 382, the plan generation subsystem management engine 354 sends a command 384 to the plan generation subsystem 156 based upon the user request 382. After the plan generation subsystem 156 processes the command 384 and generates the output 386, the management engine 354 receives the output 386 from the plan generation subsystem 156. In some embodiments, at least part of the output 386 can be retrieved from the database 160 based upon the response from the plan generation subsystem 156. The management engine 354 then delivers the output 386 to the user interaction subsystem 158 so that the advertiser 102 receives the output 386. The user interaction subsystem 158 parses the output 386 and generates a display about the output 386 to the advertiser 102. In some embodiments, the management engine 354 manipulates the output 386 before the output 386 is transmitted to the user interaction subsystem 158, such that the output 386 is in a format usable by the user interaction subsystem 158.

The user request 382 is a request of various types from the advertiser 102. Examples of the user request include a request for checking an operational status of the plan generation subsystem 156, a request for retrieving the media plan 124 generated by the plan generation subsystem 156, and a request for inputting plan parameters 122 to the plan generation subsystem 156.

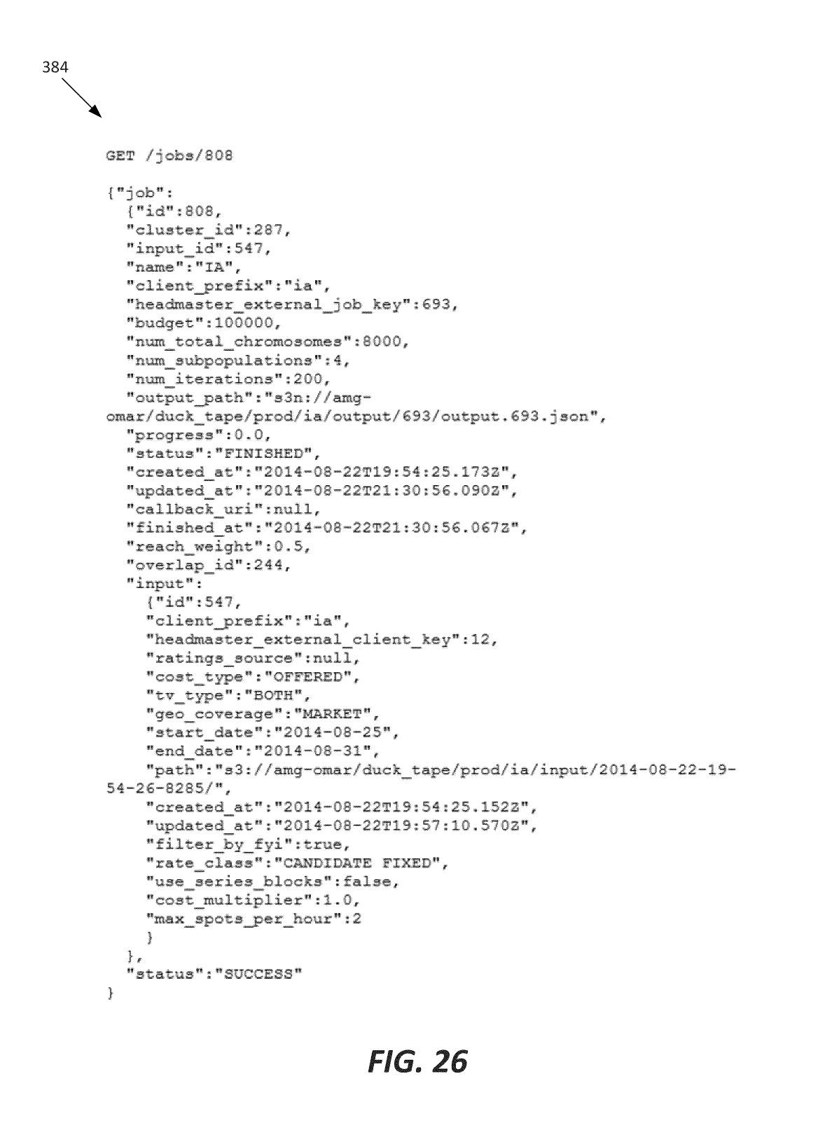

The command 384 is generated by the plan generation subsystem management engine 354 based upon the user request 382 and provides the information for the plan generation subsystem 156 to respond to the command 384 by generating the output 386. An example of the command 384 is illustrated and described in more detail with reference to FIG. 26.

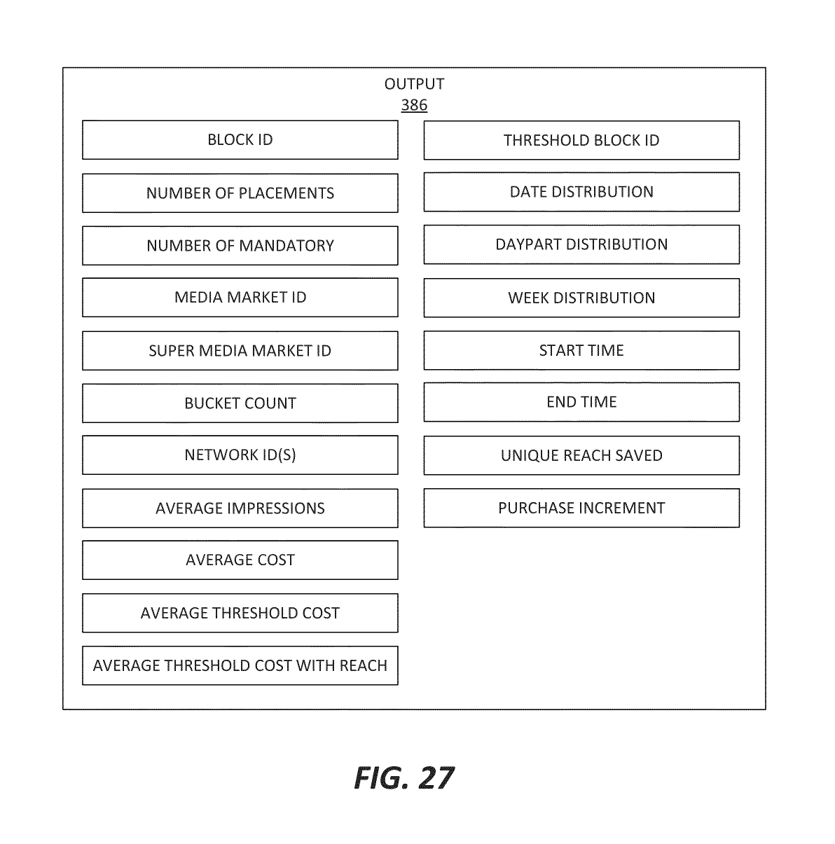

The output 386 is generated by the plan generation subsystem 156 in response to the command 384 and sent back to the plan generation subsystem management engine 354. The output 386 includes data for answering the user request 382. An example of the output 386 is illustrated and described in more detail with reference to FIG. 27.

FIG. 26 illustrates an example format of the command 384 from the plan generation subsystem management engine 354. The command 384 includes the information parsed from the user request 382. In some embodiments, the command 384 is created in JavaScript Object Notation (JSON) format. In other embodiments, the command 384 is generated in other formats suitable for transmitting data objects consisting of attribute-value pairs.

FIG. 27 illustrates an example list of data included in the output 386 received by the plan generation subsystem management engine 354 from the plan generation subsystem 156. In some embodiments, the data contained in the output 386 include a block ID, the number of placements, the number of mandatory placements, a media market ID, a super media market ID, a bucket count, one or more network ID, average impressions, an average cost, an average threshold cost, an average threshold cost with reach, a threshold block ID, a data distribution, a daypart distribution, a week distribution, a star time, an end time, a unique reach save, and/or a purchase increment.

FIG. 28 illustrates an example layout of the interface 450 provided by the user interface engine 356. In some embodiments, the interface 450 includes a job ID 452, a plan generation subsystem ID 454, budget information 456, a number of iterations 458, output information 460, a reach weight 462, a job status 464, a time of update 466, and a job delete button 470.

The interface 450 is configured to display a list of jobs and the status of each job. Further, the interface 450 enables a user of the media plan generation system 110 to manage the jobs, such as deleting one or more of the jobs and searching for one or more jobs by certain criteria.

The job ID 452 identifies an operation of generating each media plan 124 in the plan generation subsystem 156.

The plan generation subsystem ID 454 displays an identification used in the plan generation subsystem 156 to distinguish each operation therein.

The budget information 456 shows a budget set in each operation of generating the media plan 124.

The number of iterations 458 displays the number of iterating process performed in the plan generation subsystem 156 to generate the media plan 124. The iterating process of the plan generation subsystem 156 is further described herein.

The output information 460 indicates the name and location of the output 386 provided by the plan generation subsystem 156.

The reach weight 462 shows a reach weight factor used in each operation of generating the media plan 124. As described herein, the reach weight is used to adjust the balance between reach and frequency in generating the media plan 124. In some embodiments, the reach is generally defined as the number of sample households exposed to a predetermined advertisement in a given plan. Duplicated viewing events by the same household are not considered in calculating the reach. The frequency refers to the number of times an individual viewer is exposed to the predetermined advertisement. The frequency is attained through repetition of the advertisement during a predetermined campaign run period and/or by rotating the advertisement among media types.

In some embodiments, if the reach weight factor is set higher than zero, the media plan 124 is designed to weigh the reach of advertisement result against the frequency of the advertising. As the reach weigh factor increases above zero, the reach is considered to be increased. If the reach weight factor is below zero, the media plan 124 is configured to weigh the frequency of advertising against the reach of advertisement result. As the reach weigh factor decrease below zero, the frequency is considered to be increased.

The job status 464 shows the status of each job. In some embodiments, the job status 464 is selected to be one of “QUEUED,” “FINISHED,” and “FAILED,” which indicate that the job is in process, successfully done, and unsuccessful, respectively.

The time of update 466 indicate a time that the job status has been recently updated.

The job delete button 470 is provided to enable the user to remove the associated job from the operation of the plan generation subsystem 156.

FIG. 29 is a block diagram of an example plan generation subsystem 156. In some embodiments, the plan generation subsystem 156 includes a pre-optimization engine 502 and an optimization engine 504.

The plan generation subsystem 156 operates to generate a media plan 124 with recommended placement blocks 132. The media plan 124 is optimized to satisfy multiple advertising objectives simultaneously. For example, the placement blocks 132 contained the media plan 124 are selected to balance various criteria, such as maximization of impressions, minimization of costs, effective distribution in various periods of time, maximization of reach, and maximization of frequency. In some embodiments, the distribution includes distribution of advertisements over weeks, distribution of advertisements in a day, and distribution of advertisements over days of a week. In some embodiments, the reach is defined as the number of households exposed to one or more advertisements in a given plan divided by the total number of households. In some embodiments, the impression is defined as a single instance of displaying an advertisement to an individual consumer or household.

As such, the generation of an optimized media plan 124 is a multi-objective knapsack problem, which is regarded as a NP-complete problem to which an exact solution is typically infeasible. As described herein, the plan generation subsystem 156 is configured to enable the process of generating the media plan 124 in a reasonable time frame and produce a reliable result of the media plan 124 that closely approximates an optimal solution.

In some embodiments, the plan generation subsystem 156 is configured as a MapReduce backend program executed in the computer cluster 166.

The pre-optimization engine 502 operates to reduce the number of placement blocks based upon one or more criteria so as to reduce a search space (e.g., the range of possible placement blocks for an optimized media plan 124) that is seeded into the optimization engine 504. In general, the pre-optimization engine 502 is configured to filter out marginally efficient placement blocks from all possible placement blocks in order to save operating time of the optimization engine 504 and reduce any notice in the process of the optimization engine 504. This enables the optimization engine 504 to run a process of optimizing the media plan 124 in a shorter time than it may take otherwise.

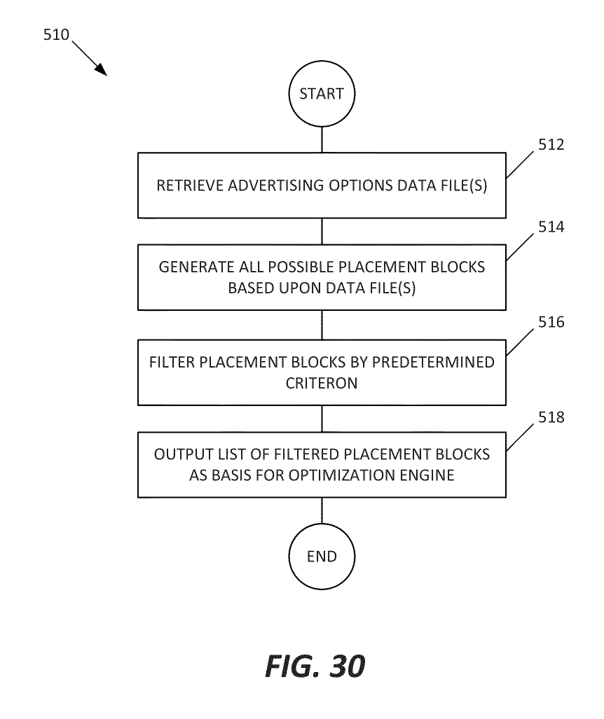

In some embodiments, the criteria used in the pre-optimization engine 502 include frequency and reach. For example, the pre-optimization engine 502 eliminates placement blocks with a marginal level of frequency and/or a marginal level of reach. In other embodiments, other criteria are used to reduce the number of placement blocks that are used by the optimization engine 504. An example of the pre-optimization engine 502 is illustrated and described in more detail with reference to FIG. 30.

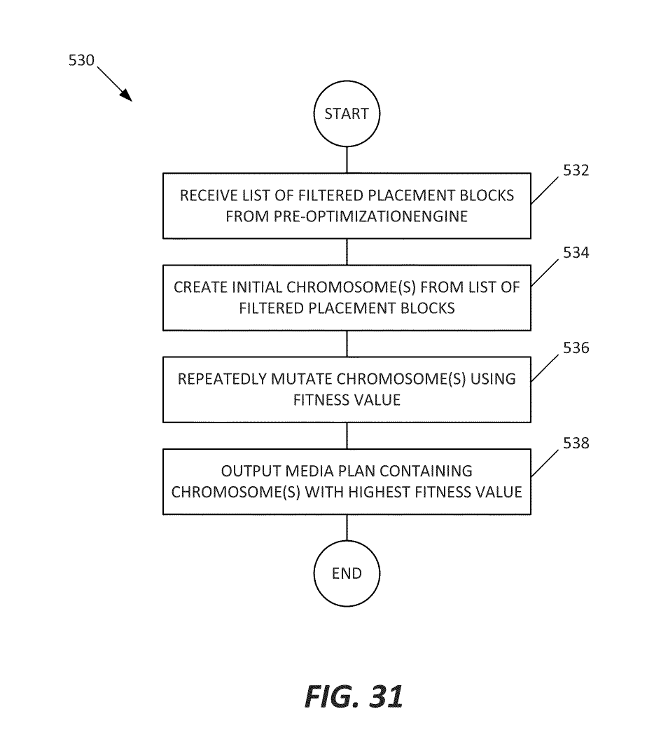

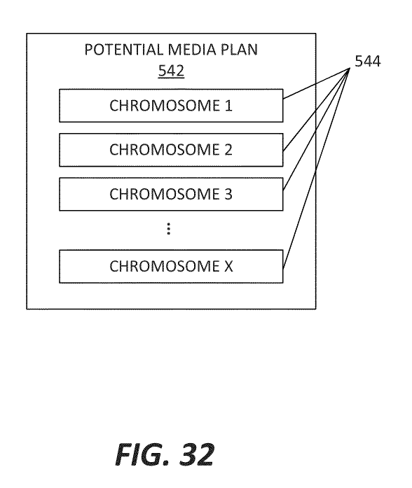

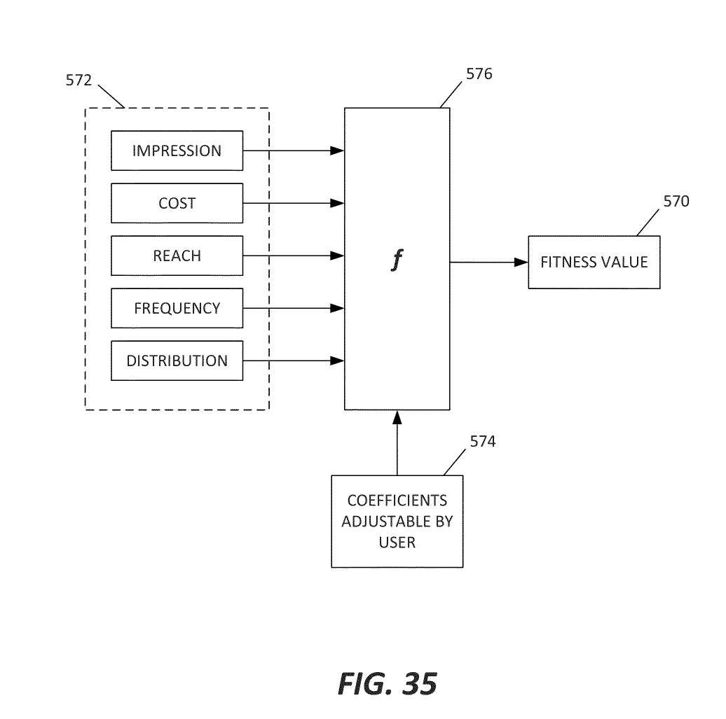

The optimization engine 504 operates to optimize a media plan 124 in a reasonable amount of time. In some embodiments, the optimization engine 504 employs simulation-based optimizations and search heuristics, such as genetic algorithms or simulated annealing, to generate the optimized media plan 124. The optimization engine 504 is configured to evaluate a very large number of possible media plans with a different set of placement blocks. For example, the optimization engine 504 repeatedly compares the candidate media plans (e.g., potential media plans 542 (FIG. 32) to determine the best one of them in a short amount of time, considering one or more criteria (e.g., a fitness value 570 (FIG. 35)). In some embodiment, the criteria used include impressions, the total reach of the plan, and distributions. As described below, iterative modification of the candidate media plan allows the candidate media plan to evolve over time to reach the optimized media plan 124. In some embodiments, the optimization engine 504 operates to return an optimized media plan 124 in not more than 15 minutes. An example of the optimization engine 504 is illustrated and described in more detail with reference to FIG. 31.

FIG. 30 is a flowchart of an example method 510 of operating the pre-optimization engine 502. In some embodiments, the pre-optimization engine 502 includes operations 512, 514, 516, and 518.

At the operation 512, the pre-optimization engine 502 operates to retrieve at least one of the advertising options data files 372, 374 and 378 from the data management subsystem 154. In some embodiments, the advertising options data files 372, 374 and 378 are obtained directly from the database 160. As described above, the advertising options data files 372, 374 and 378 include a variety of information consolidating the media data 120, such as viewership, restrictions, costs and overlap data.

At the operation 514, the pre-optimization engine 502 operates to generate all possible placement blocks based upon the retrieved advertising options data files 372, 374 and 378. All of the placement blocks generated in this operation are candidates for a media plan 124. Some of them are eventually selected into the final result of the media plan 124 by the pre-optimization engine 502 and the optimization engine 504, as described below.

At the operation 516, the pre-optimization engine 502 operates to filter the placement blocks based upon one or more predetermined criteria so that the number of the placement blocks are limited before being used by the optimization engine 504. At least one of the all possible placement blocks are eliminated from candidacy for the media plan 124. In other words, the pre-optimization engine 502 selects only some of the placement blocks that are most likely to fit the media plan 124. The selected placement blocks are used as a basis for operation of the optimization engine 504 as a starting point. The selected placement blocks functions as a narrowed search basis that is used by the optimization engine 504, thereby speeding up the process of the optimization engine 504. In some embodiments, the placement blocks can be selected based upon the number of impressions that results from the placement blocks. The higher impression a placement block has, the more likely the placement block is selected. In other embodiments, the placement blocks are selected in terms of one or more other characteristics. In other embodiments, the placement blocks can be selected based upon other criteria, such frequency and reach.

In some embodiments, the criteria used in the operation 516 include a budget-related criterion. For example, the placement blocks are selected to the extent that the total cost of the placement blocks selected does not exceed the budget-related criterion. In some embodiments, the budget-related criterion is a budget of the media plan 124 multiplied by a budget multiplier. The budget multiplier is adjusted depending on the size of the placement blocks selected to be used by the optimization engine 504. For example, as the budget multiplier increases, the number of placement blocks selected in the operation 516 increases. In some embodiments, the budget multiplier is between 1 and 10. In other embodiments, the budget multiplier is between 3 and 8. For exemplary illustrative purposes, if the budget for the media plan 124 is $1,000,000 and the budget multiplier is 5, the pre-optimization engine 502 selects placement blocks mostly likely fit the media plan 124 until the total cost of the selected placement blocks reaches $5,000,000. In other embodiments, one or more other criteria are used to filter the placement blocks in the operation 516.

At the operation 518, the pre-optimization engine 502 operates to output a list of the filtered placement blocks as a basis for operating the optimization engine 504.

FIG. 31 is a flowchart of an example method 530 of operating the optimization engine 504. In some embodiments, the method 530 includes operations 532, 534, 536 and 538.

At the operation 532, the optimization engine 504 receives the list of filtered placement blocks from the pre-optimization engine 502 for subsequent processes.

At the operation 534, the optimization engine 504 operates to initially create a group of chromosomes 544 (FIG. 32) from the list of the filtered placement blocks. In this document, a group of chromosomes is defined to include one or more chromosomes. A chromosome 544 represents a placement block 132 that can be included in a potential media plan 542. In some embodiments, the initial chromosomes 544 are randomly selected from the list of the filtered placement blocks. For example, the initial chromosomes 544 are created by one or more random mutations of the filtered placement blocks. As described below, the potential media plan 542 is repeatedly altered to contain different, or different sets of, chromosomes 544, and converges to the final result of the media plan 124 by operation of the optimization engine 504. An example of the potential media plan 542 and the chromosome 544 is illustrated and described in more detail with reference to FIG. 31.

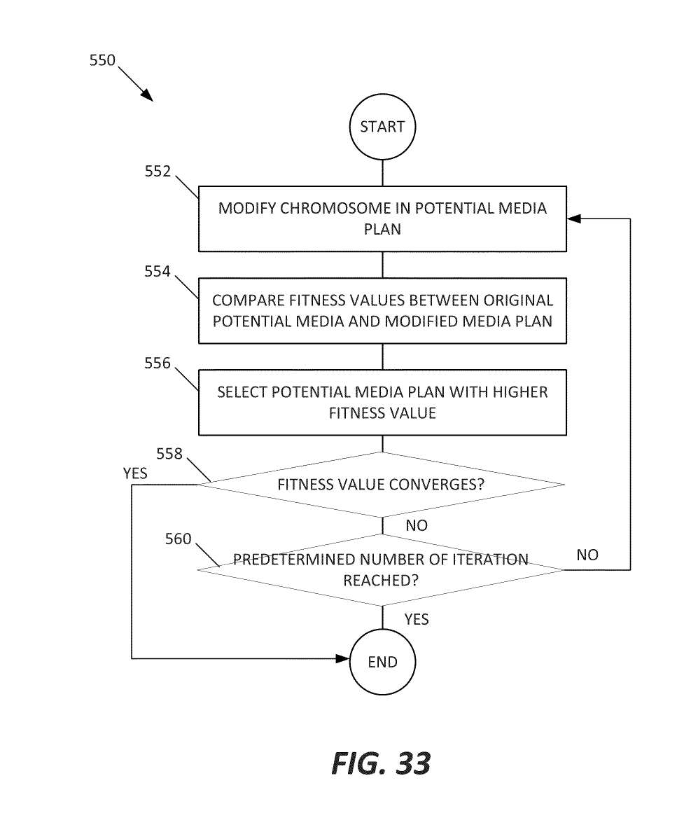

At the operation 536, the optimization engine 504 operates to repeatedly mutate the chromosomes 544 in the potential media plan 542 using a fitness value 570. In some embodiments, for each cycle of mutation, the optimization engine 504 alters the chromosomes 544 contained in the potential media plan 542 and determines the change in the fitness value 570 of the potential media plan 542 over the alteration. The chromosomes 544 contained in the potential media plan 542 with a higher fitness value are chosen for the next cycle of mutation of the chromosomes 544 in the potential media plan 542. The mutations of the chromosomes 544 continue to be performed until the fitness value converges or a predetermined number of mutations have been reached. An example of the operation 536 is described in more detail with reference to FIG. 33.

At the operation 538, the optimization engine 504 operates to output the potential media plan 542 containing one or more chromosomes 544 that has the highest fitness value 570. This potential media plan 542 is considered to be the media plan 124 with most recommended placement blocks 132. In some embodiments, the output of the potential media plan 542 (i.e., the media plan 124) is saved in the database 160 so as to be accessed for subsequent processes, such as displaying to the advertiser 102.

FIG. 32 is a block diagram of an example potential media plan 542 containing one or more chromosomes 544. As describe herein, each chromosome 544 represents a placement block 132 that can be potentially included in the media plan 124. The potential media plan 542 includes one or more chromosomes 544 that are randomly selected from the list of filtered placement blocks generated by the pre-optimization engine 502. The chromosomes 544 contained in the potential media plan 542 are repeatedly mutated as the optimization engine 504 continues to operate, and the fitness value 570 for the potential media plan 542 at each mutation is evaluated. In some embodiments, when the fitness value 570 is found to converges, the potential media plan 542 is considered to ripe to be the media plan 124. In other embodiments, when the mutations have been performed as many times as required, the media plan 124 is determined as the potential media plan 542 having the highest fitness value 570.

FIG. 33 is a flowchart of an example method 550 for performing the operation 536 of FIG. 31. In some embodiments, the method 550 includes operations 552, 554, 556, 558, and 560.

At the operation 552, the optimization engine 504 modifies the set of chromosomes 544 included in the potential media plan 542. In some embodiments, at least some of the chromosomes 544 contained in the potential media plan 542 are added, removed, and/or substituted to alter the set of chromosome 544 in the potential media plan 542.

At the operation 554, the optimization engine 504 operates to compare fitness values of the potential media plan 542A having the unmodified set of chromosomes 544 and the potential media plan 542B having the modified set of chromosomes 544. An example calculation of the fitness value 570 is illustrated and described with reference to FIG. 35.

At the operation 556, the optimization engine 504 operates to select the potential media plan 542 with the higher fitness value 570 between the unmodified potential media plan 542A and the modified potential media plan 542B. The selected potential media plan 542 is considered to be closer to the final output of the media plan 124.

At the operation 558, the optimization engine 504 determines whether the fitness value 570 converges. In some embodiments, the fitness value 570 is considered to be converge when the fitness value 570 does not change for several mutations to a predetermined degree. If the fitness value 570 is determined to converge (“YES” at the operation 558), the method 550 ends and continues on to the operation 538 of FIG. 32, at which the potential media plan 542 with the converging fitness value 570 is regarded as the output of the media plan 124. If the fitness value 570 is determined to not converge (“NO” at the operation 558), the method 550 moves on to the operation 560.

At the operation 560, the optimization engine 504 determines whether the mutations have iterated a predetermined number of times. If it is determined that the predetermined number of mutations have been performed (“YES” at the operation 560), the potential media plan 542 with the highest fitness value 570 is regarded as the output of the media plan 124. If not (“NO” at the operation 560), the method 550 returns to the operation 552 to repeat the mutation of the chromosomes 544 in the potential media plan 542.

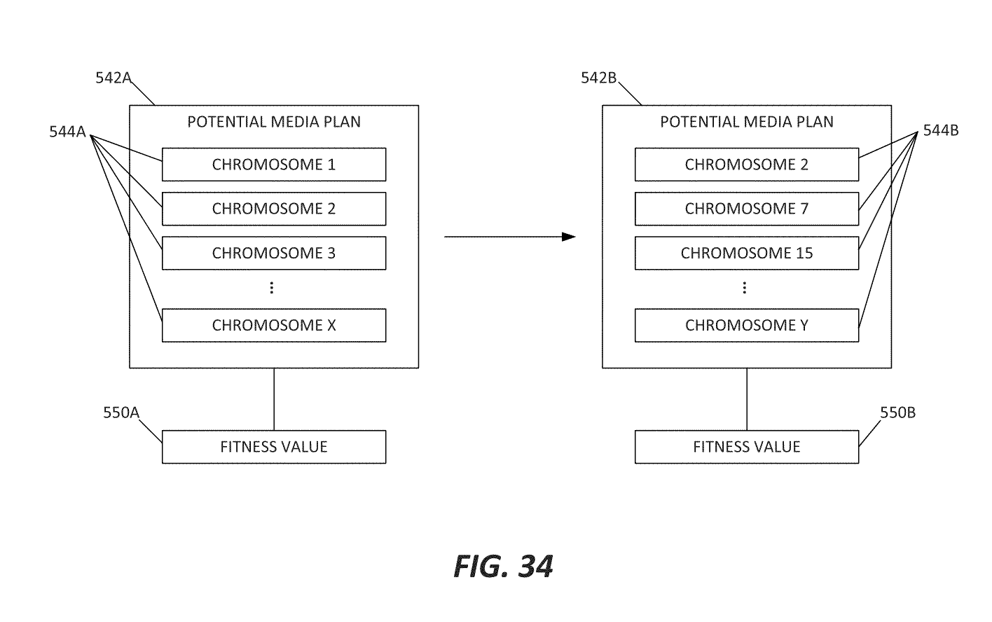

FIG. 34 illustrates a mutation of the chromosomes 544 in the potential media plan 542. As illustrated, a set of chromosomes 544A are mutated into a set of chromosomes 544B. For brevity purposes, the potential media plan 542 containing the unmodified set of chromosomes 544A is designated as 542A, and the potential media plan 542 containing the modified set of chromosomes 544B is designated as 542B. The original, unmodified potential media plan 542A has a fitness value 570A, and the modified potential media plan 542B has a fitness value 570B. As described above, the fitness values 570A and 570B are compared to select one of the potential media plans 542A and 542B with the higher fitness value.

FIG. 35 illustrates an example calculation of a fitness value 570. Illustrated are one or more variables 572, one or more adjustable coefficients 574, and a fitness function 576.

The variables 572 represent different criteria for advertising. In some embodiments, the advertising criteria are associated with different objectives, such as maximization of impressions, minimization of costs, effective distribution in various periods of time, maximization of reach, and maximization of frequency. In some embodiments, the distribution includes distribution of advertisements over weeks, distribution of advertisements in a day, and distribution of advertisements over days of a week. As such, the variables 572 are associated with these different criteria (e.g., impression, cost, reach, frequency, and distribution), respectively.

The coefficients 574 are designed to be accompanied with the variables 572, respectively, to adjust the value of the variables 572. At least some of the coefficients 574 are configured to be adjustable by a user (e.g., the advertiser 102) so that the user weighs more or less the associated variables 572 against other variables 572. For example, the variable 572 associated with reach can be modified by a reach coefficient that is adjustable by the user. The user can increase the reach coefficient to weigh reach of advertising against other variables, such as frequency of advertising. In similar manners, the user can control the weight of other variables 572 by adjusting the associated coefficients 574.

The fitness function 576 is configured to consider at least some of the variables 572 and the coefficients 574 associated therewith to generate a fitness value 570 of a potential media plan 542. In some embodiments, the fitness function 576 is calculated in multiple steps.

In some embodiments, the fitness function 576 is first formulated to account for the variables for impression and reach so as to maximize impression and reach of advertising. The fitness function 576 is first constructed as follows:

F_{D}=(1.0+C_{R}×R)×I,

where F_{D} is a fitness value at default, R is a reach variable, I is an impression variable, and C_{R} is a reach coefficient.

The reach variable R indicates the number of households exposed to an advertising content in a given plan divided by a total number of households. In some embodiments, in calculating the reach variable R, one or more initial random samples of households are drawn from a target population (e.g., a total set of viewers for a given program, station, etc.). These samples are then converted to a unique set, eliminating double-counting of viewers. For each reach key (e.g. a combination of “seriesID,” “networkID,” “daypart,” and “mediaMarketID”), a seeded random subsample of households, which is taken from the initial random sample of households, is selected to have a size of:

(the number of households with a tuning associated with the key)×(a proportion of the purchased placement blocks over available quarter hours).

The reach variable R is then calculated by dividing the number of a unique set of households across all subsamples for each reach key by the total number of households from a dataset.

The impression variable I is calculated as the sum of the number of impressions for each placement 132 in a media plan. In some embodiments, the impressions for each placement block 132 are calculated by the data management subsystem 154.

The reach coefficient C_{R} is provided as one of the input parameters 122 from the advertiser 102 via the user interaction subsystem 158.

In some embodiments, the fitness function 576 is then adjusted to minimize the concentration of placements of advertisement in dates and dayparts. In some embodiments, this adjustment is performed by introducing a penalty as follows:

F_{A}=F_{D}×(1.0−0.5×CT_{DP});

F_{A}=F_{D}×(1.0−0.1×CT_{D});

F_{A}=F_{D}×(1.0−0.1×CT_{W}),

where F_{A} is an adjusted fitness value, CT_{AP} is a concentration penalty for daypart, CT_{D} is a concentration penalty for date, and CT_{W} is a concentration penalty for week.

In some embodiments, the concentration penalty is calculated using the Gini index, such as:

CT=(2×sumIY)+(n×sumY)−(n+1)÷n,

where, for a list of counts per daypart, date, or week,

$$sumIY = {\sum }_{i}^{n} ( i + 1 ) \times counts [ i ] , \\ sumY = {\sum }_{i}^{n} counts [ i ] ,$$

Where n is the number of values in the counts list.

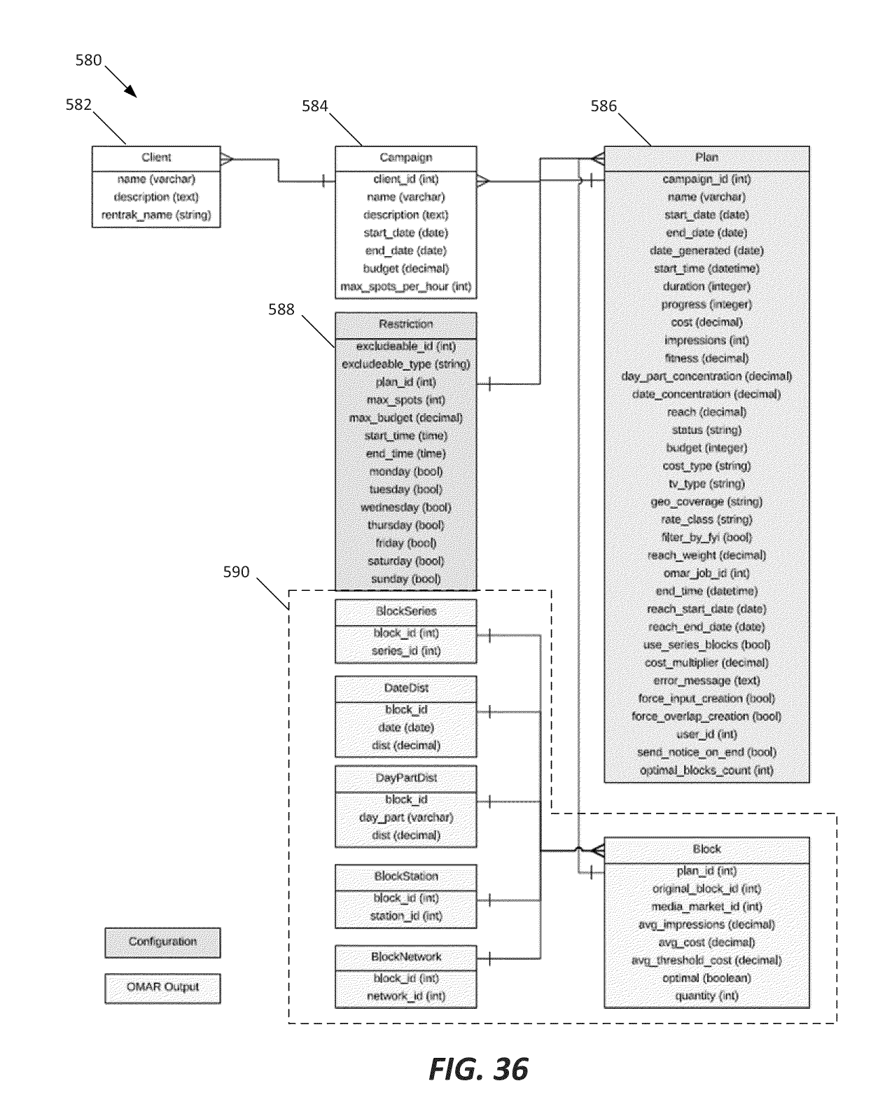

FIG. 36 is an example schema 580 utilized by the plan generation subsystem 156. The schema 580 defines a client table 582, a campaign table 584, a plan table 586, a restrictions table 588, and one or more output tables 590.

The client table 582 includes variables for identifying the client, such as the advertiser 102 and other data associated with the client.

The campaign table 584 includes variables for identifying the campaign 130 and other data associated with the campaign 130.

The plan table 586 includes variables for identifying different media plans 124 (such as 124A and 124B) and other data associated with the media plans.

The restrictions table 588 includes variables for defining various restrictions in generating the media plan 124. In some embodiments, at least some of the restrictions are provided by the advertiser 102 via the user interaction subsystem 158.

The output tables 590 include variables for generating a media plan 124 with recommended placement blocks 132 and other data associated with the media plan 124.

In other embodiments, the schema 580 includes other tables in generating the media plan 124.

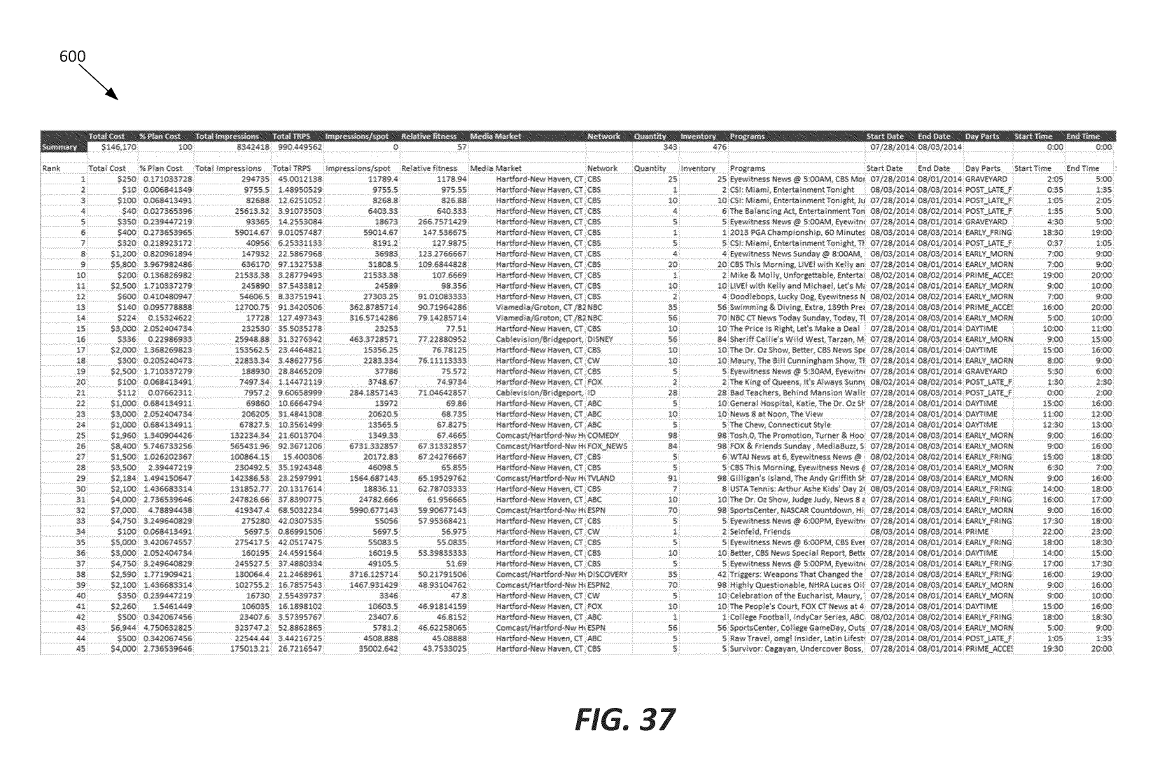

FIG. 37 is an example output 600 of a media plan 124 generated by the plan generation subsystem 156. The output 600 is the media plan 124 optimized by the plan generation subsystem 156. In the depicted example of FIG. 37, the output 600 of the media plan 124 includes 45 recommended placement blocks 132 that optimize the media plan 124, as described above.

FIG. 38 is a block diagram of an example user interaction subsystem 158. In some embodiments, the user interaction subsystem 158 includes a run management engine 612, a rate card import engine 614, and a data management engine 616.

In general, the user interaction subsystem 158 operates to provide an interface for the advertiser 102. The advertiser 102 can communicate with one or more other components (e.g., the data management subsystem 154 and/or the plan generation subsystem 156) of the media plan generation system 110 via the interface provided by the user interaction subsystem 158.

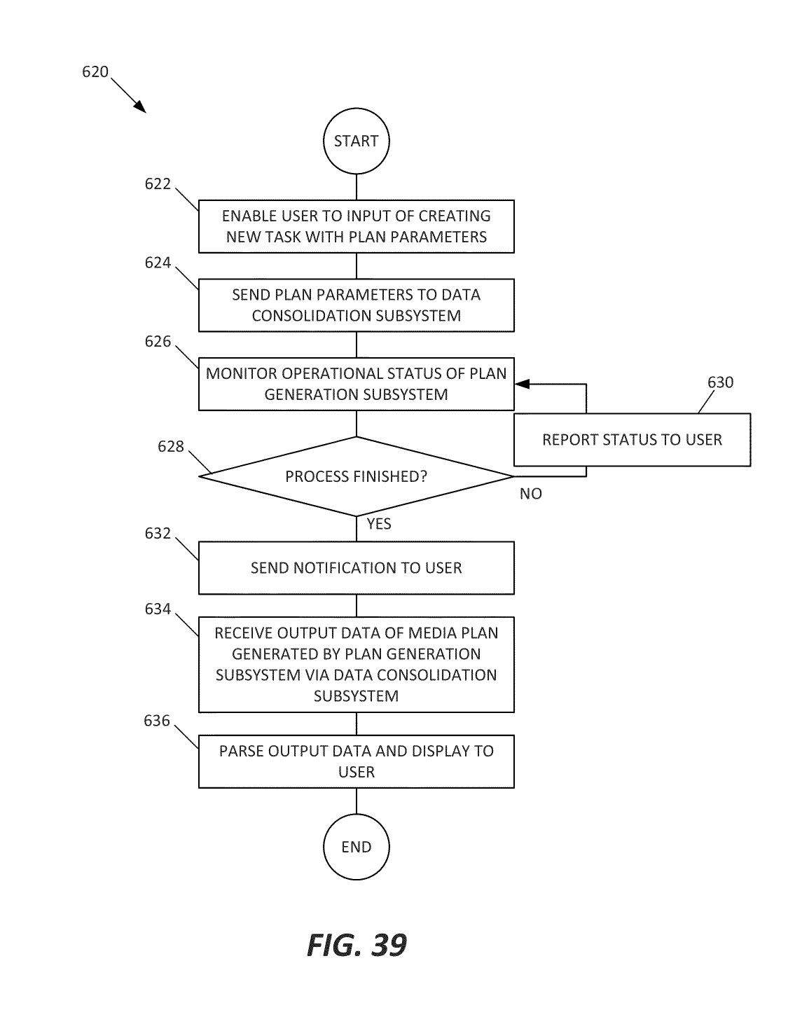

The run management engine 612 operates to receive inputs and/or requests from the advertiser 102, interact with one or more other components of the media plan generation system 110, and provide outputs to the advertiser 102. An example of the run management engine 612 is illustrated and described in more detail with reference to FIG. 39.

The rate card import engine 614 operates to enable a user (e.g., the advertiser 102 or an administrator of the media plan generation system 110) to manually load and import relevant portions of a rate card 320 into the database 160 for subsequent use by other components of the media plan generation system 110, such as the data management subsystem 154. An example of the rate card import engine 614 is illustrated and described in more detail with reference to FIG. 51.

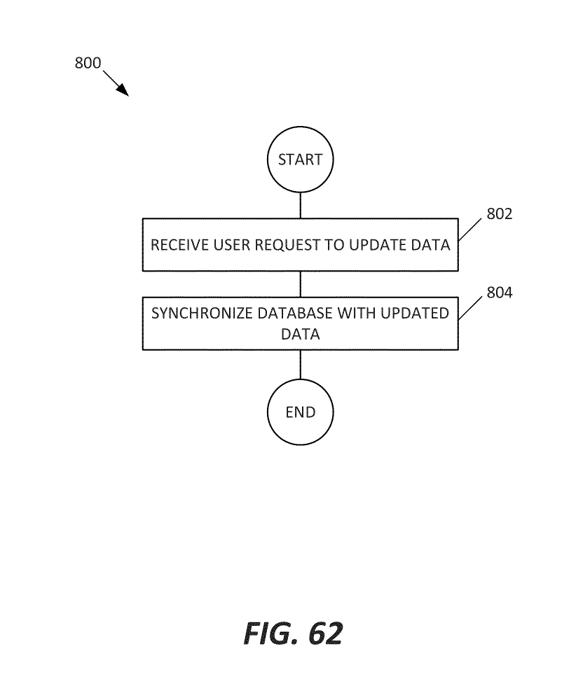

The data management engine 616 operates to enable a user (e.g., the advertiser 102 or an administrator of the media plan generation system 110) to manage the media data 120 stored in the database 160 as necessary. An example of the data management engine 616 is illustrated and described in more detail with reference to FIG. 62.

FIG. 39 is a flowchart of an example method 620 of operating the run management engine 612. In some embodiments, the method 620 includes operations 622, 624, 626, 628, 630, 632, 634, and 636.

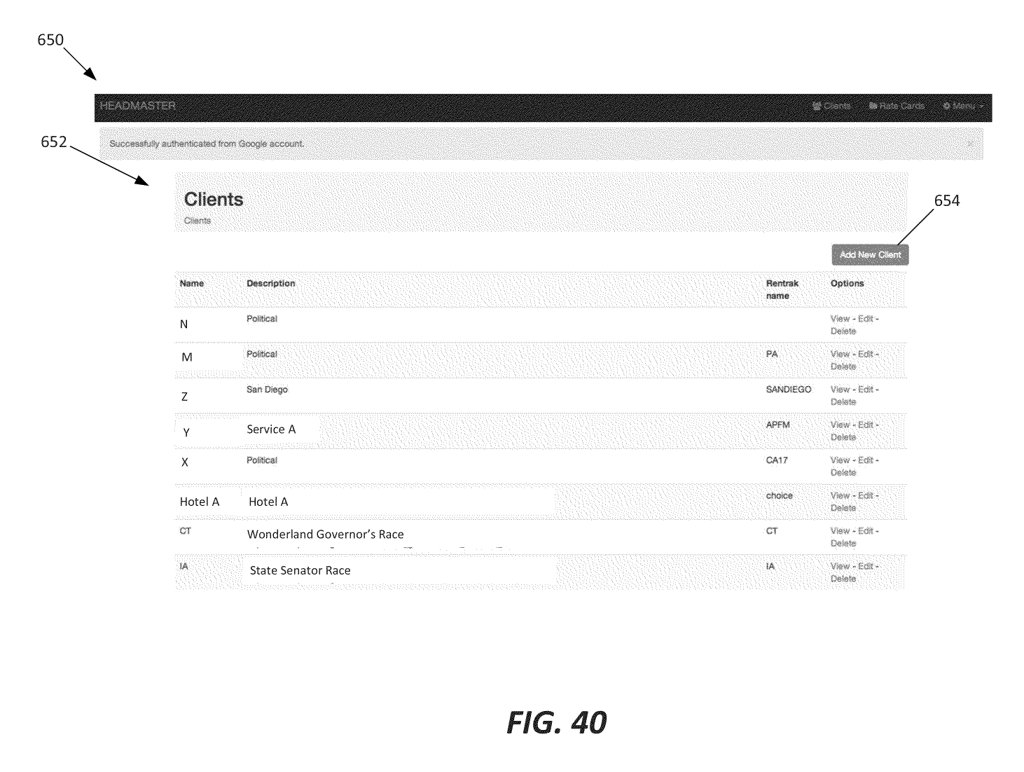

At the operation 622, the run management engine 612 enables a user to input a request of creating a new task with plan parameters 122. The run management engine 612 provides an interface for a user to provide one or more requests therethrough. In some embodiments, a user can create clients, campaigns, and plans via the interface provided by the run management engine 612. Further, a user can input one or more plan parameters 122 through the interface of the run management engine 612. An example of the interface provided by the run management engine 612 is illustrated and described in more detail with reference to FIGS. 40-46.

At the operation 624, the run management engine 612 operates to send the plan parameters 122 to the data management subsystem 154. As described herein, the plan parameters 122 can be used by the data management subsystem 154 to generate one or more advertising options data files 372, 374 and 378.

At the operation 626, the run management engine 612 operates to monitor an operational status of the plan generation subsystem 156. The operation 626 can be performed in parallel with other operations (e.g., the operations 622, 624, 630, 632, and 634). In some embodiments, the run management engine 612 sends a request to the data management subsystem 154 such that the data management subsystem 154 detects the job status of the plan generation subsystem 156. In some embodiments, the run management engine 612 operates to periodically monitor the status of the operation of the plan generation subsystem 156 through the data management subsystem 154.

At the operation 628, the run management engine 612 monitors if a job performed by the plan generation subsystem 156 has been finished. If it is found that the job of the plan generation subsystem 156 is not completed (“NO” at the operation 628), the method 620 moves on to the operation 630. If not (“YES” at the operation 628), the method 620 goes on to the operation 632.

At the operation 630, the run management engine 612 operates to report the job status of the plan generation subsystem 156 to the user. In some embodiments, the run management engine 612 displays the job status in the interface so that the user recognizes the status. Then, the method 620 moves to the operation 626, at which the run management engine 612 continues to monitor the operational status of the plan generation subsystem 156.

At the operation 632, the run management engine 612 can be configured to send a notification to the user that the job has been done by the plan generation subsystem 156. In some embodiments, the run management engine 612 is configured to send the notification to an email account registered by the user. In other embodiments, the notification can be delivered to the user in real-time in different manners.

At the operation 634, the run management engine 612 operates to receive output data of the media plan 124 generated by the plan generation subsystem 156 via the data management subsystem 154. In some embodiments, the output data of the media plan 124 is stored in the database 160 as shown in FIG. 36 once generated by the plan generation subsystem 156, and the data management subsystem 154 retrieves the output data of the media plan 124 from the database 160 to send it to the run management engine 612.

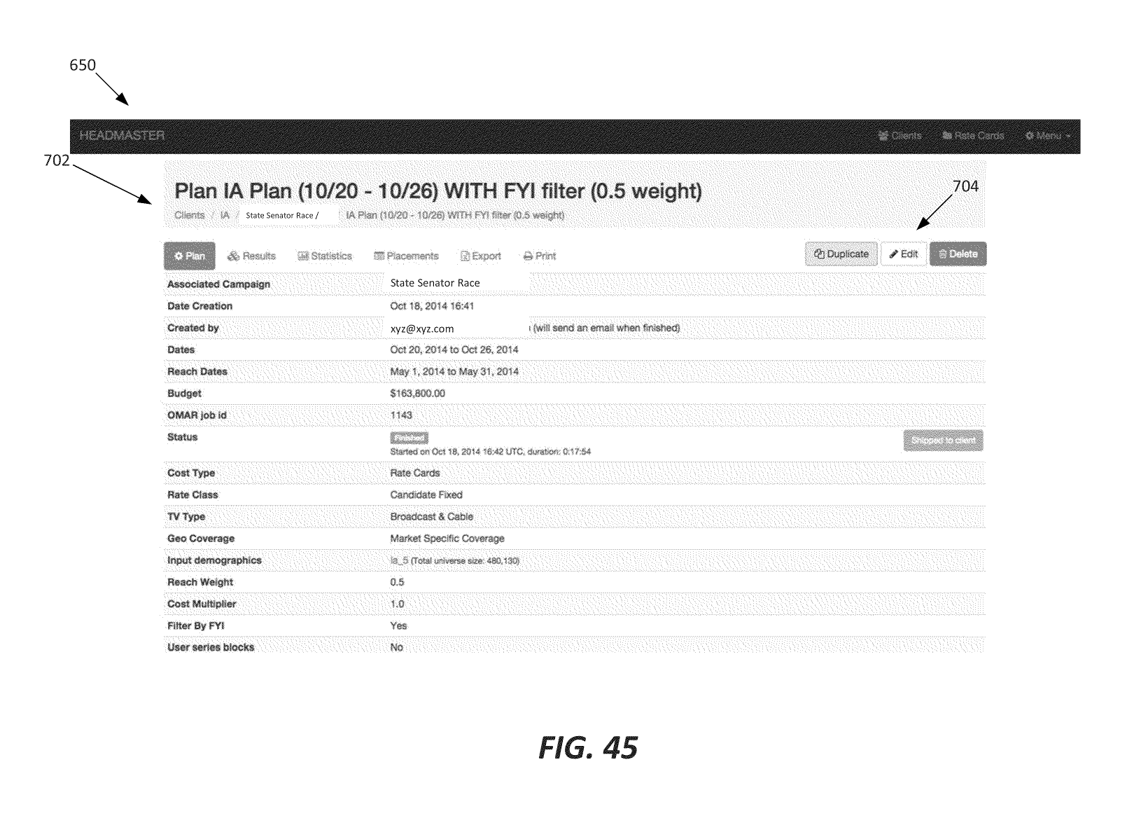

At the operation 636, the run management engine 612 operates to parse the output data of the media plan 124 and display it to the user through the interface. In some embodiments, the media plan 124 is displayed on the interface in various formats and/or layouts. As shown in FIGS. 45-49 below, the media plan 124 is demonstrated with statistics, graphs, and/or charts on the interface.

FIGS. 40-50 illustrates an example interface 650 provided by the run management engine 612. In particular, FIGS. 40-44 illustrate an example interface 650 generated in the operation 622 of FIG. 39. FIGS. 45-50 illustrate the interface 650 generated by the run management engine 612 of the user interaction subsystem 158 to output the optimized media plan 124 in various manners.

FIG. 40 is an example interface 650 of the run management engine 612 that displays a client list page 652. As illustrated, the client list page 652 includes a list of client names, client descriptions, media data information (e.g., Rentrak media data in FIG. 40) associated with the client, and other options. In some embodiments, the other options enable the user to manage the information about each client, such as viewing, editing, and deleting. The management of the client information can be performed by the data management engine 616, as described below. Also shown is a button 654 for enabling a user to create a new client. The user can select this button to create a new client, as performed in the operation 622 of FIG. 39.

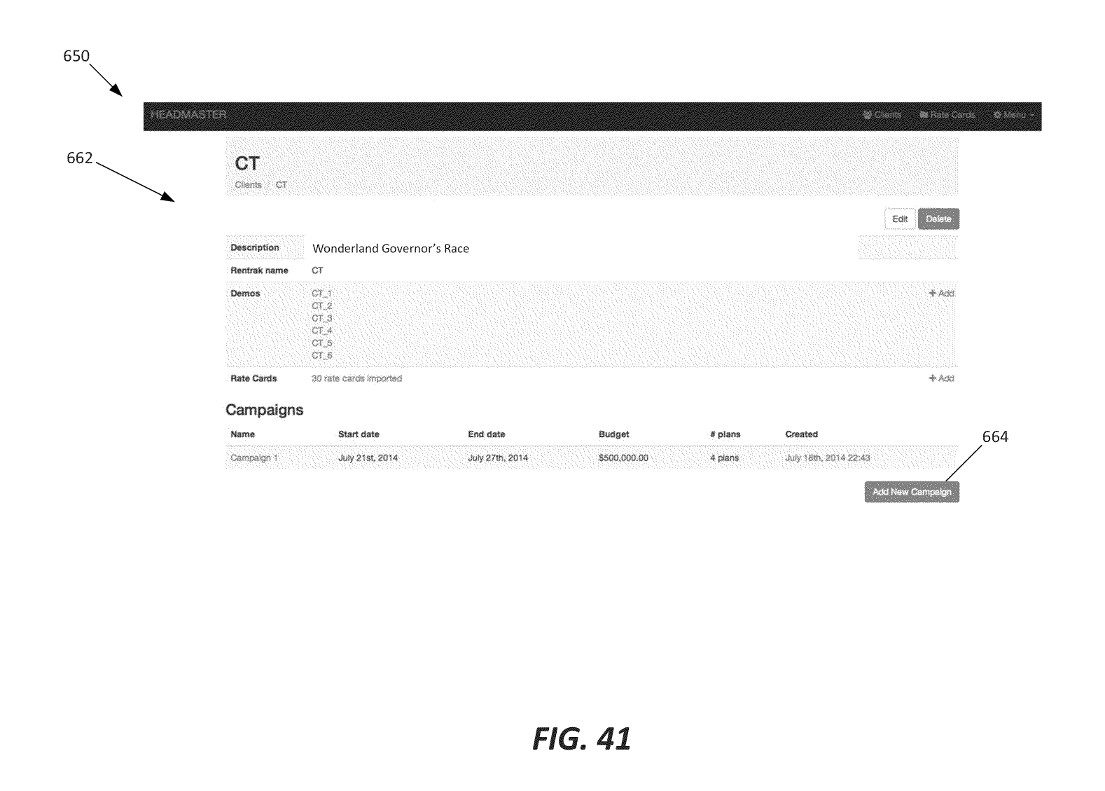

FIG. 41 is an example interface 650 of the run management engine 612 that displays a client details page 662. As illustrated, the client details page 662 shows the details of a selected client, which is “CT” in the depicted example. As illustrated, the client details page 662 can display the client's name, description, media data information (e.g., Rentrak media data in the depicted example), a list of associated demographics, a list of associated rate cards, and a list of campaigns associated with the client. Also shown is a button 664 for enabling a user to add a new campaign. The user can select this button 664 to create a new campaign, as performed in the operation 622 of FIG. 39.

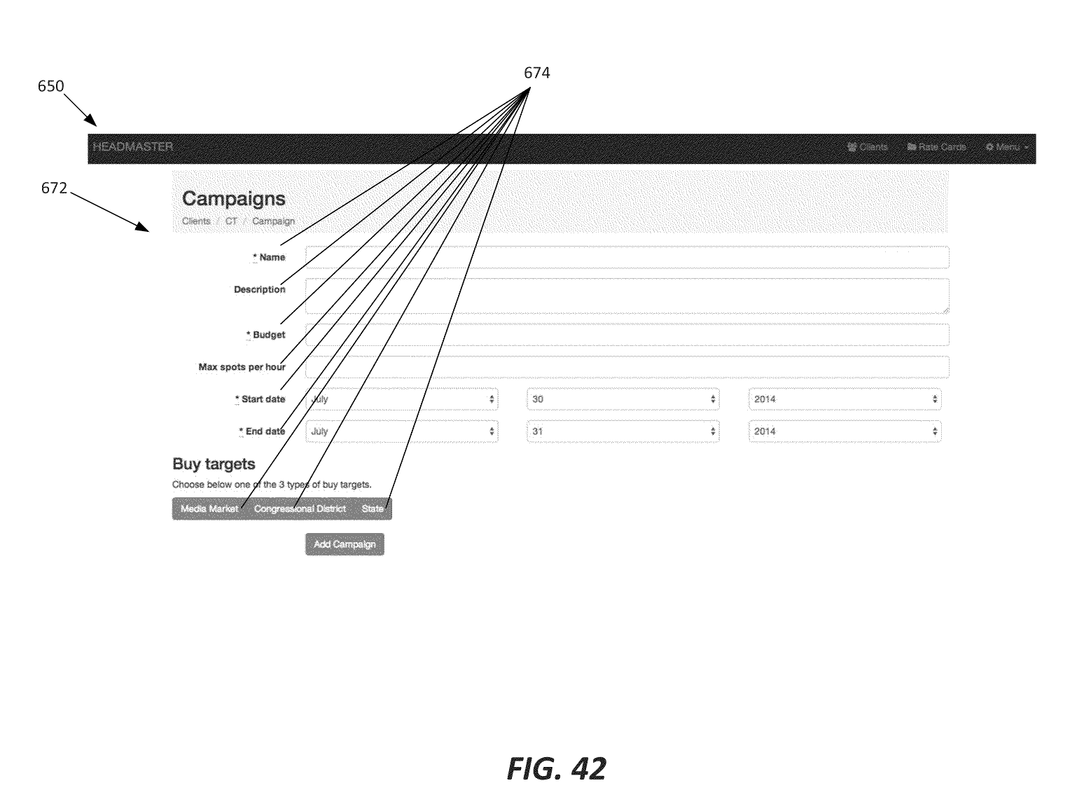

FIG. 42 is an example interface 650 of the run management engine 612 that displays a page 672 for generating a new campaign. As illustrated, the page 672 shows various items 674 to fill out to create a new campaign. Examples of the items 674 include a campaign name, a campaign description, a budget, a maximum allowable placement blocks per hour, a start date, an end data, and a purchase target. In some embodiments, the purchase target is selected as at least one of a media market, a congressional district, and a State. In some embodiments, at least one of the items 674 is used and included in the plan parameters 122, as described herein.

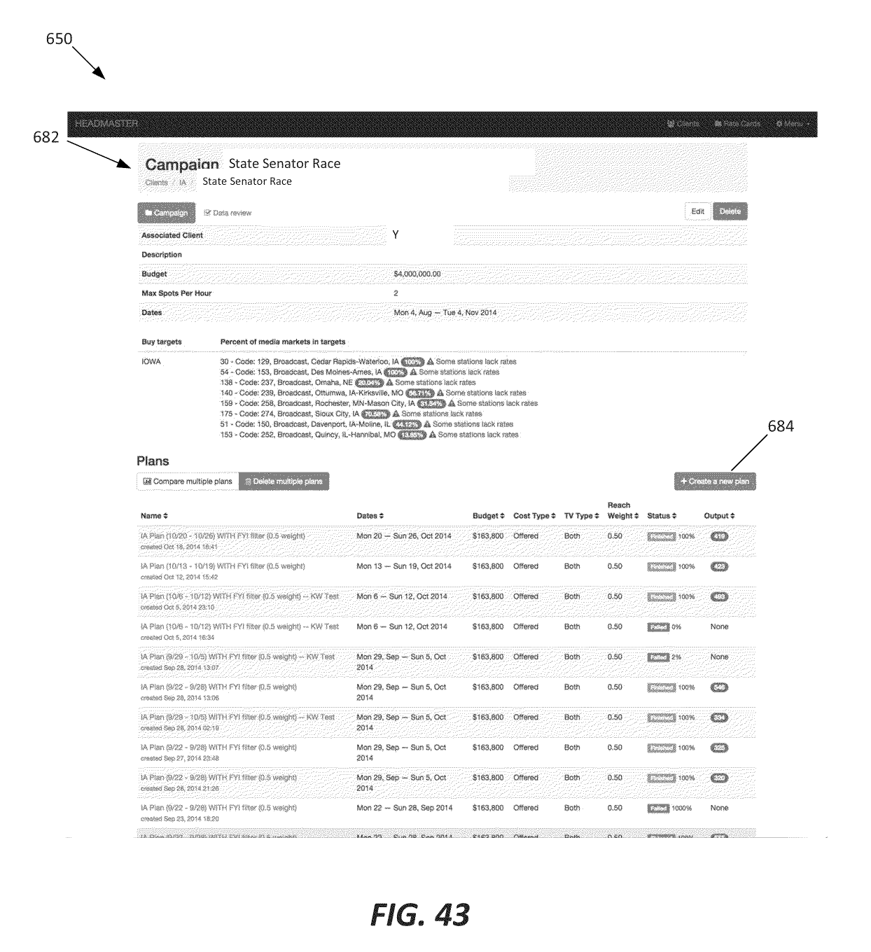

FIG. 43 is an example interface 650 of the run management engine 612 that displays a campaign details page 682. As illustrated, the campaign details page 682 shows the details of a selected campaign, which is “Through November” in the depicted example. As illustrated, the campaign details page 682 can display associated client identification (e.g., “IA” in the depicted example), name of the campaign, its description, a budget, a maximum allowable placement blocks per hour, a campaign date (a start date and an end data), a list of purchase targets, and a list of plans under the campaign. Also shown is a button 684 for enabling a user to add a new plan under the campaign. The user can select this button 684 to create a new plan, as performed in the operation 622 of FIG. 39.

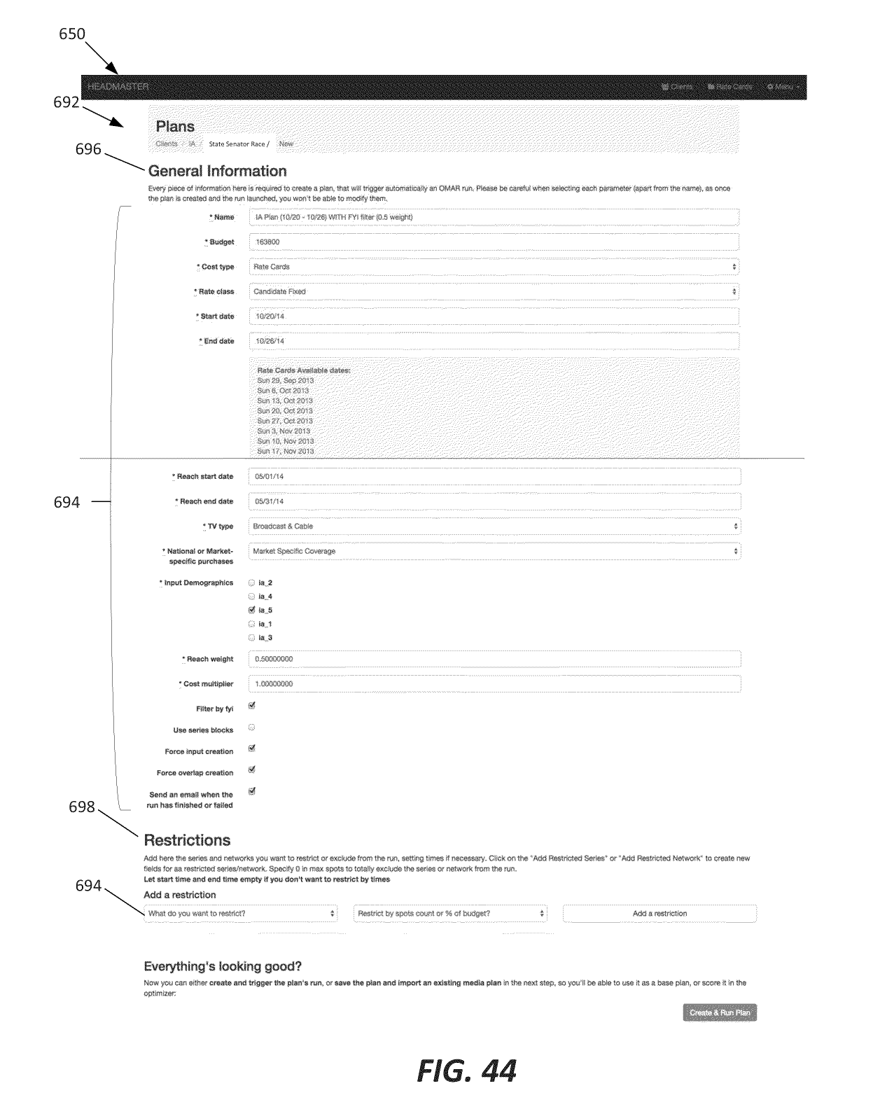

FIG. 44 is an example interface 650 of the run management engine 612 that displays a page 692 for generating a new plan. As illustrated, the page 692 shows various items 694 to fill out to create a new plan. In some embodiments, the items 694 are categorized as general information 696 and restrictions 698. Examples of the items 694 include a plan name, a budget, a type of cost data, a rate class, a start date, an end date, a reach start date, a reach end date, a television type, a coverage type (“National or Market-specific purchases” in the depicted example), input demographics, a reach weight, a budget multiplier, restrictions information, and other relevant information. In some embodiments, at least one of the items 694 is used and included in the plan parameters 122, as described herein.

FIG. 45 is an example interface 650 of the run management engine 612 that displays a plan details page 702. As illustrated, the plan details page 702 shows the details of a selected media plan 124, which is “IA Plan (10/20-10/26) WITH FYI filter (0.5 weight)” in the depicted example. As illustrated, the plan details page 702 can display associated campaign identification (e.g., “Through November” in the depicted example), date of plan creation, a user who created the plan, advertising dates, reach dates, a budget, a job ID used in the plan generation subsystem, a job status, a type of cost data, a rate class, a television type, a geographical coverage, input demographics, a reach weight, a budget multiplier, and other data. Also shown is a group of buttons 704 for enabling a user to manage the plan, such as duplicating, editing, and/or deleting. The user can select one of the buttons 704 to perform an associated management function, as performed in the operation 622 of FIG. 39.

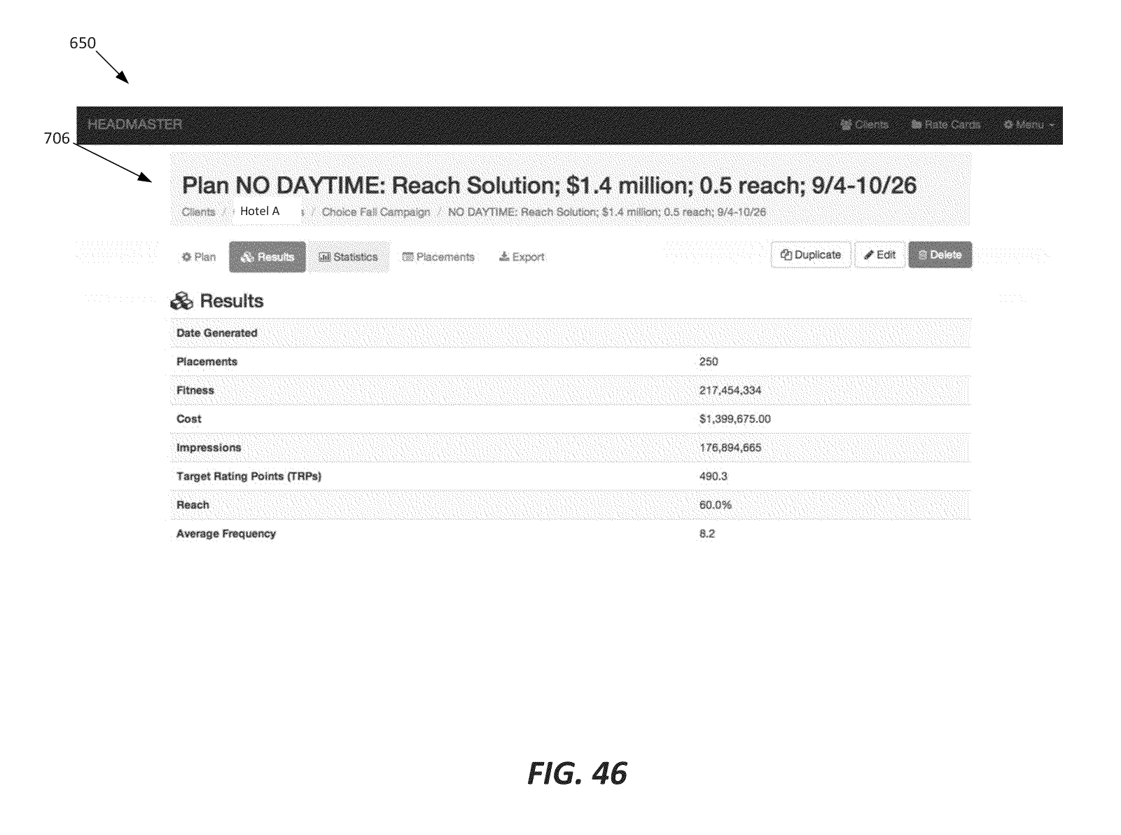

FIG. 46 is an example interface 650 of the run management engine 612 that displays an output result 706 of the media plan 124. As illustrated, the output result 706 can include various items of the output result, such as the number of placement blocks contained in the media plan 124, the fitness value of the media plan 124, the cost of the media plan 124, the number of impressions created in the media plan 124, target rating points of the media plan 124, the reach achieved by the media plan 124, and the average frequency achieved by the media plan 124. In some embodiments, target rating points (TRPs) are used to quantify gross rated points achieved by an advertisement among targeted viewers, and provide an index of the choice of viewers and the popularity of a particular channel.

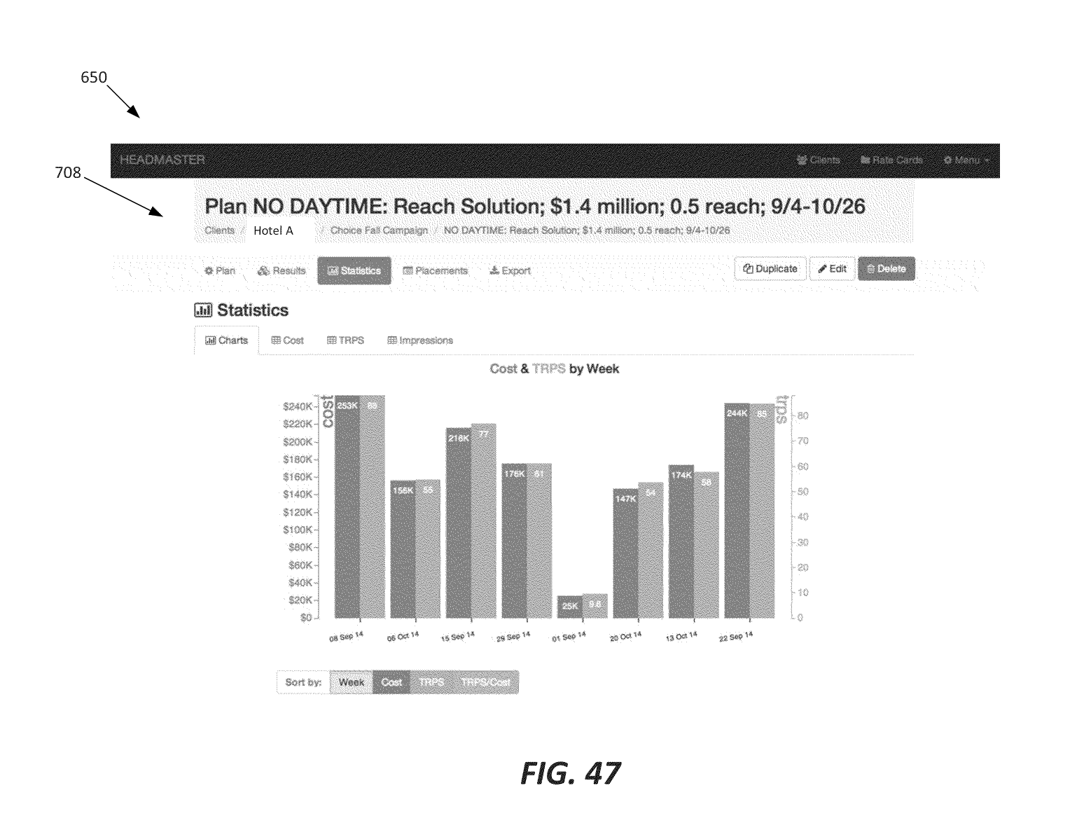

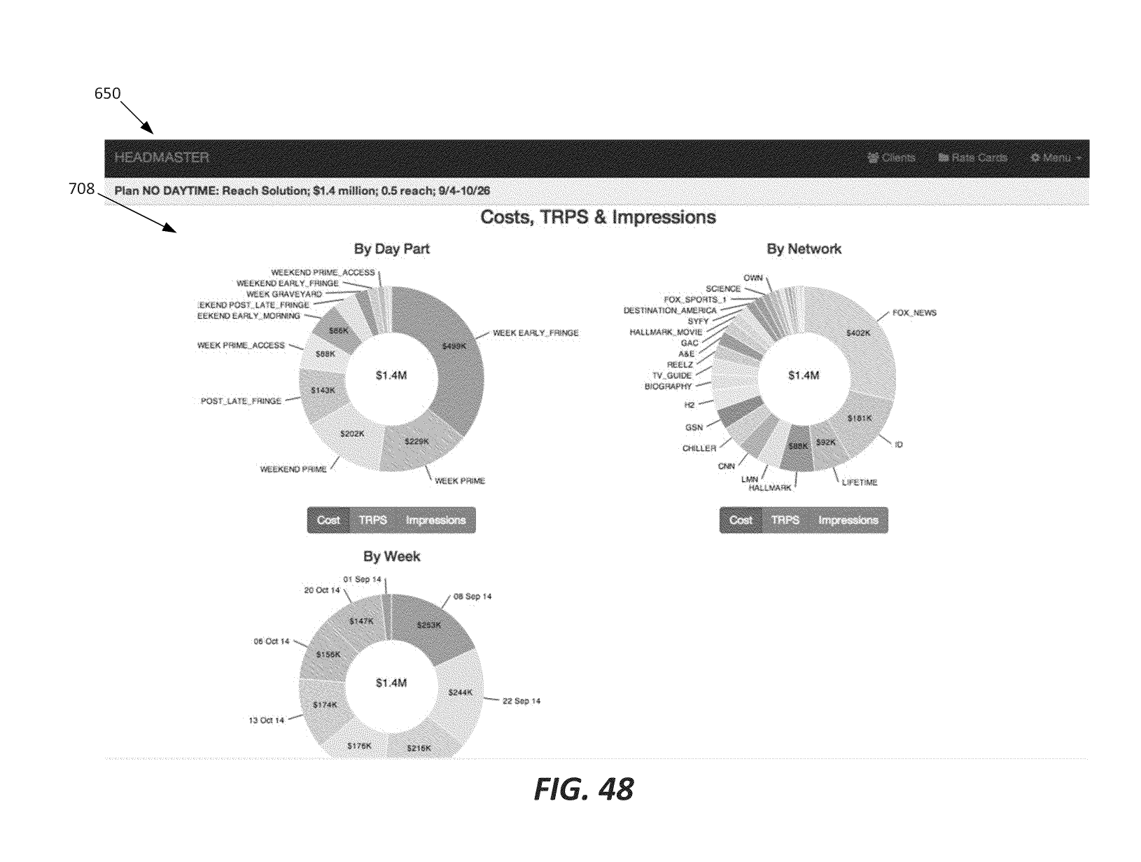

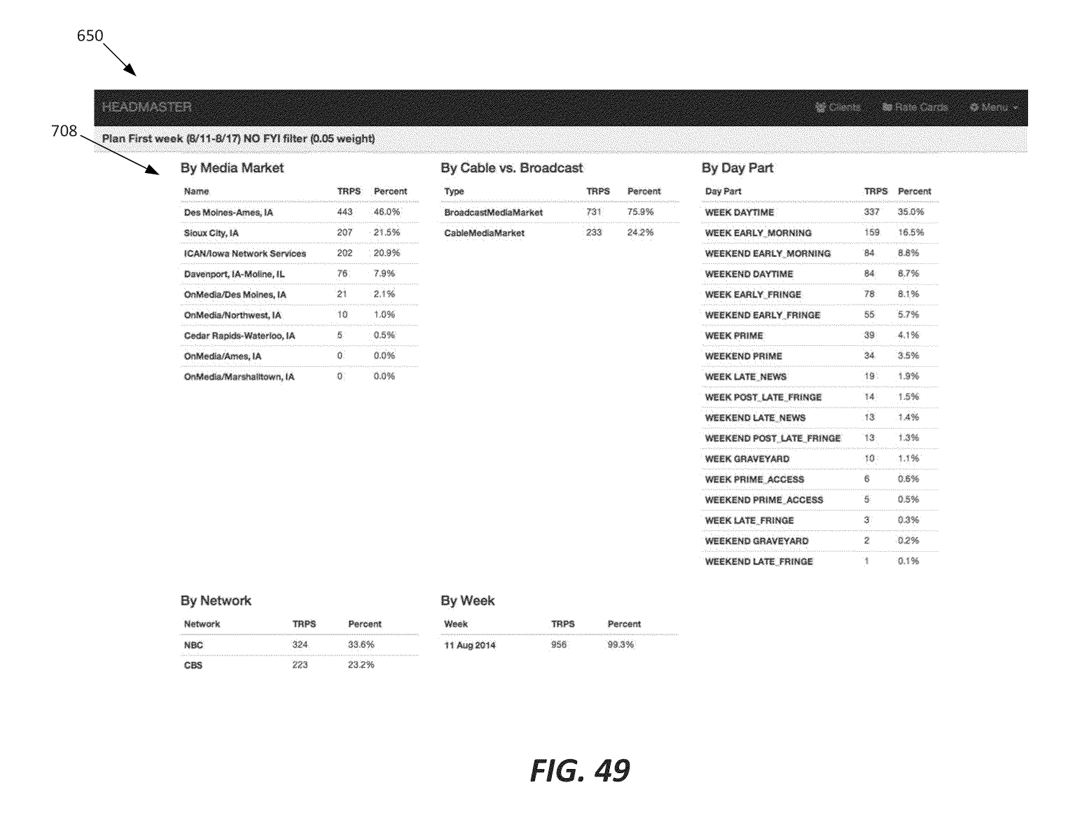

FIGS. 47-49 illustrate an example interface 650 of the run management engine 612 that displays statistics 708 of the media plan 124 in various manners. As illustrated, the run management engine 612 can operate to display the details of the optimized media plan 124 in the form of charts (FIG. 47), costs (FIG. 48), TRPs (FIG. 49), and impressions.

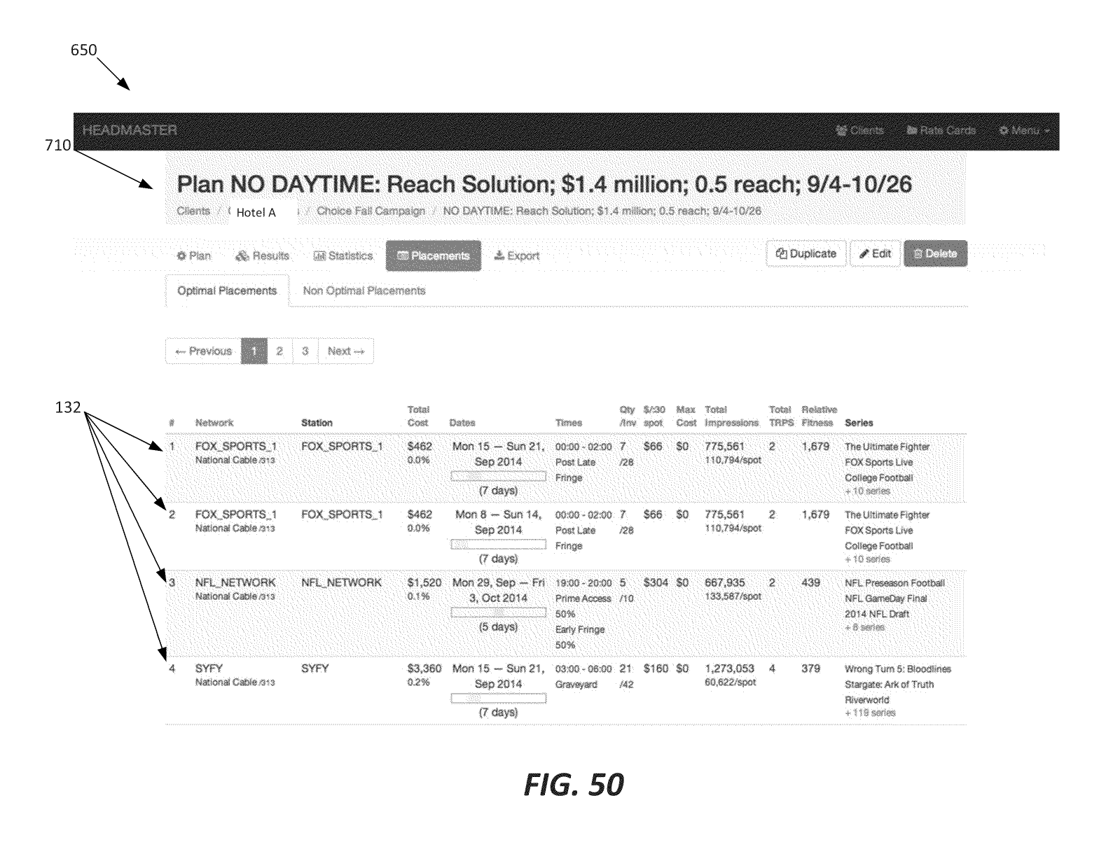

FIG. 50 is an example interface 650 of the run management engine 612 that displays a page 710 for a list of recommended placement blocks 132 contained in the media plan 124. As illustrated, each of the placement blocks 132 presents a network, a station, a total cost, advertising dates, times, total TRPs, a relative fitness value, program series, and other relevant information.

FIG. 51 is a flowchart of an example method 720 of operating the rate card import engine 614. In some embodiments, the method 720 includes operations 722, 724, 726, and 728.

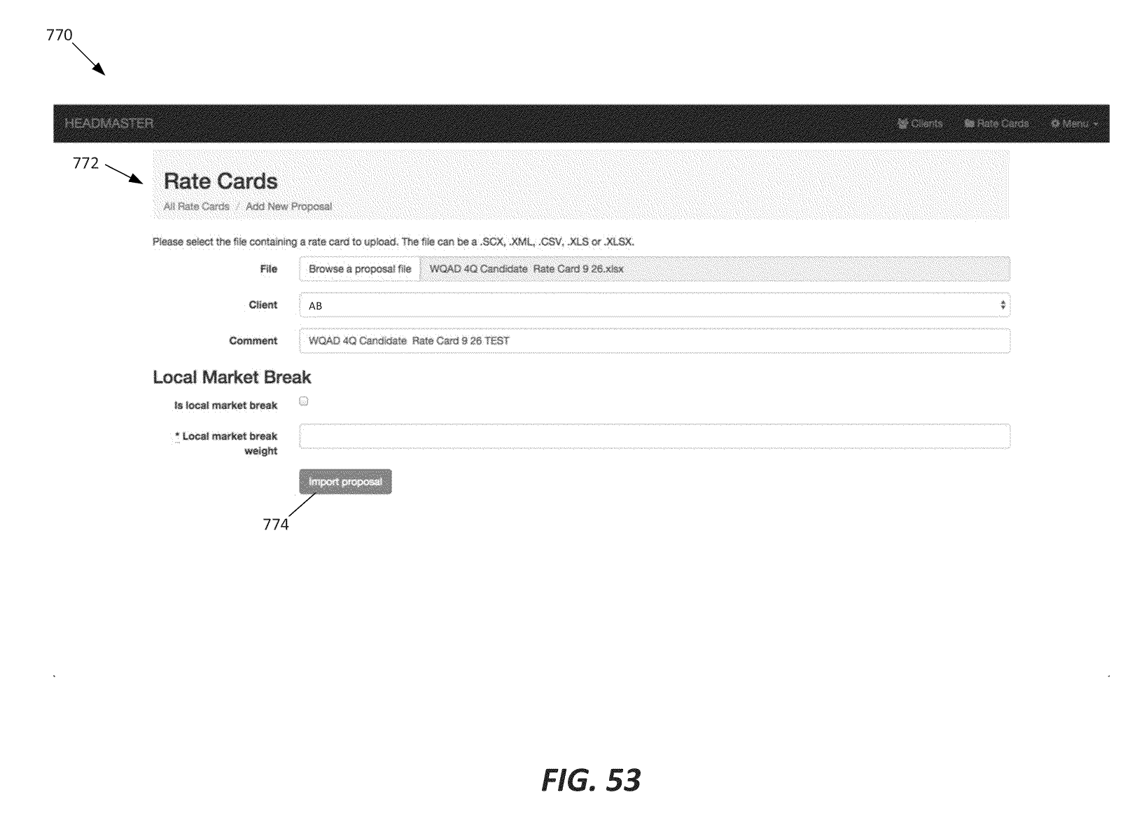

At the operation 722, the rate card import engine 614 enables a user to load a rate card file 768 (FIG. 52) via the interface 650. An example of the interface 650 is illustrated in FIG. 53.

At the operation 724, the rate card import engine 614 operates to parse the loaded rate card file 768. An example of the operation 724 is illustrated and described in more detail with reference to FIG. 52.

At the operation 726, the rate card import engine 614 operates to transform the imported data to a format usable by other components of the media plan generation system 110, such as the data management subsystem 154.

At the operation 728, the rate card import engine 614 operates to store the transformed data into the database 160.

FIG. 52 is a flowchart of an example method 740 of performing the parsing operation 724 of FIG. 51. In some embodiments, the method 740 includes operations 742, 744, 746, 748, 750, 752, 754, 756, 758, 760, 762, and 764. Also shown is one or more rate card files 768.

At the operation 742, the rate card import engine 614 determines whether the loaded rate card file 768 is in SCX or XML format. If it is determined that the file 768 is in either SCX or XML format (“YES” at the operation 742), the method 740 moves on to the operation 744. If not (“NO” at the operation 742), the method 740 continues on to the operation 748.

As described above, some of the rate card formats, such as SCX and XML, are well defined formats and thus can be automatically parsed and saved into the database 160. However, the other rate card formats, such as PDF, XLSX, CSV and other formats, are not uniformly defined and thus require a manual process to import relevant data into the media plan generation system 110.

At the operation 744, the rate card file 768 in either SCX or XML format is automatically parsed using XML node names. In some embodiments, the rate card import engine 614 performs to parse the rate card file 768. In other embodiments, the parsing can be performed by the data transformation subsystem 152, as described above.

At the operation 746 (or the operation 728 of FIG. 51), data parsed from the rate card file 768 are stored in the database 160 after the operation 726 of FIG. 51 is performed, at which the data is transformed into a format usable by other components of the media plan generation system 110, such as the data management subsystem 154.

At the operation 748, the rate card import engine 614 operates to display a sheet of the loaded rate card file 768 to allow a user to review the data arrangement of the rate card file 768.

At the operation 750, the rate card import engine 614 enables the user to select a group of cells representing an avail and another group of cells for a period. An avail is defined as one or more date ranges of rates for one station, one range of time, and one or more days of the week. An avail can also cover multiple rate classes for the same period. A period is defined as one that gives the rate for one date range and one rate class (if any) within the avail. Once the user select one or more avails and periods, the method 740 moves on to the operation 752.

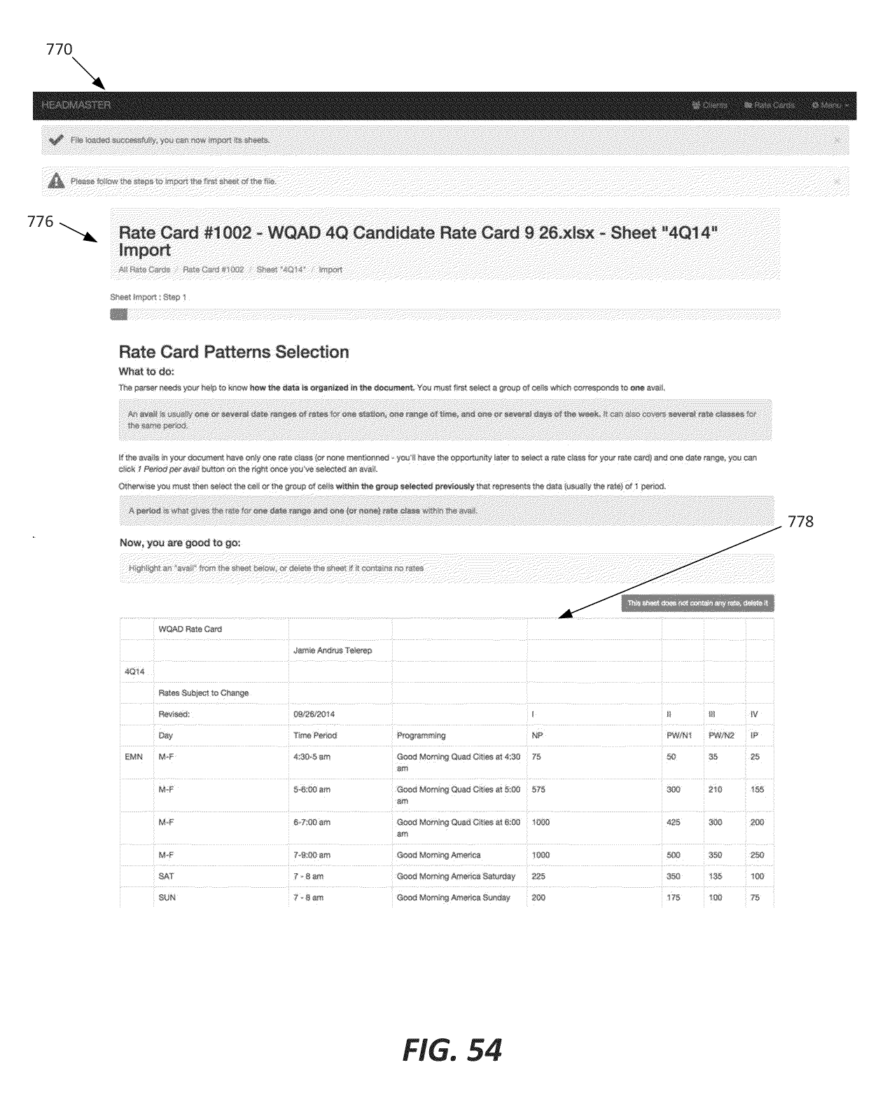

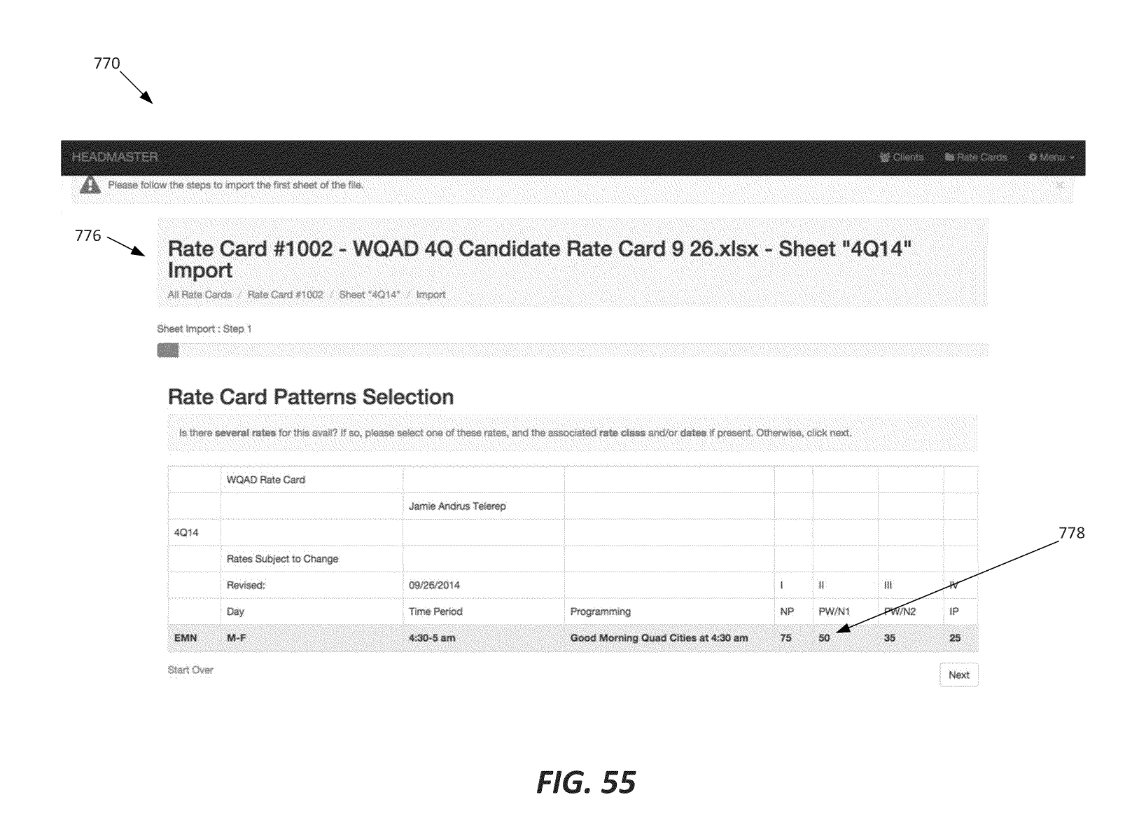

At the operation 752, the rate card import engine 614 analyzes the sheet of the rate card file 768 and organizes cells in the avails and periods. An example of the operations 748, 750 and 752 is illustrated in FIGS. 54 and 55.

At the operation 754, the rate card import engine 614 displays groups of cells that are uncertain avails and/or periods to enable the user to validate such uncertain avails and verify such uncertain periods. Although the rate card import engine 614 operates to identify all avails in the rate card file 768, at least some of the potential avails can be incorrect. Therefore, the rate card import engine 614 needs a user input to validate and/verify allegedly inaccurate avails. Further, the rate card import engine 614 can require the user to verify that the columns corresponding to different periods are correct. This is because, in cases where a certain columns contain very similar type of data (e.g., ratings and runtimes), the rate card import engine 614 can mistake the column to be a column containing a specific date range of the avail.

At the operation 756, the rate card import engine 614 enables the user to select groups of cells representing the accurate avails and periods.

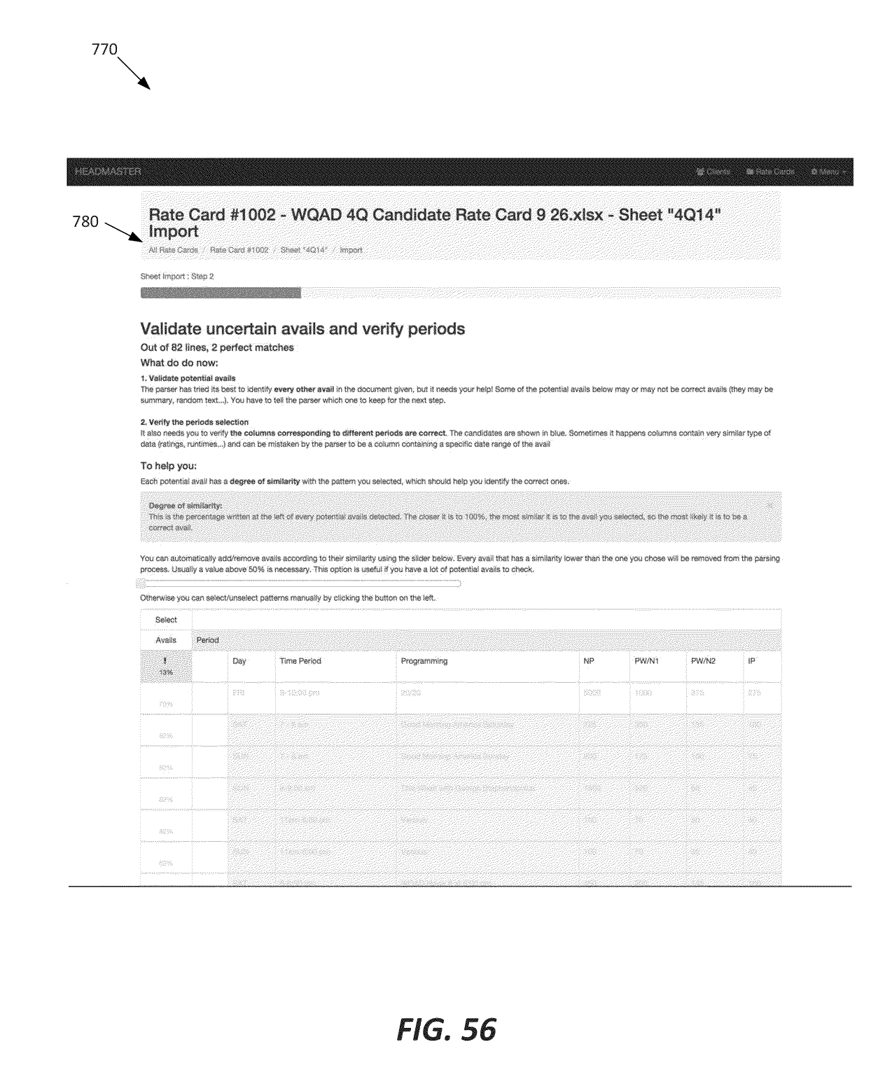

At the operation 758, the rate card import engine 614 analyzes the groups of cells and tries to identify content in the cells. An example of the operations 754, 756 and 758 is illustrated in FIG. 56.

At the operation 760, the rate card import engine 614 displays a sample of cells with their corresponding potential matching of data. The rate card import engine 614 has analyzed the organization of data in the rate card file 766 to match cells with right information associated with the cells by detecting the formats in the rate card file 766. However, the matching process performed by the rate card import engine 614 is not always accurate, and thus requires the user to recognize what information is contained in each cell.

At the operation 762, the rate card import engine 614 enables the user to validate the cells and select the right groups of cells to match associated information.

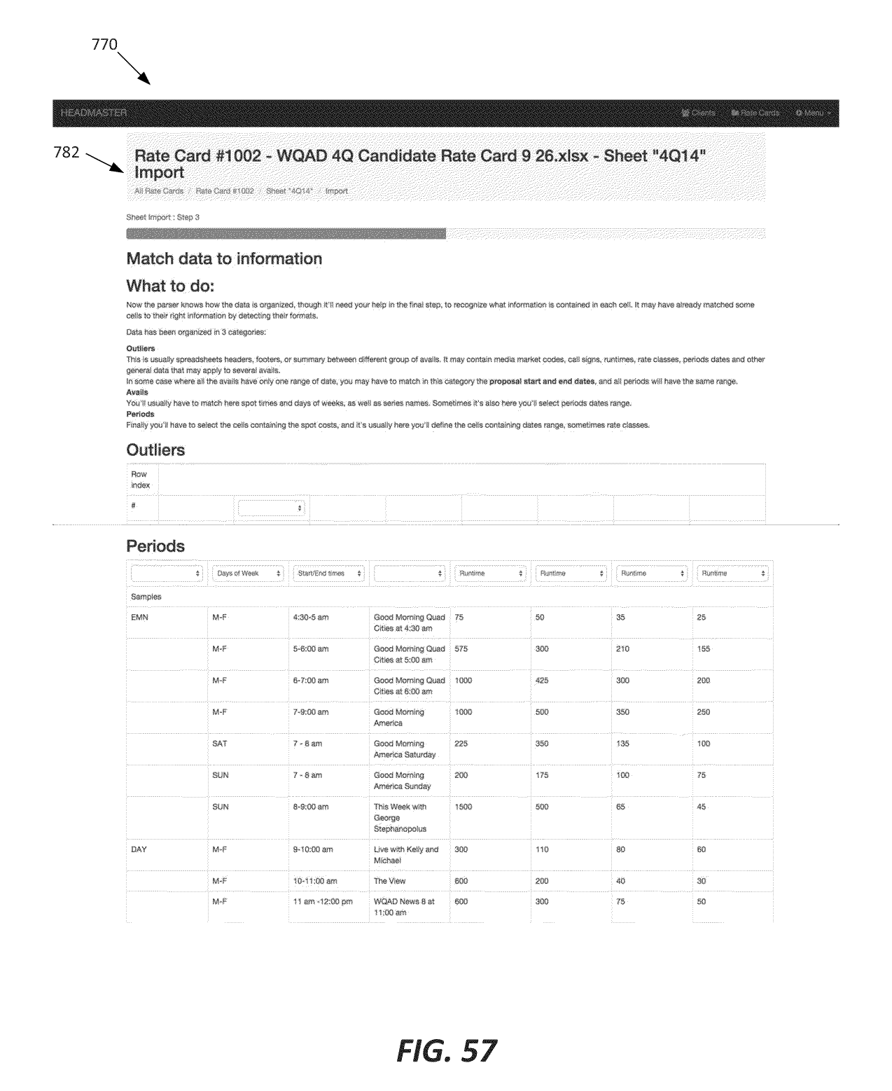

At the operation 764, upon the user's validation, the rate card import engine 614 operates to extract the data from the sheet of the rate card file 766 to save them in the database 160 at the operation 746. An example of the operations 760, 762 and 764 is illustrated in FIG. 57.

FIG. 53 is an example interface 770 of the rate card import engine 614 that displays a rate card load page 772. The page 772 includes a selectable button 774 for a user to load a rate card file 768 to be imported.

FIG. 54 is an example interface 770 of the rate card import engine 614 that displays a rate card pattern selection page 776. The page 776 displays a sheet of the loaded rate card file 768 to allow a user to review the data arrangement of the rate card file 768.

FIG. 55 is an example interface 770 of the rate card import engine 614 that displays the rate card pattern selection page 776. The page 776 displays that a group of cells 778 is selected representing one or more avails and/or periods.

FIG. 56 is an example interface 770 of the rate card import engine 614 that displays a page 780 for enabling a user to validate uncertain avails and verify periods. As described above, the rate card import engine 614 enables the user to select groups of cells representing the accurate avails and periods.

FIG. 57 is an example interface 770 of the rate card import engine 614 that displays a page 782 for matching data. As described above, the rate card import engine 614 displays a sample of cells with their corresponding potential matching of data.

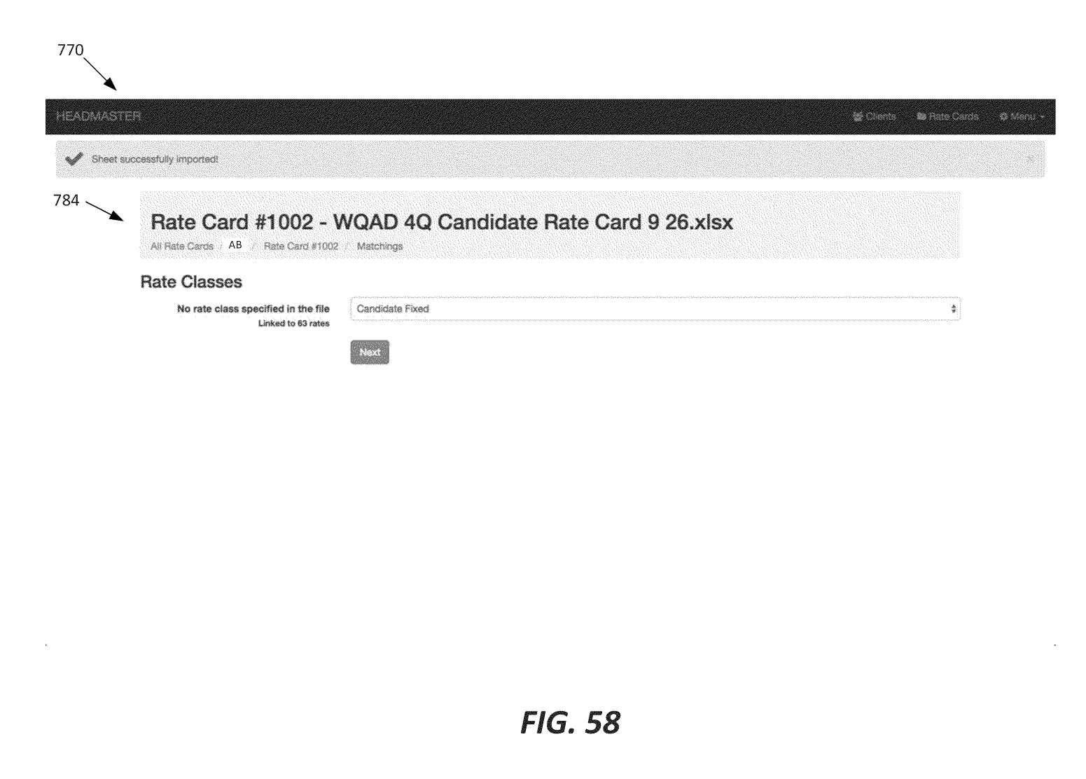

FIG. 58 is an example interface 770 of the rate card import engine 614 that displays a page 784 for enabling a user to select a rate class for an associated rate card 768. In some embodiment, the page 784 is used when the avails as displayed in FIG. 54 has no rate class mentioned.

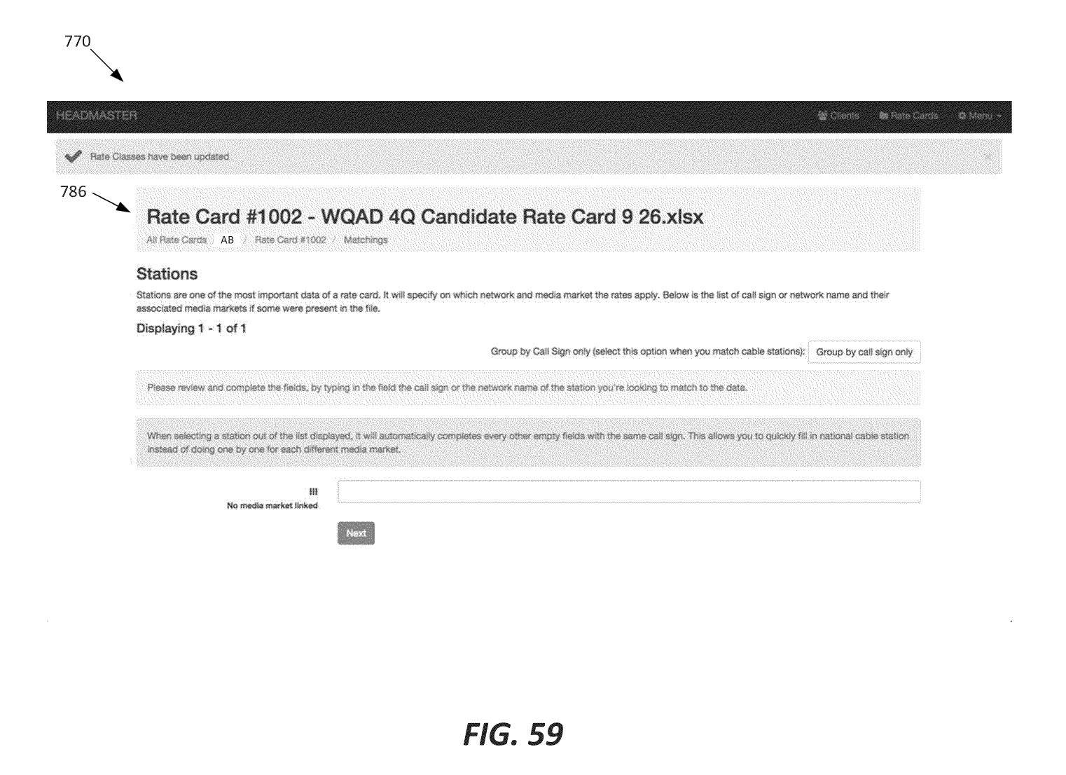

FIG. 59 is an example interface 770 of the rate card import engine 614 that displays a page 786 for enabling a user to select stations the rates apply. In some embodiments, stations are one of data of a rate card. In some embodiments, the page 786 allows a user to specify on which network and media market the rates apply.

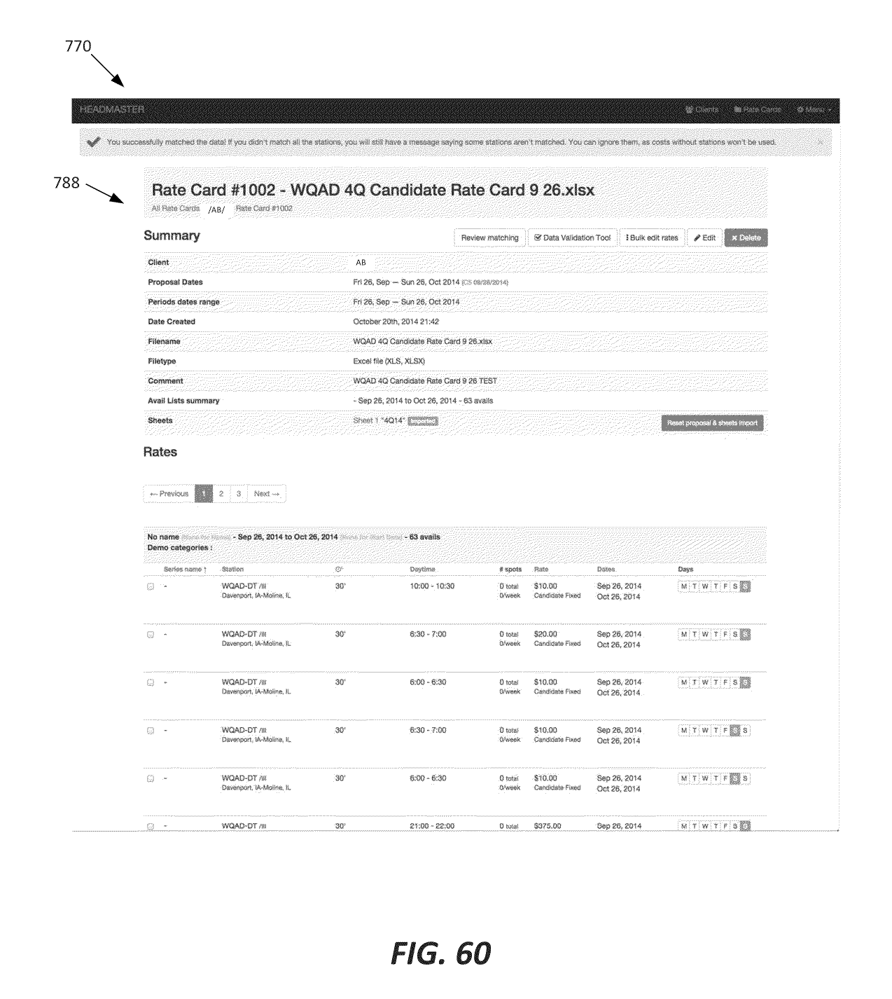

FIG. 60 is an example interface 770 of the rate card import engine 614 that displays a rate card summary page 788. The rate card summary page 788 is designed to display all the details of a rate card 768, including the summary of the rate card 768 and the rates information for each placement.

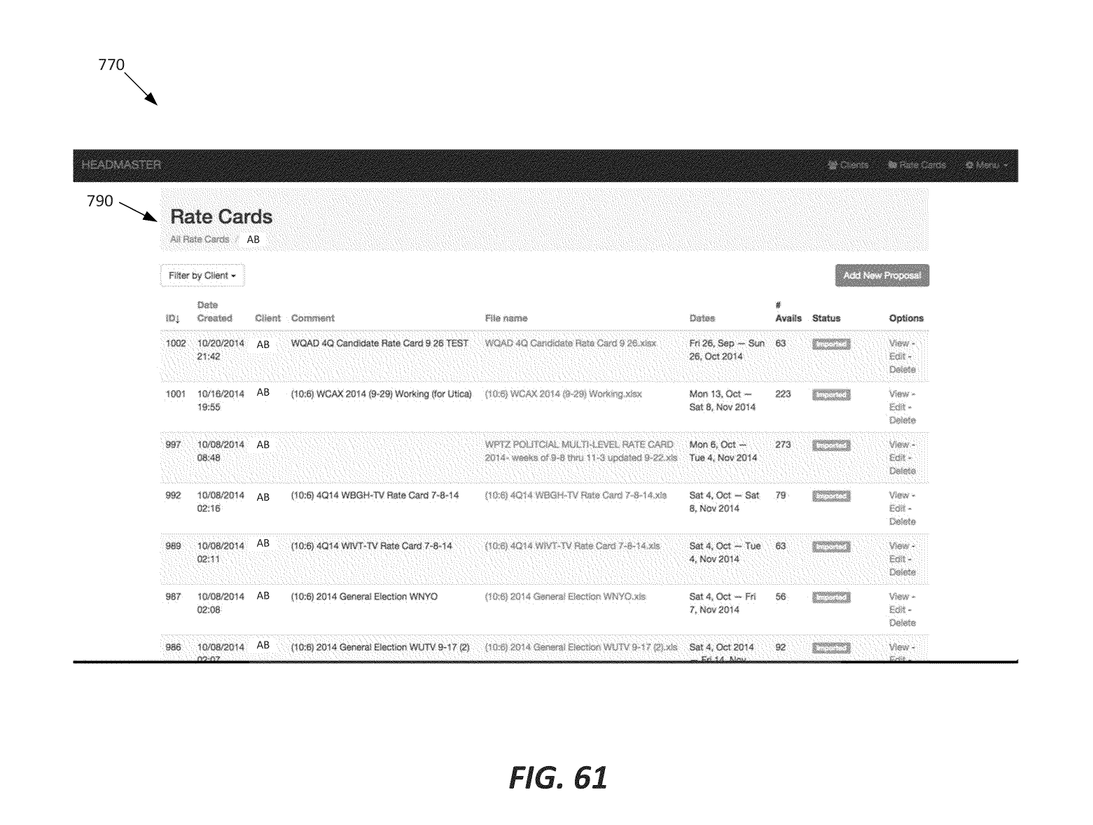

FIG. 61 is an example interface 770 of the rate card import engine 614 that displays a rate card list page 790. The rate card list page 790 shows a list of all rate cards stored in the system.

FIG. 62 is a flowchart of an example method 800 of operating the data management engine 616. In some embodiments, the method 800 includes operations 802 and 804.

Some embodiments of the data management engine 616 provides an interface for a user (e.g., the advertiser 102 or an administrator of the media plan generation system 110) to access data stored in the database 160 and manage the data in various manners (e.g., loading, creating, editing, and deleting). Some types of data can be apt to change and have to be updated frequently. Examples of data to be updated include media markets data, stations data, and networks data. For example, information about stations can often change, or a new station has been added. Then, such an update in the stations needs to be properly reflected in the stations data stored and managed by the media plan generation system 110. Otherwise, the media plan generation system 110 will not generate the most optimized media plan 124 due to the outdated information about stations. The data management engine 616 allows a user to simply modify the information about stations via an interface provided by the data management engine 616. Then, the data management engine 616 operates to synchronize the database with the update data.

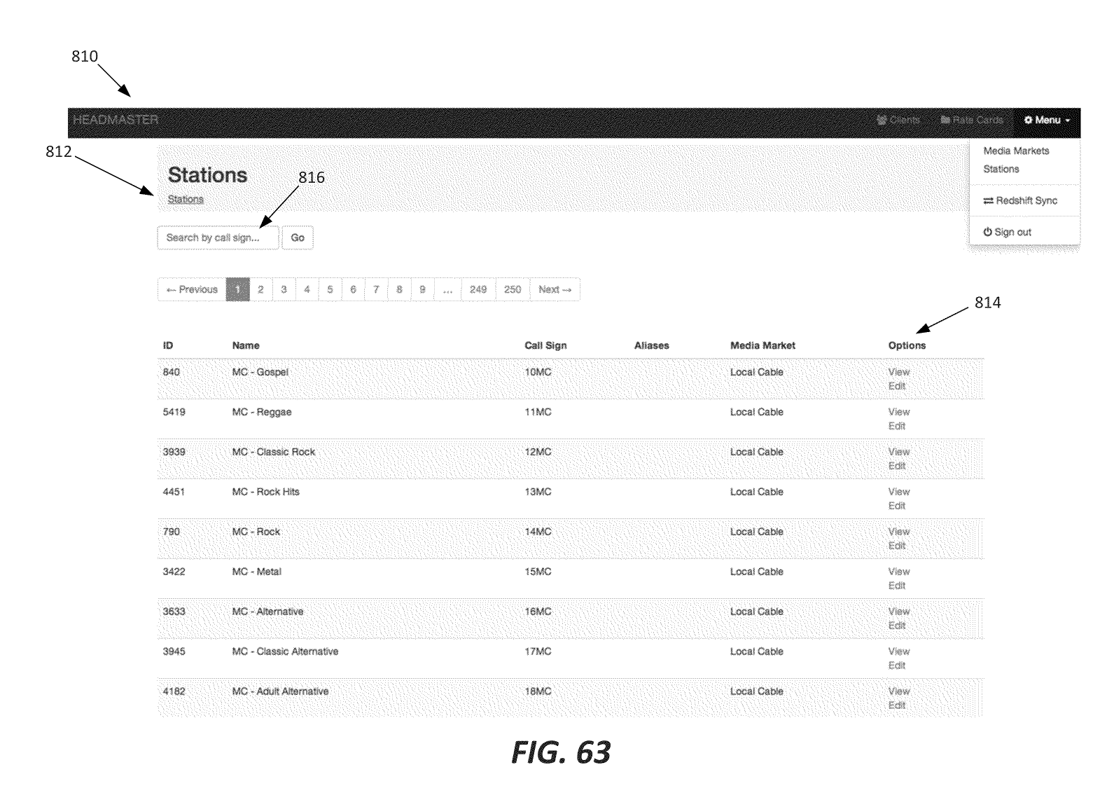

In some embodiments, the data management engine 616 provides a search option 816 (FIG. 63) to allow a user to search for a station in which the user is interested. For example, as the user manually manages or updates the data with the information about a station, the user can use the search option 816 to check if the station has already existed in the data. In some embodiments, the search option 816 is designed to perform fuzzy string searching that operates to find strings that match a pattern approximately.

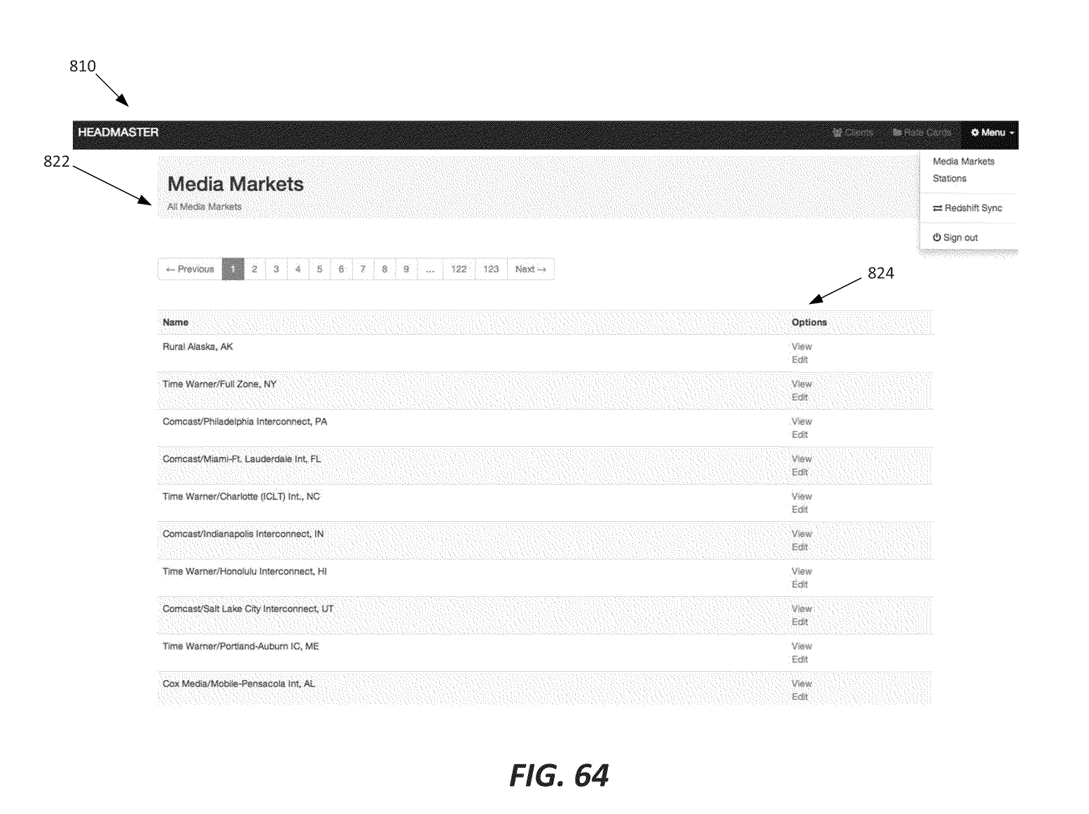

At the operation 802, the data management engine 616 operates to receive a user request to update data via an interface 810 (FIGS. 63-64) provided by the data management engine 616.

At the operation 804, the data management engine 616 synchronizes the database 160 with the updated data. In some embodiments, the data management engine 616 periodically access the relevant data in the database 160 and modify them with the updated data.

FIG. 63 illustrates an example interface 810 of the data management engine 616 that displays a stations management page 812. In some embodiments, as illustrated, the stations management page 812 includes a list of stations, each of which is identified by, for example, ID, name, call sign, aliases, and/or media market. Also shown are one or more selectable buttons 814 and a search option 816.

The one or more selectable buttons 814 are configured to enable a user to manage the information of associated stations. In some embodiments, the selectable buttons 814 include a view button for retrieving the details of a station, an edit button for modifying the information about a station, an add button (or a new button) for adding a new station in the list, and a delete button for deleting a station.

The search option 816 is configured to allow a user to search for one or more stations in which the user is interested. In some embodiments, the search option 816 is designed to perform fuzzy string searching that operates to find strings that match a pattern approximately, thereby helping the user locate the station more efficiently.

FIG. 64 illustrates an example interface 810 of the data management engine 616 that displays a media markets management page 822. In some embodiments, as depicted, the media markets management page 822 includes a list of media markets, each of which is identified by, for example, its name. Also shown are one or more selectable buttons 824. As the buttons 824 operate similarly to the buttons 814 of FIG. 63, the description of the buttons 824 is omitted for brevity purposes.

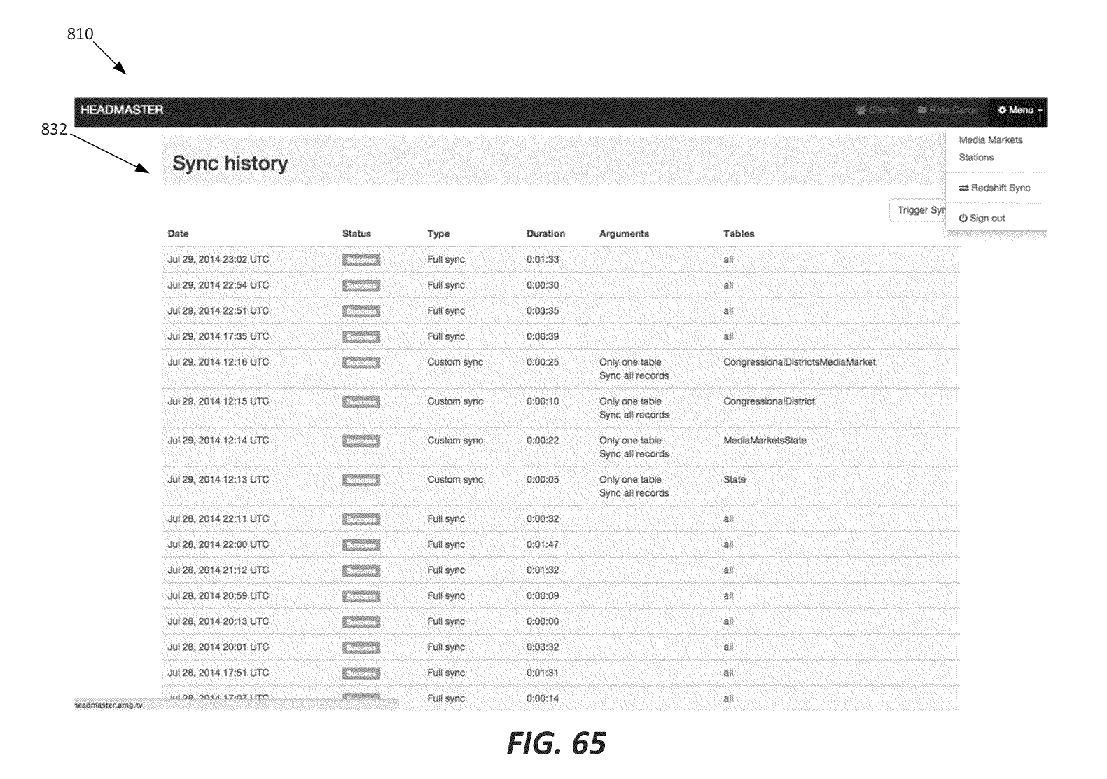

FIG. 65 illustrates an example interface 810 of the data management engine 616 that displays a sync history page 832. In some embodiments, as illustrated, the sync history page 832 includes a list of events of synchronization with the database 160. In some embodiments, each synchronization event is identified by at least one of event data, status, type, duration, description, and synchronized tables. In other embodiments, synchronization events can be identified in different manners.

Revisiting the rate card import engine 614 of FIG. 51, an example algorithm that can be used in the rate card import engine 614 to parse media data in a spreadsheet, such as CSV format, is described below.

In this example, the parsing algorithm is designed to infer rate card information based on contents in cells and organizations thereof. In some embodiments, the information in the rate card can often be divided into two parts, one of which is a core content that contains avail lines, and the other of which is outliers, such as headers, title, and other information common to several avail lines. Typically, the core content is very consistent. For example, cells on the same column are of the same format. In contrast, the outliers are different from cell to cell, and do not have apparent organization. The parsing algorithm can be designed to automatically detect the core content (e.g., the avails) based upon these characteristics.

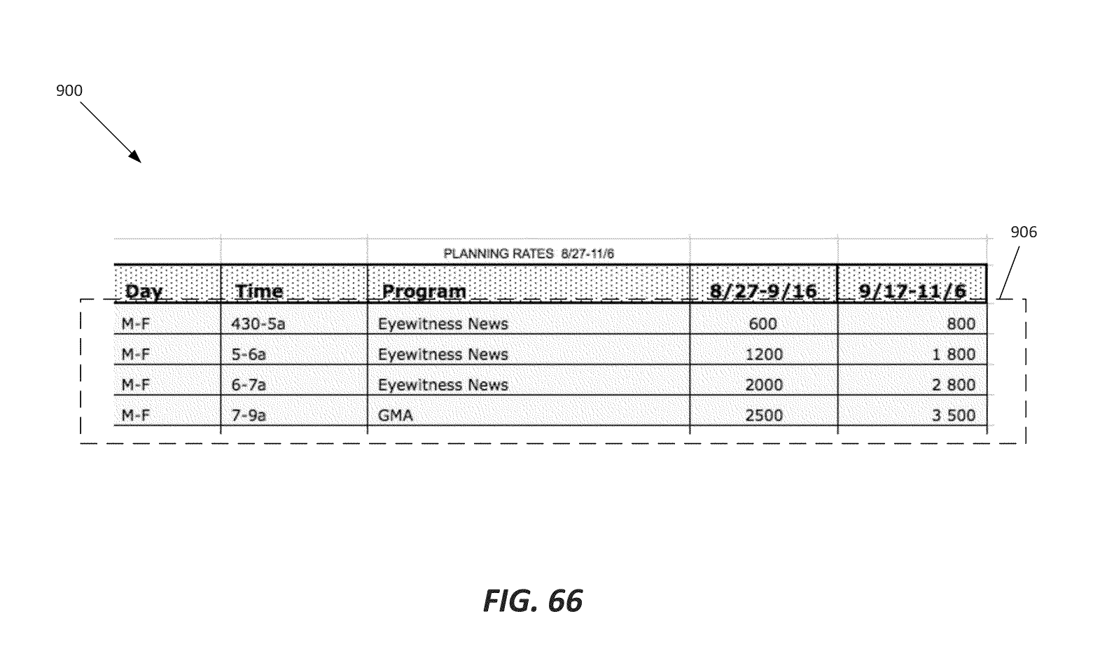

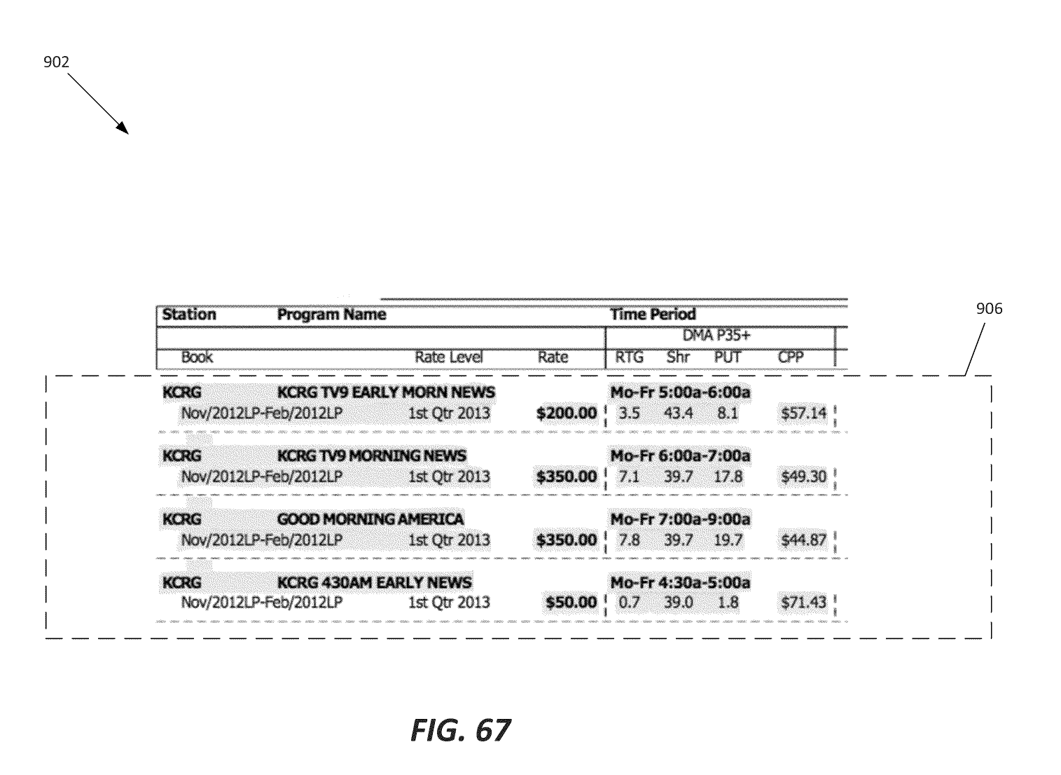

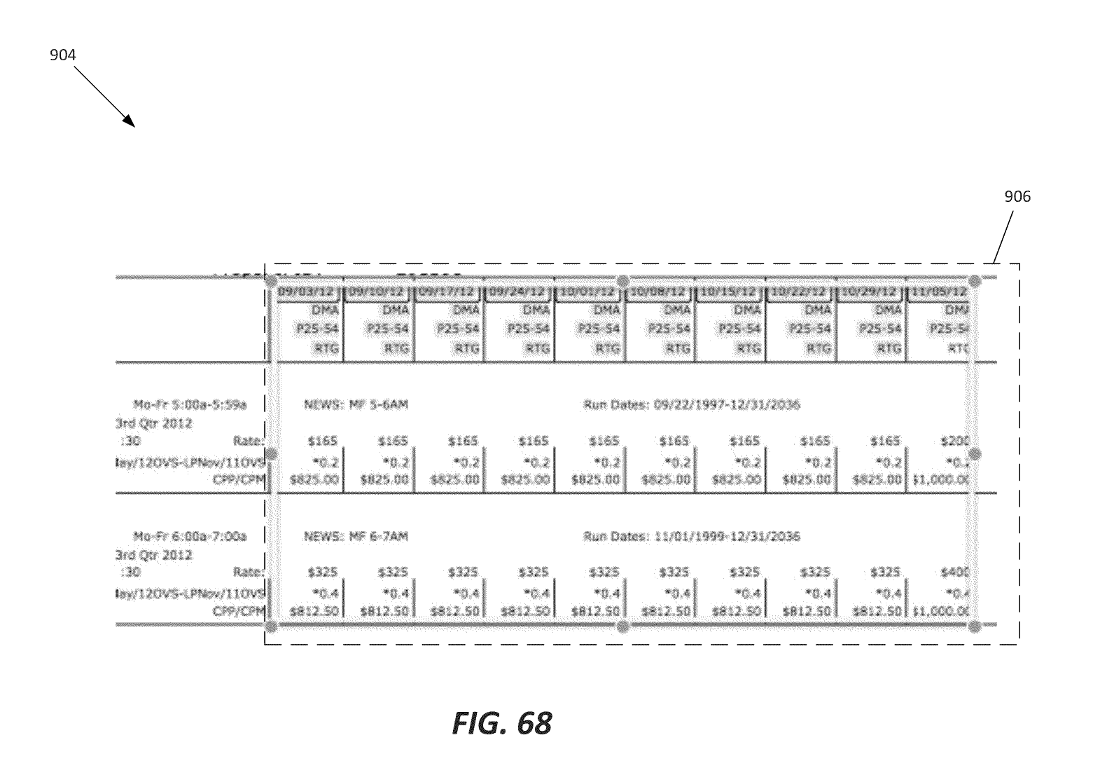

FIGS. 66-68 illustrate examples of rate cards 900, 902 and 904. In some embodiments, the rate cards 900, 902, and 904 can be parsed by the algorithm as illustrated herein. Core contents (e.g., avails) are generally designated by reference number 910. As illustrated, the avail lines can be either rows or columns. In some embodiments, the avails can be on two or more lines, respectively (e.g., the rate card 902). As depicted with the rate card 904, avails can be represented as several lines and rows, which are configured to show detailed rates per week. In the rate card 904, one week is represented as only one date, which makes it difficult to automatically parse.

In some embodiments, the parsing algorithm includes steps of (1) deleting empty rows and columns; (2) assigning each cell a vector of possible formats; (3) identifying avail lines; (4) creating a hierarchy of data; (5) assigning a model/field combination to each field; (6) asking for validation; and (7) parsing.

Regarding a step (1), empty rows and/or columns are deleted for the subsequent steps. This step is optional.

Regarding step (2), in some embodiments, a regular expression (Regexp) is used to match the cell content. In other embodiments, a machine learning algorithm that is designed to learn from supervised data can be used for matching. In yet other embodiments, Levenshtein distance or the like in a supervised classification algorithm can be used to represent the cell directly by its content.

In some embodiments, cell content is in a text format as a default. Cell content can be of several types, such as integer, float, rate (float and dollar), date, dates, day, days, time, day time, and call letters. Every cell can be assigned one of more of the possible formats. For example, a cell can be represented by a boolean vector or b probability vector (i.e., one value within the vector is the probability of the cell being of the assigned format).

Regarding step (3), each row and column can then be assigned a vector of possible format of each cell it contains. Then, an unsupervised classification algorithm (UCA or clustering algorithm) can be executed to detect consistent rows and/or columns in order to detect avails. This should manage to detect one or two consistent groups (sometimes one avail is on two lines . . . ), plus one group of outliers.

In some embodiments, the UCA may not work in certain rate card formats, which contain more complex structure for avails that can span over several lines. In that case, it is necessary to find repetitive patterns in the structure of the document, without knowing in advance the shape of repeated patterns. In some embodiments, a user can be involved in the process. For example, the rate card import engine 614 operates to display several rows and columns to the user and prompt the user to select the repeated pattern by selecting two corners of a box (a corner being a cell). This allows obtaining a template for the pattern, and thus finding all the other patterns by computing the distance to this template.

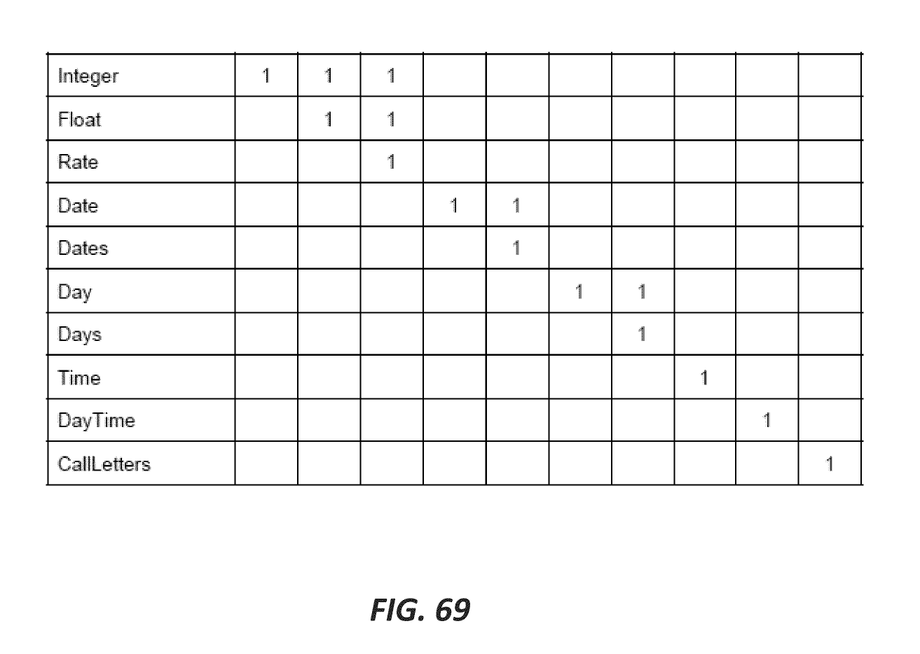

In some embodiments, in the patterns extraction, it is possible to assign each type a bitmask (well, an integer) (e.g., FIG. 69) corresponding to similarities with other formats. For instance, a rate can have no dollar sign ($) hence being recognized as an integer, when it means the same thing. This could happen in case where formatting is wrong (i.e., the creator of the rate card document forgot a dollar sign). In that case, an integer could represent a rate, hence isn't very far away from it.

Regarding a step of validating the choice of avail lines, the rate card import engine 614 operates to display each line and their data with checkboxes pre-checked for everything that has been detected as an avail line. An user can check or uncheck them to select only the right avail lines.

Regarding step (4), a hierarchy of data is created, which assigns to each avail line data that can be found in the outlier group and can link to it (e.g., header, call letters given to several avail at once). Hierarchy can be obtained by columns/rows order and nearest occurrence.

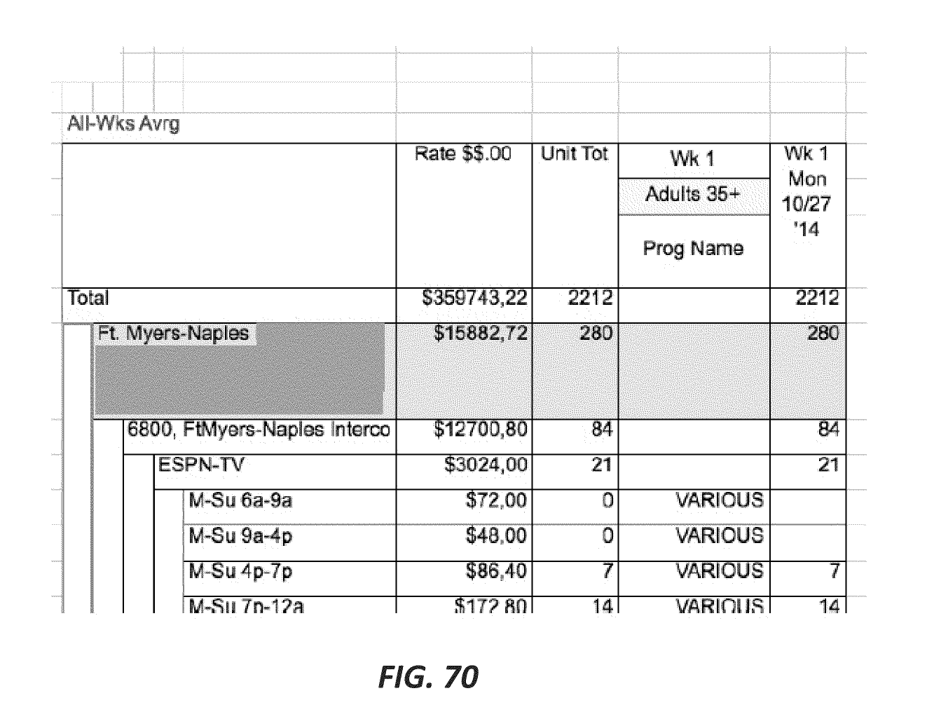

In some embodiments, outliers data (e.g., data not within an avail pattern, so common to several avails or to the entire proposal) are assigned. Using the outlier group cells, a hierarchy of data is created assigning outliers cells to avails. For instance, as illustrated in FIG. 70, the avail lines (with day times, rate, unit tot) are linked to station call letters (ESPNTV) and syscode (6800 . . . ) in a hierarchical way.

Because each of outliers data can be placed on a line separate from an avail, it is possible to select every remaining line from the rate card spreadsheet that does not belong to an avail (i.e., different pattern) and then find similarities among them to extract their patterns (e.g., some outliers data). Once the different outliers patterns are detected, each one of them can be linked to each avail or more.

Regarding step (5), according to the organization of data obtained, it is possible to assign to each cell a combination of model and field (i.e., to which model the cell is linked (Proposal, AvailList, Avail, Period . . . ) and to which field of the model (start date, end date, rate . . . )). To achieve this, the most probable format of each cell is used to filter the possible combinations, from which the hierarchical position (Proposal>AvailList>Avail) is known so the repetition and the position in the document makes it possible to determine which model/field it corresponds to.

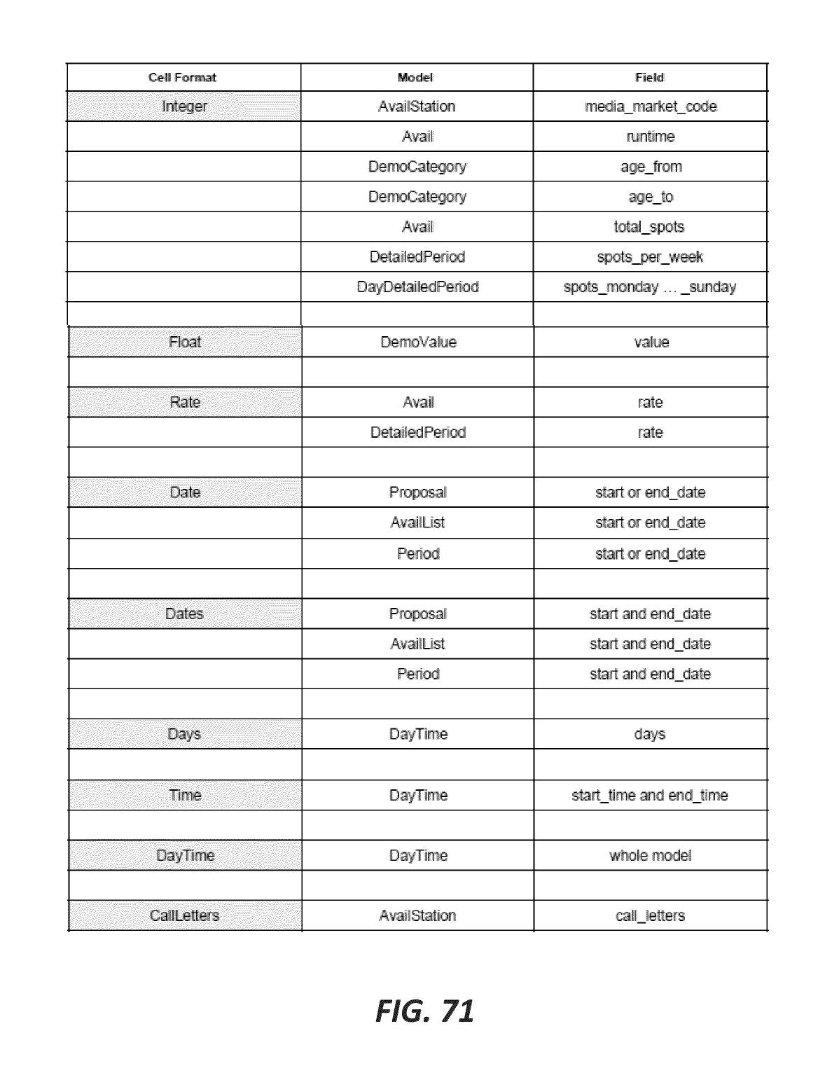

In some embodiments, a cell can contain all the data of one model (see DayTime in FIG. 71) or even a hash of attributes (start_date and end_date for instance). This can be modeled by extracting a hash from a cell, which can contain one or more keys/values. In this sense, this is more a model/hash association.

It is possible to fully configure the different format to model/hash combination by simply telling only fields names and at class loading, match the fields names to the models that have all the fields in the hash.

FIG. 71 is an example table containing every cell format to model/field (or hash) combination. Combinations are put in the best type matching (so a rate, even if it can be represented as an integer, is put in front of rate format).

Regarding step (6), the rate card import engine 614 operates to ask a user to validate each association of data (outliers with avails) and also the model/field combination associated to each cell.

In the present disclosure, the media planning system 100 is illustrated and described primarily on political advertisements on broadcasting televisions and/or cable televisions. However, the media planning system 100 can be employed to determine advertisement placements to promote a product or service. Further, the media planning system 100 of the present disclosure can be used in the same or similar manner with other types of campaign, such as radio advertising, online streaming advertising, text messages, banner messages, video messages, roll-over messages, text over video messages, and any other advertising formats. For example, embodiments of the media planning system 100 can be expanded to measure other advertising media or program delivery sources, such as the Internet, radio, handheld devices, wireless devices (e.g., mobile phones), television distribution systems, cable, satellite, programs delivered through television networks, “TiVo” type systems, “DirectTV” type systems, and many others.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of generating a campaign media plan, the method comprising:
receiving media data;
receiving plan parameters;
generating at least one advertising options data file based upon the media data and the plan parameters; and
generating, using one or more computing devices, a media plan with recommended placement blocks, the recommended placement blocks generated from the at least one advertising options data file and selected based upon a fitness value.

2. The method of claim 1, further comprising:
prior to generating a media plan with recommended placement blocks, generating all possible placement blocks from the at least one advertising options data file; and
eliminating at least one of the all possible placement blocks based upon one or more predetermined criteria to select some of the all possible placement blocks to be used as a basis list of placement blocks for generating the recommended placement blocks.

3. The method of claim 2, wherein the predetermined criteria include at least one of a number of impressions, a number of frequencies, and a number of reaches.

4. The method of claim 2, wherein the predetermined criteria include a budget-related criterion calculated by multiplying a budget of the media plan with a budget multiplier.

5. The method of claim 4, wherein the budget multiplier is between 1 and 10.

6. The method of claim 2, wherein generating a media plan with recommended placement blocks comprises:
creating a group of chromosomes from the basis list of placement blocks, each of the chromosomes representing a placement block selected from the basis list of placement blocks;
repeatedly mutating the group of chromosomes using the fitness value until the fitness value converges; and
generating the media plan with placement blocks represented by the group of chromosomes that offer the converging fitness value.

7. The method of claim 6, wherein repeatedly mutating the chromosomes using fitness values comprises, in each cycle of mutation:
altering the group of chromosomes to generate a modified group of chromosomes;
comparing a fitness value of the group of chromosomes and a fitness value of the modified group of chromosomes; and
selecting either of the group of chromosomes or the modified group of chromosomes, which offers a higher fitness value.

8. The method of claim 1, wherein generating a media plan with recommended placement blocks comprises:
creating a group of chromosomes from the basis list of placement blocks, each of the chromosomes representing a placement block selected from the basis list of placement blocks;
repeatedly mutating the group of chromosomes using the fitness value until a predetermined number of mutations have been reached; and
generating the media plan with placement blocks represented by the group of chromosomes that offer a highest fitness value.

9. The method of claim 1, wherein the fitness value is calculated based upon one or more variables and one or more adjustable coefficients, the variables representing a plurality of criteria associated with a plurality of advertising objectives, and the coefficients designed to be accompanied with the variables to adjust values of the variables, respectively.

10. The method of claim 9, wherein the plurality of advertising objectives includes at least one of maximization of impressions, minimization of costs, distribution in one or more periods of time, maximization of reach, and maximization of frequency.

11. The method of claim 10, wherein the distribution in one or more periods of time include distribution of advertisements over weeks, distribution of advertisements in a day, and distribution of advertisements over days of a week.

12. The method of claim 1, wherein the media data include audience measurement data and cost data.

13. The method of claim 1, wherein the audience measurement data include audience information and program information.

14. The method of claim 1, further comprising:
prior to generating one or more advertising options data files, converting the media data into a predetermined format readable by a database.

15. The method of claim 1, wherein at least portion of the media data are obtained from one or more media data collection devices associated with one or more media delivery devices located at consumer's sites.

16. The method of claim 1, wherein receiving plan parameters includes receiving plan parameters from an advertiser.

17. A system of generating a campaign media plan, the system comprising:
at least one processing devices;
a computer readable storage device storing software instructions that, when executed by the one or more computing devices, cause the one or more processing devices to:
receive media data;
receive plan parameters;
generate at least one advertising options data file based upon the media data and the plan parameters; and
generate a media plan with recommended placement blocks, the recommended placement blocks generated from the at least one advertising options data file and selected based upon a fitness value.

18. The system of claim 17, wherein the software instructions further cause the one or more processing devices to:
prior to generating a media plan with recommended placement blocks, generate all possible placement blocks from the at least one advertising options data file; and
eliminate at least one of the all possible placement blocks based upon one or more predetermined criteria to select some of the all possible placement blocks to be used as a basis list of placement blocks for generating the recommended placement blocks.

19. The system of claim 17, wherein the software instructions further cause the one or more processing devices to:
create a group of chromosomes from the basis list of placement blocks, each of the chromosomes representing a placement block selected from the basis list of placement blocks;
repeatedly mutate the group of chromosomes using the fitness value either until the fitness value converges or until a predetermined number of mutations have been reached; and
generate the media plan with placement blocks represented by the group of chromosomes that offer a highest fitness value.

20. A computer storage medium encoding computer executable instructions that, when executed by at least one processor, perform a method of generating a campaign media plan, the method comprising:
receiving media data;
converting the media data into a predetermined format readable by a database;
receiving plan parameters;
generating at least one advertising options data file based upon the media data and the plan parameters;
generating all possible placement blocks from the at least one advertising options data file;
eliminating at least one of the all possible placement blocks based upon one or more predetermined criteria to select some of the all possible placement blocks to be used as a basis list of placement blocks;
creating a group of chromosomes from the basis list of placement blocks, each of the chromosomes representing a placement block selected from the basis list of placement blocks;
repeatedly mutating the group of chromosomes using a fitness value either until the fitness value converges or until a predetermined number of mutations have been reached; and
generating a media plan with placement blocks represented by the group of chromosomes that offer a highest fitness value.
